(19) United States
(12) Patent Application Publication
(10) Pub. No.: US 2013/0313191 A1
(43) Pub. Date: Nov. 28, 2013

(54) WATER TREATMENT SYSTEMS AND METHODS

(71) Applicant: Omni Water Solutions, Inc., (US)

(72) Inventors: Wayne Wolf, Austin, TX (US); Billy Roberts, Austin, TX (US)

(73) Assignee: Omni Water Solutions, Inc., Austin, TX (US)

(21) Appl. No.: 13/838,676

(22) Filed: Mar. 15, 2013

Related U.S. Application Data
(63) Continuation-in-part of application No. 12/780,837, filed on May 14, 2010, now Pat. No. 8,486,275.
(60) Provisional application No. 61/216,165, filed on May 14, 2009.

(51) Int. Cl. C02F 9/00

(52) U.S. Cl. CPC C02F 9/005
USPC 210/638; 210/143

(57) ABSTRACT

Water treatment systems and methods. Embodiments provide water treatment systems which comprise first oxidation, particulate filtration, and membrane filtration subsystems in that order. Systems also comprise recirculation paths and sensors for these subsystems. A controller determines whether to recirculate water to a previous subsystem in the order. Systems can comprise downstream second oxidation, high pressure membrane, ion exchange, activated carbon subsystems and/or ultraviolet contactors. Systems with high pressure membranes can comprise a pump before the high pressure membranes, a booster pump of the high pressure membrane subsystem, and a damping tank. In such systems the controller maintains a pressure in the damping tank. High pressure membrane subsystems can further comprise nanofiltration membranes and RO membranes. Systems can comprise bypass paths for some/all of the subsystems. For such systems, the controller further determines, whether to bypass these subsystems.

### CROSS-REFERENCE TO RELATED APPLICATIONS

This application is a continuation in part of U.S. patent application Ser. No. 12/780,837 entitled “Self-Contained Portable Multi-Mode Water Treatment Systems and Methods,” filed May 14, 2010, which is hereby incorporated herein by reference and which was a non provisional application of provisional U.S. patent application Ser. No. 61/216,165 entitled “Self-Contained Portable Water Treatment Apparatus and Methods with Automatic Selection and Control of Treatment Path,” filed May 14, 2009, which is also hereby incorporated herein by reference.

### BACKGROUND

1. Field of Disclosure

The present disclosure relates to the field of water treatment, and in its embodiments more specifically relates to self-contained, portable, automated apparatus and methods for treating water to remove various types of contaminants to produce potable and/or other types of water.

2. Description of Various Scenarios

In much of the world, the lack of clean, safe drinking water (and/or water of adequate quality for other uses) is a major problem, and the need for reliable sources of water is one of the most important factors in the survival of entire populations. Even when water is available it is very likely to be contaminated and unsafe for use. Common contaminants include entrained large debris, entrained small particle debris, suspended solids, salts, oils, volatile organic compounds (VOCs) and other chemicals, as well as living organisms and other pathogens. Different sources of water that requires treatment before it can be safely used can include various ones of these common contaminants, or may include all of them. The substantial variation in the contaminants found in different water sources has heretofore made the design of treatment systems either a case-by-case process or a one-fits-all process. A treatment system designed and constructed with a few treatment modules to remove only selected contaminants reflective of the anticipated raw water source cannot effectively treat water in the event that an additional contaminant is introduced to the source water, either permanently or intermittently, such as when a natural or man-made disaster occurs that changes the contaminants in the source water. A one-fits-all treatment system designed to treat source water for the removal of all possible contaminants, whether actually present or not, can be considerably more costly to construct, operate and maintain than a system that treats only for contaminants actually present.

Portability and interchangeability of treatment system apparatus is also a problem that is detrimental to the goal of making water more readily available. Portable water treatment systems are needed for a wide variety of different scenarios and geographic locations where the source water is of unknown or variable quality. Portable water treatments systems commonly need to be deployed as part of a disaster relief response. For instance, conventional water treatment systems located in the New Orleans area, which were intended to treat fresh water from the Mississippi River or local lakes, were incapable of treating the contaminated mixture of fresh and salt water, debris, oil, and chemicals in the source water supply immediately following Hurricane Katrina. Other types of portable treatment systems are needed to provide adequate homeland security responses, such as responding to a chemical or biological terrorist attack which contaminates domestic fresh water sources. The military, mining companies, and petroleum exploration and production companies also need portable treatment systems when deploying to remote areas lacking existing water treatment infrastructure in order to provide potable water for its personnel. Portable treatment systems can also provide an effective source of potable water in underdeveloped countries lacking adequate water treatment infrastructure for their people.

Especially in underdeveloped countries and in remote areas anywhere, transporting, setting up, operating, and maintaining water conventional treatment equipment and installations can be difficult, and sometimes impossible. Operation and maintenance of conventional equipment and systems often requires trained personnel, who may not be available or may be unreliable.

Environmental factors where water treatment equipment is located, or needed, can also present significant difficulties, both in terms of equipment operating parameters and in terms of equipment maintenance and protection. For instance, in high temperature locations the ambient temperature may be too high for equipment to operate for more than short periods without damage. In very humid locations, condensation can damage equipment components, including but not limited to electrical and control devices. Salt air can create and accelerate corrosion problems that interfere with operation and shorten the useable life of treatment equipment.

There have been a number of attempts to develop portable self-contained water purification systems to produce potable water in the past for specific scenarios and geographic locations. The success of such prior portable systems has been limited. The U.S. military has sought to develop mobile water treatment systems for use with deployed military units; however, such units have encountered deficiencies in operation and in being able to successfully remove a wide variety of contaminants. Others have sought to develop water purification systems that produce potable water from virtually any raw water source using a variety of different inline treatment processes which remain in operation regardless of the need for all the treatment process steps. Yet the problems described hereinabove have not been fully addressed, and there remains an unfulfilled need for a water treatment system, including apparatus and methods of operating, that are readily portable, protected against harsh environments, highly effective in contaminant removal, fully automatic in operation, and automatically subjects source water to the treatment steps appropriate for removing contaminants present in the source water, and automatically bypasses treatment steps unnecessary for production of clean, safe, potable water (and/or water of adequate quality for other uses).

The present disclosure, which addresses and/or fills some or all of the needs outlined above will be described below with reference to the accompanying drawing figures and illustrations.

### SUMMARY OF THE DISCLOSURE

Briefly, the present disclosure provides novel systems and methods for treating water from various raw water sources to produce potable water and/or water of adequate quality for other uses. Systems for treating water to produce potable water of some embodiments include a conduit subsystem having an inlet for receiving water from a raw water source and an outlet for potable water through which the water can flow from the inlet to the outlet; a plurality of pumps connected to the conduit system wherein the pumps can drive the flow of the water through the conduit system; and a plurality of water treatment subsystems connected to the conduit system. The water treatment subsystems include a strainer subsystem for removing particulates of a size that could potentially disrupt the water treatment system; a primary oxidation subsystem downstream of the strainer subsystem for the primary treatment of the strained water; an ozone injector coupled to the primary oxidation subsystem for injecting ozone into the primary oxidation subsystem for the oxidation of contaminants in the strained water; at least one filtration subsystem for removing smaller particulates from the water wherein the at least one filtration subsystem is selected from the group consisting of mixed media filtration elements, micro-filtration membrane elements, ultra-filtration membrane elements and activated carbon filter elements; a reverse osmosis subsystem for removing at least dissolved contaminants from the water; and a final oxidation subsystem for further oxidizing and disinfecting the water received from subsystems upstream of the final oxidation subsystem wherein ozone can be injected and then ultraviolet radiation can be imparted into the final oxidation subsystem to further enhance disinfection and advanced oxidation.

Systems of the current embodiment further include a plurality of sensors wherein each of the sensors is positioned in the water treatment system so that it can measure at least one of a set of characteristics of the water at its position wherein the set of characteristics of the water includes water flow rate, water pressure, water level and water quality parameters. Each sensor output signals that are representative of the measured characteristics. The system also includes a controller for receiving the output signals from the plurality of sensors at the plurality of locations in the treatment system wherein the controller can control the operation of the treatment system in a plurality of modes; select one of the plurality of modes of operation; monitor the measured characteristics of the water received from the plurality of sensors; use the measured characteristics received from the plurality of sensors to determine the quality of the water at a plurality of locations throughout the treatment system; automatically control the flow of water through the conduit subsystem based upon the selected mode of operation and the output signals of the measured characteristics from the plurality of sensors; automatically determine, based upon the selected mode of operation and the water quality parameter measurements at a plurality of sensor locations which of the plurality of the subsystems is needed to produce potable water at the output; and automatically direct the flow of water through the conduit subsystem to bypass the water treatment subsystems and elements that are not needed to produce potable water. The modes in which the controller may be operated may include a transient mode of operation and a normal processing mode of operation.

Methods of treating raw water to produce potable water of in accordance with various embodiments include the steps of receiving water from a raw water source into an inlet of a conduit subsystem of a water treatment system having a plurality of treatment subsystems for providing a plurality of water treatment processes, the conduit subsystem also having an outlet for potable water through which the water can flow from the inlet to the outlet; sensing a plurality of characteristics of the water at a plurality of locations in the water treatment system with a plurality of sensors wherein the set of characteristics of the water comprises water flow rate, water pressure, water level and water quality parameters; outputting signals from each of the plurality of sensors that are representative of the water characteristic measured by such sensor. Methods in accordance with the current embodiment further includes the step of receiving the output signals from the plurality of sensors located at the plurality of locations at a controller which controls the operation of the water treatment system wherein the controller monitors the measured characteristics of the water received from the plurality of sensors; pumps water from the raw water source through the conduit subsystem if the water pressure of the water from the water source is too low for operating the water treatment system; selects one of a plurality of modes of operating the water treatment system based upon the measured water characteristics; uses the output signals of the measured characteristics received from the plurality of sensors to determine the quality of the water at a plurality of locations throughout the water treatment system; automatically controls the flow of water through the conduit subsystem based upon the selected mode of operation and the output signals of the measured characteristics from the plurality of sensors; and automatically determines, based upon the selected mode of operation and the water quality parameter measurements at a plurality of sensor locations, which of the plurality of treatment steps are needed to produce potable water at the outlet; and automatically directs the flow of water through the conduit subsystem to bypass the treatment subsystems for the treatment processes that are not needed to produce potable water. The plurality of water treatment processes selectable by the controller includes straining from the water particulates of a size that could potentially disrupt the water treatment system; primarily treating the strained water in a primary oxidation treatment subsystem by injecting ozone into the primary oxidation treatment subsystem for the oxidation of contaminants in the strained water; filtering smaller particulates from the water using at least one filtration treatment subsystem wherein the at least one filtration treatment subsystem is selected from the group consisting of mixed media filtration elements, micro-filtration membrane elements, ultra-filtration membrane elements and activated carbon filter elements; removing dissolved solids from the water using a reverse osmosis treatment subsystem; further disinfecting the water by injecting ozone into the water in a final oxidation treatment subsystem; and imparting ultraviolet light into the water in the final oxidation treatment subsystem to create hydroxyl radicals to oxidize any remaining contaminants [and to destroy substantially all of any remaining injected ozone].

Systems of various embodiments, as noted elsewhere herein, can provide water suitable for human consumption and/or potable water. However, systems of many embodiments provide water suitable for industrial and/or other applications such as “fracking” oil (and/or other hydrocarbon bearing) wells. Systems of embodiments can produce high volumes (or flow rates) of treated water while minimizing the energy consumed during its production. Such systems are available from Omni Water Solutions, Inc. of Austin, Tex. under the H.I.P.P.O.® (Hydro Innovation Purification Platform for Oil & Gas hereinafter “HIPPO”) and/or other product lines. Embodiments provide robust, automated systems which use Omni's Octozone™ technology. Systems of such embodiments integrate membrane filtration technology with analytics and software thereby providing capabilities to treat a wide variety of source waters despite varied (and varying) source water conditions. More specifically, such systems can treat source waters which include heavy concentrations of oily materials, suspended particulate matter, dissolved compounds, bacteria, etc. without requiring the addition (or substitution) of treatment technologies. Moreover, such systems can do so while calling for little or no human intervention during their startup, nominal operations, and/or recovery from upsets.

Systems of embodiments can be configured to sense and respond to changing water conditions and configure their fixed treatment trains to remove unwanted chemical species from their source water while minimizing the energy they consume in doing so. When clean drinking water is needed because the local infrastructure cannot meet demand, such as during a natural disaster, or in areas where proper sanitation measures do not exist, mobile recycling units of the current embodiment can be deployed quickly and economically. Moreover, systems of embodiments can have relatively low operational costs while operating autonomously and in self-sustaining manners. Such systems can be flexible and durable even while operating in remote locations. Using integrated sets of treatment technologies, systems of embodiments can remove many hazardous compounds from their source waters without requiring a change in their treatment technologies and/or subsystems. Systems of one embodiment produce 175 gallons per minute after as little as two hours (or less) of setup time. Systems of the current embodiment can have low energy consumption as well as low maintenance costs. Yet, such systems can remove from their source waters: dissolved solids, suspended solids, iron, barium, strontium, boron, sulfites, bacteria, etc.

With regard to water for industrial uses, systems of embodiments can find application in oil exploration and production situations as well as elsewhere. On that note, recent advances in the use of hydro-fracturing (or colloquially, “fracking”) technology by the oil and gas industry are unlocking reserves in shale fields throughout the world. Hydraulic fracturing can be an effective well-completion (and/or stimulation) method, which often requires several million gallons of water for each well. The flowback water that returns to the surface can carry chlorides and other materials that hinder its re-use. With systems heretofore available, the flowback water is typically re-injected into deep disposal wells. While this action hopefully removes the water from the fresh water evaporation cycle, it increases costs for operating companies. It is estimated that supplying and disposing of water for hydraulic fracturing costs this industry over $10B annually in North America alone.

Systems of embodiments can be well-suited to applications where source water has complex, variable and/or unpredictable levels of heavy metals, organic compounds, and dissolved solids. Units of the HIPPO® product line enable treatment and re-use of water for hydraulic fracturing by providing mobile, high-volume, water treatment platforms at or near the point of use. Such platforms allow operators to treat water to the appropriate level with little or no regard to changes in the source water chemistry. Such platforms can significantly reduce transport, purchase, and/or disposal costs for fresh and/or reject products thereby providing cost advantages to their operators.

Systems of one embodiment deliver reliable water treatment solutions, of up to 350 gallons per minute, without apriori consideration of unwanted chemical species in the source water. Thus, operators can reduce or eliminate their source water pre-testing and/or pre-treatment. Systems of the current embodiment include cascading sets of interlocked water treatment subsystems linked with analytics and software that sense and respond to potentially rapidly changing source water conditions. Many of these subsystems employ proven purification technologies for source waters impacted by metals, organics, brine, etc. Further, systems of the current embodiment do so without necessarily requiring the on-site presence of an operator(s) with specialized skills. Such systems can provide comprehensive, holistic solutions that are portable, self-contained, cost effective & energy efficient. More specifically, systems of the current embodiment can produce 2,500-10,000 barrels/day of treated water. The product waters can be either fresh water, treated brine, or a mixtures of the two as well as product waters available at intermediate points in the treatment processes.

Furthermore, systems of the current embodiment can provide audit trails of source and product water conditions. In addition, or in the alternative, systems of the current embodiment provide additional on-site sources of water to support completion activity. Thus, the current embodiment can reduce trucking and disposal volumes and costs while capturing and returning suspended oil in the source water. As a result, systems of the current embodiment can improve the public image of the operators through conservation and recycling of water and water-related resources. Systems of the current embodiment can also reduce draws from aquifers and surface water sources and can create treated water for livestock, irrigation, and other uses from source water that might otherwise be discarded or disposed of.

Embodiments provide systems for treating water which comprise a first (primary) oxidation subsystem, a particulate filtration subsystem, and a membrane filtration subsystem in fluid communication with each other in that order. Systems of the current embodiment also comprise recirculation paths and sensors for each of the foregoing subsystems. A controller in communication with the sensors is configured to, responsive to the sensed conditions, determine whether to recirculate water from one of the subsystems to a previous subsystem in the order and to output a corresponding control signal.

Various embodiments further comprise second oxidation, high pressure membrane, ion exchange, and/or activated carbon subsystems and/or an ultraviolet irradiation chamber downstream of the low pressure membrane subsystem. In systems with high pressure membrane subsystems, the systems can further comprise a source pump before the high pressure membrane subsystem, a booster pump of the high pressure membrane subsystem, and a damping tank. In such systems the controller maintains a damping pressure in the damping tank within a selected range. In addition, or in the alternative, the high pressure membrane subsystem further comprises nanofiltration membranes, reverse osmosis membranes, or a combination thereof. If desired, systems can further comprise bypass paths for at least the particulate filtration subsystem. For such systems, the controller further determines, responsive to the sensed conditions, whether to bypass various subsystems.

Methods in accordance with embodiments comprise operations such as sensing water conditions with sensors in a water treatment system. Systems of the current embodiment comprise a primary oxidation subsystem, a particulate filtration subsystem, and a membrane filtration subsystem in fluid communication with each other in that order. Furthermore, systems of the current embodiment further comprise recirculation paths for each of the foregoing subsystems. Responsive to the sensed conditions and using a processor, methods in accordance with the current embodiment comprise determining whether to recirculate water from one of the subsystems to a previous subsystem in the order. Moreover, such methods comprise outputting a corresponding control signal using the processor.

Methods in accordance with some embodiments can also comprise determining whether to recirculate water from one or more of the second oxidation, high pressure membrane, ion exchange, activated carbon subsystems and/or an ultraviolet irradiation chamber which are downstream of the low pressure membrane subsystem. In accordance with various embodiments, methods further comprise maintaining a pressure within a selected range in a damping tank between the low pressure membrane subsystem and a booster pump of the high pressure membrane subsystem. Also, for embodiments in which the water treatment system includes bypass paths for various subsystems, corresponding methods further comprise determining (responsive to the sensed conditions) whether to bypass such subsystems.

### BRIEF DESCRIPTION OF THE DRAWINGS

For a more complete understanding of the present disclosure, reference is now made to the following descriptions taken in conjunction with the accompanying drawings, in which:

FIG. 1 is an illustration of an embodiment for a self-contained portable water treatment system under normal flow operating conditions;

FIG. 2 is an illustration of an embodiment for a self-contained portable water treatment system during transient operation;

FIG. 3 is an illustration of an embodiment for a self-contained portable water treatment system during backwash flow operating conditions;

FIG. 4A is the first of a set of five related detailed schematic illustrations of an embodiment for a self-contained portable water treatment system;

FIG. 4B is the second of a set of five related detailed schematic illustrations of an embodiment for a self-contained portable water treatment system;

FIG. 4C is the third of a set of five related detailed schematic illustrations of an embodiment for a self-contained portable water treatment system;

FIG. 4D is the fourth of a set of five related detailed schematic illustrations of an embodiment for a self-contained portable water treatment system;

FIG. 4E is the fifth of a set of five related detailed schematic illustrations of an embodiment for a self-contained portable water treatment system;

FIG. 5 is a top plan view of an embodiment for a self-contained portable water treatment system apparatus layout within the floor boundaries of a standard-sized international shipping container;

FIGS. 6A and 6B are decision diagrams for an embodiment of the sensor and control subsystems of the current disclosure, showing sensor input and control output signals under various treatment processing conditions and sensor input data;

FIG. 7A is the first of a set of two flow diagrams illustrating an embodiment of a method of treating water in a self-contained portable water treatment system;

FIG. 7B is the second of a set of two flow diagrams illustrating an embodiment of a method of treating water in a self-contained portable water treatment system;

FIG. 8 illustrates two hydrostatic fracking systems.

FIG. 9 illustrates a schematic diagram of a water treatment system.

FIG. 10A to FIG. 10F illustrate a schematic diagram of another water treatment system.

FIG. 11A to FIG. 11F illustrate a schematic diagram of yet another water treatment system.

FIG. 12 illustrates a flowchart of a method for controlling water treatment systems.

FIG. 13 illustrates a contact tank of an oxidation subsystem.

FIG. 14 illustrates a cross-sectional view of a coagulant/oxidizer/dissolved air sparger of an oxidizer subsystem.

The foregoing summary as well as the following detailed description of the various embodiments will be better understood when read in conjunction with the appended drawings. It should be understood, however, that the disclosure is not limited to the precise arrangements and instrumentalities shown herein. Rather, the scope of the disclosure is defined by the claims. Moreover, the components in the drawings are not necessarily to scale, emphasis instead being placed upon clearly illustrating the principles of the present disclosure. Moreover, in the drawings, like reference numerals usually designate corresponding parts throughout the several views.

### DETAILED DESCRIPTION OF THE ILLUSTRATIVE EMBODIMENTS

The principles of the presented embodiments of the system and methods of the present disclosure and their advantages are best understood by referring to the figures.

In the following descriptions and examples, specific details may be set forth such as specific quantities, sizes, etc., to provide a thorough understanding of the presented embodiments. However, it will be obvious to those of ordinary skill in the art that the embodiments may be practiced without such specific details. In many cases, details concerning such considerations and the like have been omitted inasmuch as the details are not necessary to obtain a complete understanding of any and all the embodiments and are within the skills of persons of ordinary skill in the relevant art.

In some illustrative embodiments, a portable, self-contained, multi-mode, automated water treatment system and methods for operating the system are depicted that are capable of automatically treating and purifying contaminated water from a variety of raw water sources using a variety of selectable water treatment processes. The water source may be a tank or vessel, but it is to be understood that the term “water source” may be any of a wide variety of sources, including but certainly not limited to lakes, streams, ponds, oceans, and discharged water from other processes.

Systems of the current embodiment include sensors that measures characteristics of the water, including water quality parameters, at various locations throughout the system. The sensors output signals to a controller. The controller can automatically select one of a variety of modes of operation based upon the measured water characteristics at various sensor locations throughout the system. In the illustrative embodiments, the modes of operation of the system include “normal operation”, “transient operation”, and “backwashing operation”. “Transient operation” is defined for the purposes herein as operation during the startup of the system until a steady state condition is reached or operation during an “upset” condition. “Normal operation” is defined for the purposes hereof as the mode of operation of the treatment system after the completion of the startup of the treatment system and the occurrence of steady state conditions or after an “upset” condition has been resolved. “Backwashing operation” is defined as when subsystems or elements of the system or subsystems are being cleaned by employing either backwashing methods or “clean-in-place” methods.

The controller of the current embodiment can automatically use the measured water characteristics to determine the water quality at various locations throughout the treatment system and, then, based upon the selected mode of operation and the measured water quality parameters, automatically select and control which of the treatment processes are needed to produce potable water. In response to such determinations, the controller can then automatically direct the flow of the water to bypass any unnecessary treatment subsystems and processes. Thus, the controller automatically selects and controls the water treatment path through the treatment system based upon the output signals from a variety of sensors located throughout the system. The water treatment system is preferably configured to fit in a standard-sized commercial shipping container, which will allow it to be shipped and deployed in its operational configuration saving setup time and need for additional operator skill.

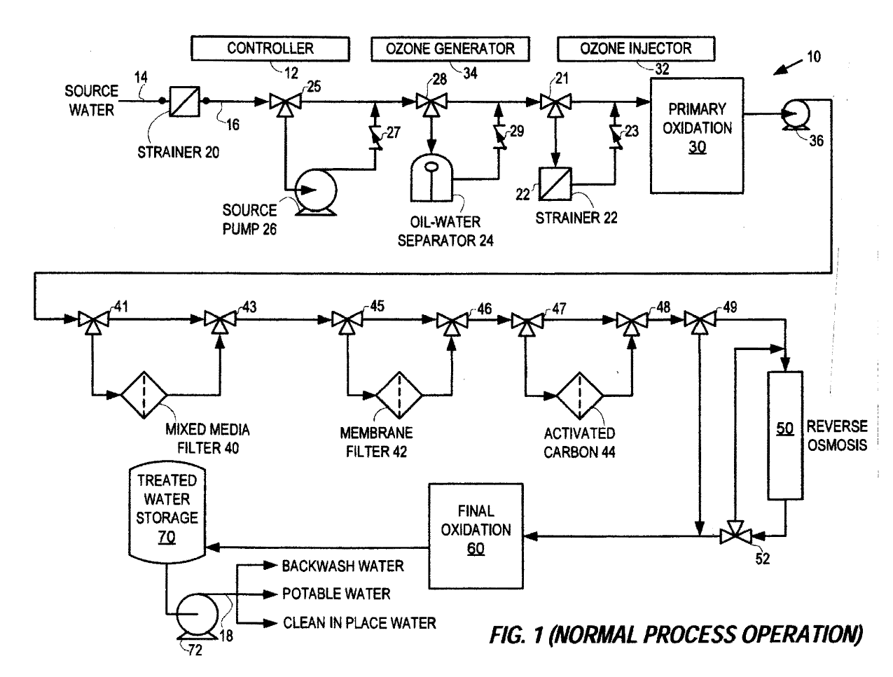

FIG. 1 provides a simplified illustration of the major components of one embodiment of the water treatment system 10 and the principal water flow paths through the treatment system 10 during normal operation. The treatment system 10 is under the control of a conventional programmable controller 12 operating applications software specifically developed for the system 10. Typically, water from a raw water source is received into the inlet 14 of a conduit subsystem 16 of the treatment system 10. The conduit subsystem 16 provides a water flow path through the treatment system 10 to an outlet 18 for potable water. The treatment system 10 may include a variety of different water treatments subsystems, including an optional debris strainer 20, a particulate strainer 22, an optional oil-water separator 24, a primary oxidation subsystem 30, a series of filtration subsystems 40, 42, and 44, a reverse osmosis subsystem 50, and a final oxidation subsystem 60. The resulting treated potable water is held in a finished water storage tank 60, where it is held for distribution as needed, and also as a source of clean water for backwashing or clean-in-place processing during the “backwashing operation” mode of operation.

In the event the controller 12 receives signals from pressure sensors (not shown) that the pressure of the source water entering the conduit subsystem 16 is insufficient for proper system operation, the controller 12 may direct the raw source water through a suitable valve 25 in the conduit subsystem 16 to a raw water source pump 26 to pump the water source into the treatment system. The source pump(s) 26 used is preferably capable of handling solids without damage. Pressurized water flowing from the pump 26 may then be directed back through a suitable valve 27, such as a check valve, into the primary water path of the conduit subsystem 16. In the event that raw water is available from a pressurized source at a sufficiently high pressure to meet process flow requirements, the raw water pump 26 need not be operated at all. The source pump 26 may also be used to raise the pressure of incoming water to meet requirements.

The system 10 may have the optional debris strainer 20 which the operator can manually place into the incoming source water flow path at the input into the conduit subsystem 16 to prevent the entry of debris, large particulates, and other objects large enough to damage the pump 26 in the event the operator believes that the source water may contain such debris or objects. An oil-water separator 24 may be an optional component of the system 10 in most instances because it is anticipated that most raw water sources to be treated using the system 10 will not be contaminated by oil to a degree that the amount of oil present in the water will not be removed by other process elements. However, inclusion of oil-water separator element 24 may be included in the treatment system 10 by having the controller 12 direct the source water through valve 28 in the conduit subsystem 16 to the oil-water separator 24 to separate oil in the source water from the water prior to redirecting the water through a suitable valve 29, such as a check valve for instance, into the primary water path of the conduit subsystem 16.

The source water may then be directed through a suitable valve 21 to the particulate strainer 22 which can act as a physical barrier to further trap and remove from the water solids of particulate sizes that could potentially inhibit water flow, clog filtration media and/or otherwise disrupt the treatment processes of the treatment subsystems located downstream of the strainer 22. Strained water from the particulate strainer 22 may then be directed back to the primary water flow path of the conduit subsystem through a suitable valve 23, such as a check valve.

After straining, the source water is directed by the conduit subsystem into a primary oxidation subsystem 30 where the water is treated with ozone injected through an ozone injector 32 from an ozone source. Preferably, the ozone source in a local ozone generator 34. Ozone addition enhances coagulation of smaller particles remaining in the raw source water, making them easier to filter. In addition, ozone-mediated oxidation prior to filtration will remove most taste and odor causing compounds, enhance water clarity and aesthetics, oxidize iron and manganese compounds, and provide an initial disinfection to eliminate bacterial and viral pathogens. Ozone addition prior to filtration also enhances filter performance and filter media longevity.

Preferably, the primary oxidation subsystem 30 includes a dissolved air flotation element (not shown) to be described hereinafter. When the primary oxidation subsystem 30 includes a dissolved air flotation element, the ozone injector is adapted to inject a combination of air and ozone into the primary oxidation subsystem for enhancing the separation of organic contaminants and oil from the water and the disinfection and oxidation of the resulting water separated from the organic contaminants and oil. Unlike the prior strainers and oil water separator treatment elements, the primary oxidation system 30 is not an optional treatment element and remains in the water treatment conduit flow path of the current embodiment at all times.

After primary oxidation, a feed pump 36 fluidly connected into the conduit subsystem downstream of the primary oxidation subsystem 30, feeds or pumps the partially treated water through the remainder of the treatment subsystems, except when the reverse osmosis subsystem is used. When the reverse osmosis subsystem is required, feed pump 136 delivers the partially treated water to a booster pump located immediately upstream of the reverse osmosis subsystem.

The partially treated water pumped from the feed pump 36 can be directed by the controller 12 through a suitable valve 41 to the first of one or more filtration subsystems to remove smaller particulates from the water. Preferably, the water flow can be directed by the controller 12 through a mixed media filtration subsystem 40 as the next step in the treatment process. Such a mixed media filtration subsystem 40 may comprise a mixture of anthracite and sand. The mixed media filtration subsystem is preferably designed to physically remove particles larger than approximately 1 micron from the partially treated water prior to treatment in the next treatment subsystem. Treated water exiting the filtration subsystem 40 may then be redirected to the primary water flow path through the conduit subsystem through another suitable valve 43.

The controller 12 may next direct the treated water to a membrane filtration system 42 through a suitable valve 45. In membrane filtration subsystem 42, any remaining undissolved or suspended solids ranging in size down to approximately 0.1 microns may be removed. Large bacterial organisms may also fall within the particle size range for which membrane filtration is effective, and any such bacteria present will be removed in this treatment process. Filtration membranes used in this subsystem encompass membranes often referred to as micro-filtration membranes, as well as those referred to as ultra-filtration membranes, depending on membrane porosity, used singly or in combination. The use of membrane filtration instead of the conventional sedimentation plus filtration technique substantially reduces the volume of the filter media required, and thus reduces treatment apparatus size and total space requirements. Treated water exiting the subsystem 42 may then be redirected to the primary water flow path through the conduit subsystem 16 through another suitable valve 46.

The controller 12 may next direct the treated water through an activated carbon filtration subsystem 44 through a suitable valve 47. The filtration subsystem 44 may comprise one or more vessels containing granular activated carbon, and is utilized downstream from the membrane filtration element to adsorbs VOCs and/or other dissolved chemical compounds remaining in the partially treated water. Activated carbon provides a barrier against the passage of contaminants such as pesticides, industrial solvents and lubricants that are physically absorbed by the carbon. Partially treated water exiting the activated carbon filtration subsystem 44 may then be redirected through a valve 48 to the primary water flow path through the conduit subsystem.

Because the raw water supply may contain dissolved salts, in concentrations which may range from slightly brackish to the salinity of seawater, the system 10 also may include a reverse osmosis subsystem 50, which utilizes a semi-permeable membrane desalination process. For raw water with low concentrations of salts the reverse osmosis subsystem can be operated in a serial or sequential mode and achieve satisfactory results. However, when salinity is high, as when the raw water to be treated is seawater, the reverse osmosis subsystem can be set to operate in a single pass mode. In alternative embodiments, water exiting the reverse osmosis subsystem 50 may be redirected by the controller 12 through a suitable valve 52 back to the entrance of the reverse osmosis subsystem 50. The multi-mode operation provided by the reverse osmosis subsystem allows a single membrane grade to successfully treat waters with a wide range of salt concentrations. In addition to desalination, the reverse osmosis subsystem 50 will also function to remove many chemical contaminants that may remain in the partially treated source water. Treated water exiting the reverse osmosis subsystem that the sensors show meets suitable water quality standards may then be directed through valve 52 to final oxidation subsystem 60.

The final oxidation subsystem 60 provides a disinfection and advanced oxidation process (“AOP”) which is used to treat the incoming partially treated water to destroy or remove any remaining pathogenic organisms that were not removed or destroyed in upstream treatment elements and subsystems. This second or final oxidation subsystem 60 preferably comprises a stainless steel contact chamber fitted with an ozone injector, in which ozone from the ozone source is injected in sufficient concentrations that the water is in contact with the ozone for a sufficient period of time to accomplish a final disinfection of the treated water. In some embodiments, the water exiting the contact chamber of this second oxidation subsystem after final disinfection may be routed to an ultraviolet light exposure chamber to convert any residual ozone into OH hydroxyl radicals to destroy any remaining toxic compounds. The treated finish water is then routed to the treated water storage tank 70 where it may be held for later distribution. The treated water reaching the storage tank 70 is free of impurities, and is clean and safe for human consumption and use. A service pump 72 controllable by controller 12 is fluidly connected between the water storage tank 70 and the outlet 18 of the conduit subsystem 16, and the controller 12 can direct the pump 72 to pump water from the tank 70 for distribution. The treated water may also be used as a source of clean water for backwashing or cleaning-in-place system elements when needed, as will be described in more detail hereinafter.

Preferably, the ozone used in the treatment system is generated in an on-site ozone generator 34. Generation of ozone requires only ambient air and electricity, so it is much more feasible to produce the required ozone on-site than to transport chlorine and/or other treatment chemicals to the location of the water to be treated. The ozone used in the system 10 is generated as needed rather than being stored, as would be necessary if, e.g., chlorine were used for disinfection. Chlorine is a very hazardous gas, and storage of chlorine to be used as a disinfectant creates substantial risk of health and environmental damage. The use of ozone in the system is also preferred because ozone has the advantage of being one of the most powerful oxidants known. Ozone can be easily monitored and measured using simple field tests, unlike other non-chlorine agents, which require the use of delicate and expensive test equipment that is not well suited for field use.

The water treatment system 10 includes apparatus for multiple types of treatment process steps that, in combination, is capable of treating raw source water for the removal of the full range of contaminant materials that can be realistically expected to be present in a wide variety of raw water sources. The system 10 includes treatment subsystems and elements with the capacity to address and treat the highest anticipated levels of contaminant and impurity concentrations envisioned for treatment with systems of the current embodiment. The controller 12 can, however, based upon the condition of the water moving through the system, determine whether a particular treatment step is needed, and automatically by-pass any unnecessary treatment subsystems and elements. The controller's ability to determine the presence, or absence, of contaminants in the water at various locations throughout the treatment system and automatically adjust the treatment steps and parameters needed to produce potable water maintains the highest achievable operating efficiency. The high degree of efficiency achieved by the system 10 minimizes operating costs as well as equipment wear.

While the system shown in FIG. 1 is capable of treating and purifying highly contaminated water by including all treatment subsystems and elements in the water treatment flow path, it will be recognized that not all raw water sources will be so severely contaminated as to require the full treatment scope to provide potable water. In approaches heretofore it has been common to customize each treatment system to include only treatment apparatus that will be used at a particular site to address a specific set of contaminants, thereby limiting its ability to treat water from the raw water source at the site if the condition of the raw water changes. Under such approaches there was no standardization in construction, and each system became an independent design and build project—an inherently less efficient approach to construct treatment systems on site, in comparison to a production facility set up to optimize the construction process. This practice is also more likely to produce treatment systems with differing operating parameters and control requirements and require more extensive operator training

In summary, the most economical and efficient treatment approach is to treat raw water from a particular source for only the contaminants that are actually present in that water source. The system provides that capability with a standardized set of treatment subsystems and elements in a standardized configuration. Standardization of the system apparatus and construction of systems offsite greatly facilitates the construction process and reduces costs. In the illustrated embodiment of the system 10, treatment elements may be included in the flow path of the water being treated, or excluded from the flow path, depending upon whether the type of contaminant addressed by an element is or is not present in the raw water.

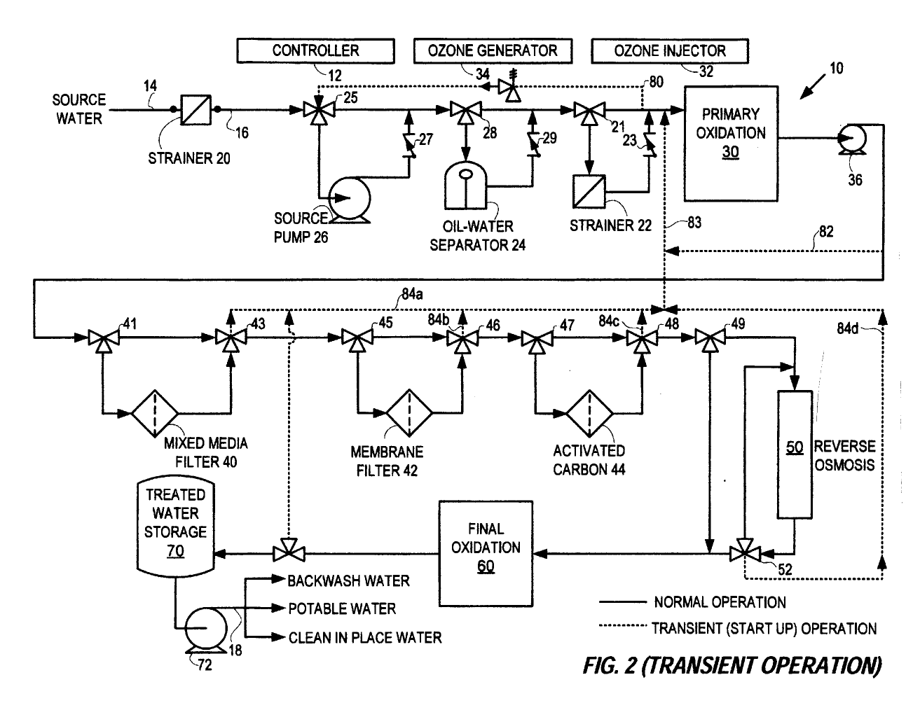

FIG. 2 depicts the additional principal water flow paths of the system 10 of FIG. 1 during the “transient” mode of operation, which is selected by the controller 12 during the startup of the system 10 or during an “upset” condition in the system detected by the controller 12. The subsystems and elements of FIG. 2 corresponding to the same parts of FIG. 1 are designated with like reference numerals.

During the startup of the system 10, the controller 12 selects the “transient” mode of operation of the system 10, which remains in the transient mode until the controller determines that the water quality of the water entering the storage tank is that of potable water and that a steady state condition in the water quality has been achieved. Until such a determination is made, the controller 12 initially directs the system to recycle the water upstream of the primary oxidation system 30 through a return conduit 80 to valve 25 upstream of the source pump 26, as shown as a dotted line in FIG. 2, until the controller determines that the water quality of the water immediately upstream of the primary oxidation subsystem 30 is of sufficient quality that it can be successfully treated by the primary oxidation subsystem 30.

The controller 12 then directs the water to the primary oxidation subsystem 30 for primary treatment and then recycles the water to the input to the primary oxidation subsystem through conduit 82 and 83 until the water quality of the water downstream of the primary oxidation system 30 is of sufficient quality to be treated by at least one of the filtration subsystems 40, 42, and 44. In a like manner, the partially treated water exiting the filtration subsystems, the reverse osmosis subsystem and the final oxidation subsystem is recirculated through conduits 84a and 83, 84b and 83, 84c and 83, 84d and 83, and 84e and 83, respectively, until the partially treated water exiting each of such treatment subsystems discharges water of a sufficient water quality to be treated by the next subsystem located downstream of it.

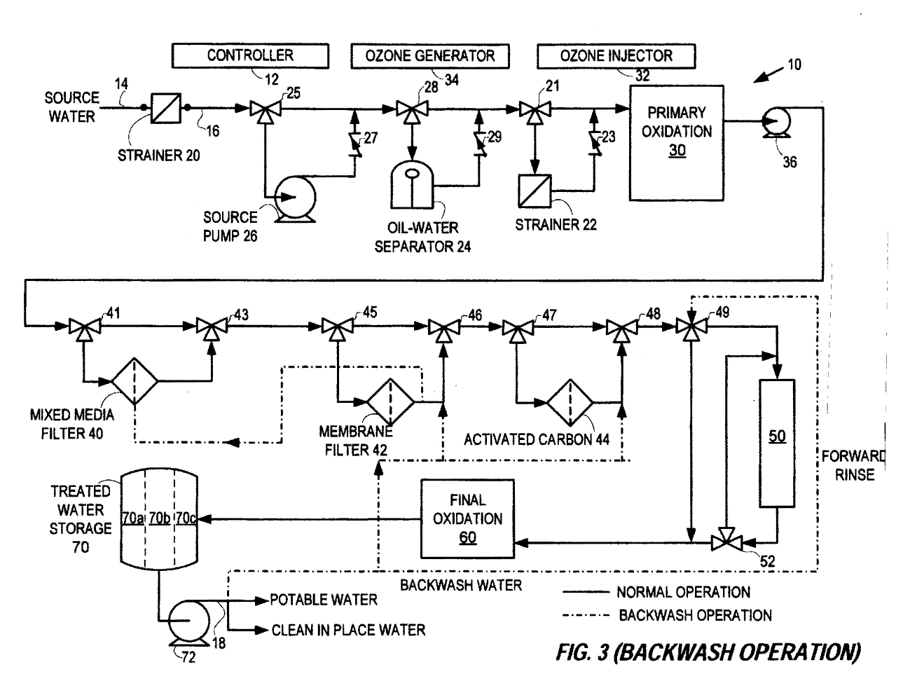

FIG. 3 depicts the principal water flow paths of the method of FIG. 1 during the backwashing mode of operation. The subsystems and elements of FIG. 3 corresponding to the same parts of FIG. 1 are designated with like reference numerals.

As with all filtration elements or components, filter media will become loaded with contaminants filtered from the fluid flowing through the element, and will require replacement, or backwash to flush accumulated contaminant materials from the media and out of the filtration subsystem. In addition to treatment process flow through the elements of the system, FIG. 3 also shows a backwash flow path. Water used for backwash in the example of FIG. 3 is drawn from the finished water storage tank 70 and is routed through the treatment element apparatus that is to be cleaned, in a path that may be essentially a reverse of the illustrated treatment flow path during normal operation. Backwash water, with entrained contaminant materials, can be returned to the raw water source, or otherwise appropriately disposed of.

The treated water storage tank 70 may be partitioned into three separate storage volumes 70a, 70b, and 70c, respectively, for use for storing finished potable water for later distribution; for use as a source of clean water for backwashing treatment elements, and another for use as a source of clean-in-place water for cleaning the treatment elements in place. The source for backwash water and the backwash flow paths are both subject to variation while remaining within the scope of the disclosure, and the paths shown by the dashed lines in FIG. 3 are not to be taken as limiting. It will be understood that backwashable elements and components of the system 10 will not require backwash at the same time, due to factors such as uneven contaminant loading. The controller is designed and operated to be capable of establishing the most efficient and effective backwash flow path in differing loading circumstances, typically based upon pressure differentials detected by sensor components.

### Detailed System Description

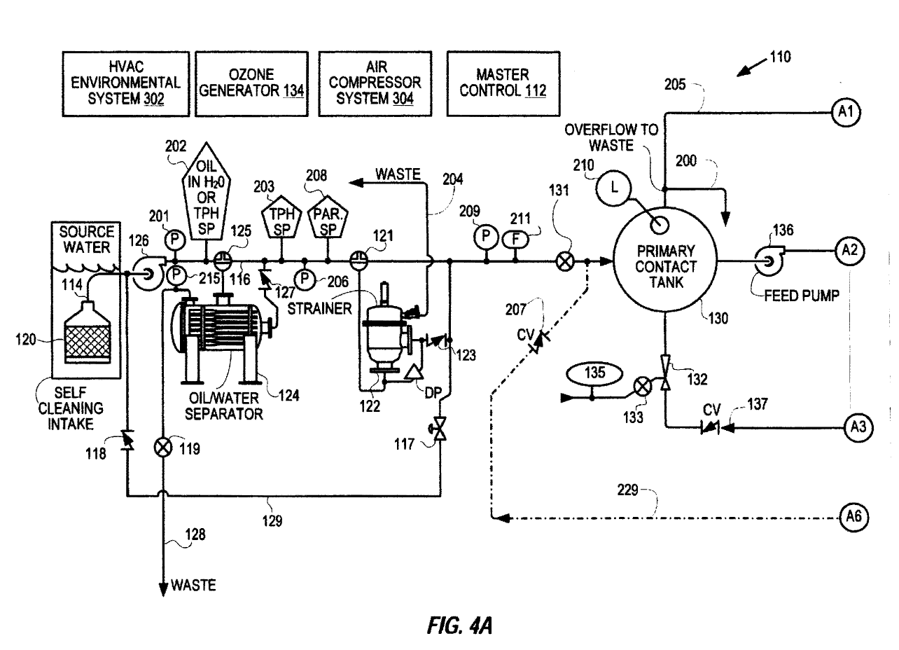

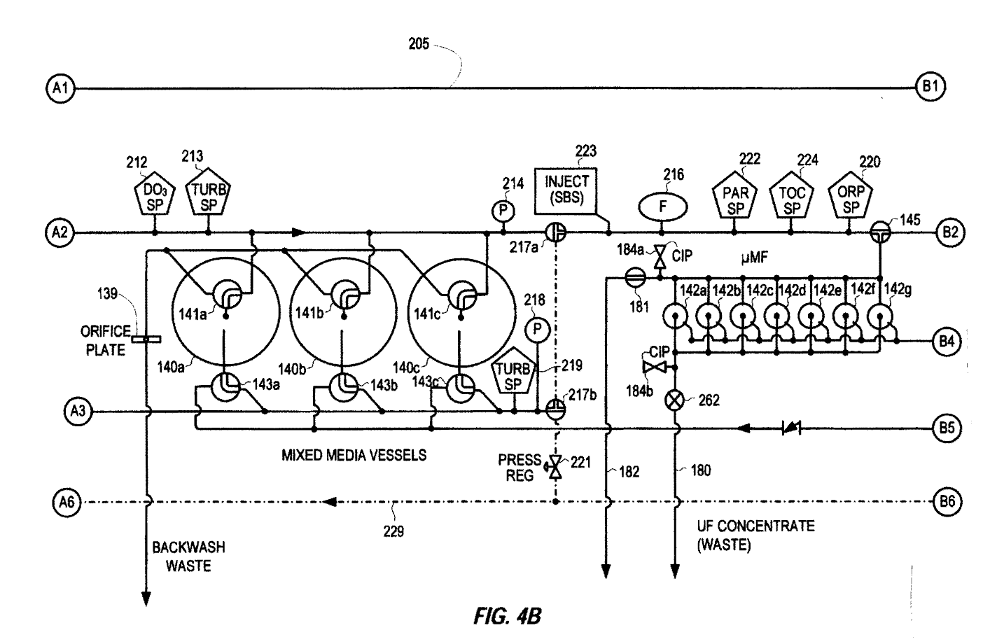

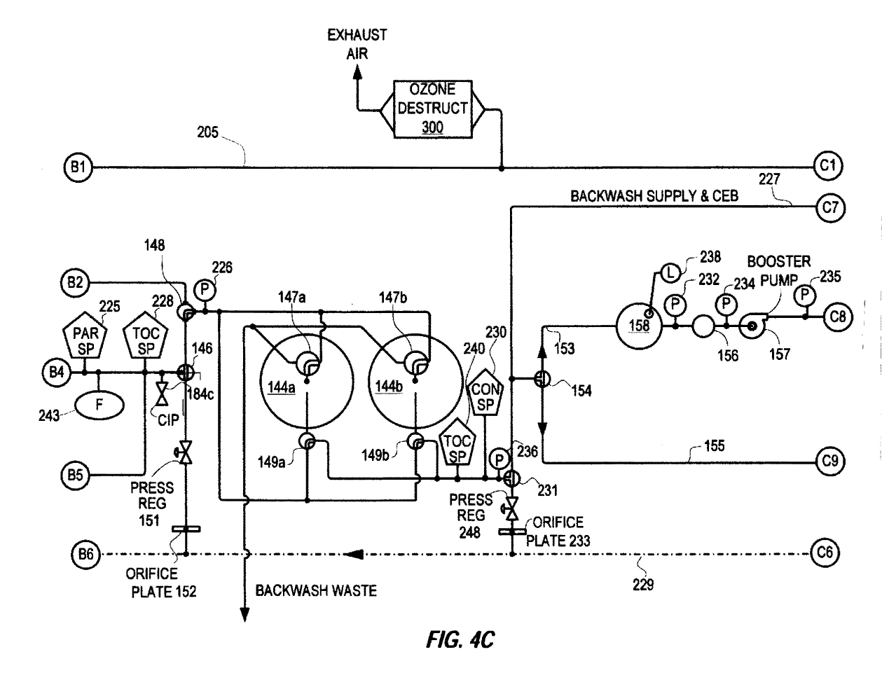

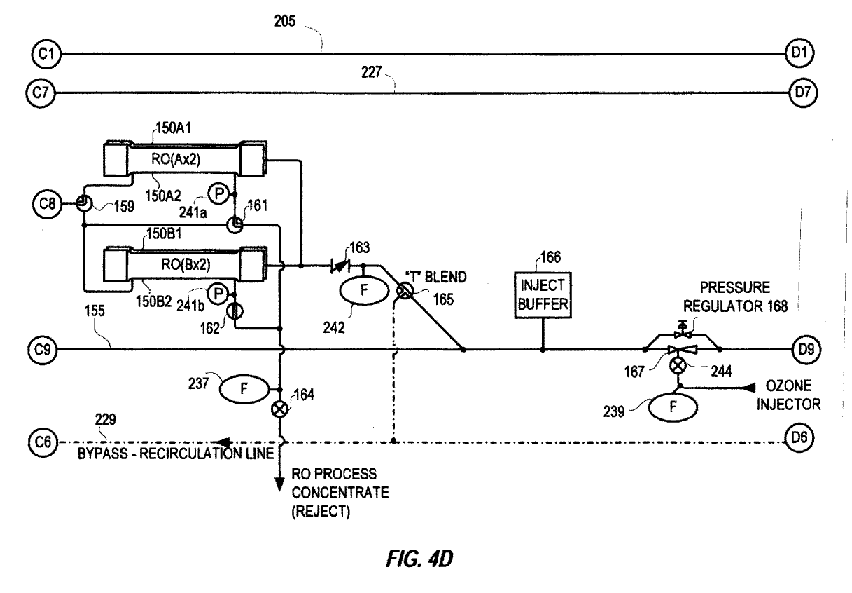

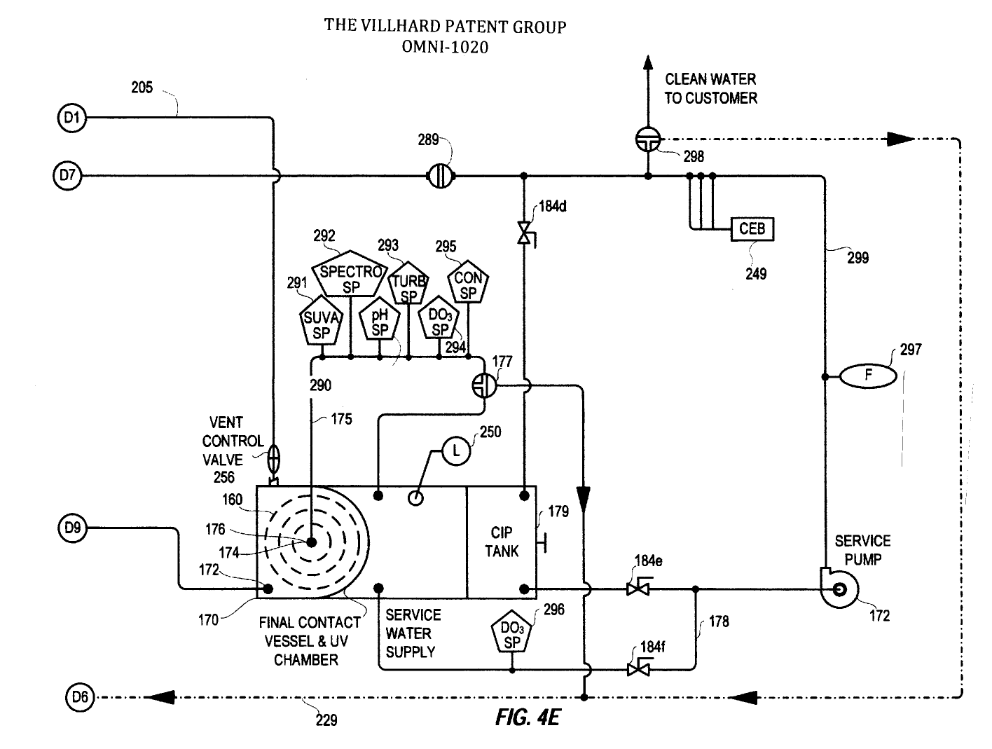

FIGS. 4A through 4E depict a substantially more detailed illustration of one embodiment of the subsystems, elements, control system components, and other apparatus of the system 10 of FIGS. 1 through 3 and the treatment process water flow during transient, normal and backwashing modes of operation.

The water treatment system 110 is under the control of a conventional programmable controller 112 operating applications software specifically developed for the system 110. The controller is part of a sensing and control subsystem that includes sensors to detect the presence, absence, or magnitude of certain contaminants. The subsystem also includes various actuation means (such as motorized valves) which receive signals from the processor(s) in the controller and activate as directed to establish the flow path determined to be appropriate for the treatment needed.

The controller 112 receives a variety of input signals from the variety of sensors (to be described hereinafter) electrically coupled to the controller which measure the characteristics of the water, including various water quality parameters, at a variety of sample points (“SPs”) located throughout the treatment system 110. The applications software of the controller receives these signals and determines which valves, elements and other components of the system 110 electrically connected to the controller need to be sent output signals in order for the controller 110 to select the mode of operation and the treatment subsystems and elements of the system 110 to be operated during a given mode and time interval.

Sensor apparatus, processors, and automatically operable valves appropriate for use in the sensing and control portions of the system 110 are known, and any such components that will provide the performance for effective operation of the system in accordance with the method of the disclosure may be used.

The network of sensors utilized in the system is designed and intended to collect and transmit a wide array of operational information to the control system processor(s), which maintain an ongoing monitoring of system operation and element effectiveness in real time and in comparison to pre-selected parameters, and generate command signals to, e.g., the motorized valves, so as to make adjustments and changes needed to maintain optimal process conditions. The comprehensive array of sensors, processor(s), and physical equipment actuators provides sophisticated control over system operations and allows the system 110 to operate for extended periods without human intervention. The comprehensive nature of the control system reduces the need for onsite operator time and significantly reduces operator training, saving both time and money.

As depicted in FIGS. 4A through 4E, water from a raw water source is typically received into the inlet 114 of a conduit subsystem 116 of the treatment system 110. The principal treatment subsystems and elements that are fluidly coupled or can be fluidly coupled by the controller 112 to the conduit subsystem 116 include an optional suitable debris strainer 120, source pump 126, an optional oil-water separator 124, a particulate strainer 122, a primary contactor/oxidation tank 130, preferably including a dissolved solids flotation element (not shown), a feed pump 136, mixed granular media filter elements (140a through 140c), membrane filter elements (142a through 142g), granular activated carbon filter elements (144a and 144b), reverse osmosis elements (150A1, 150A2, 150B1, and 150B2), a final contact vessel 170 with an ultraviolet light source, a clean water storage tank or service water supply tank 170, and a service pump 172. The conduit subsystem 116 provides a water flow path through various selectable treatment subsystems and elements described herein below of the treatment system 110 to an outlet 118 for potable water. Clean treated water in the service supply tank 170 is held for distribution as potable water as needed, and also as a source of clean water for backwash and/or clean in place (CIP) operations during the backwashing mode of operation.

### Debris Strainer and Source Pump

Similarly to the embodiment of the system 10 of FIGS. 1-3, the system 110 may have an optional debris strainer 120 which the operator can manually place into the incoming source water flow path at the input 114 into the conduit subsystem 116 to prevent the entry of debris, large particulates, and other objects large enough to damage the pump 126 in the event the operator believes that the source water may contain such debris or objects. A suitable strainer 120 is an autowashing debris strainer.

FIG. 4A depicts a water source from which raw water can be drawn or admitted to the system 110. When the water pressure of the source water is too low to drive water into the treatment system 110, the controller, in response to certain sensor signals described herein below, can send control signals to the source pump 126 to operate the source pump to draw water from the water source into inlet 114 of the conduit subsystem 116. For instance, the controller may activate the source pump 126 when a demand signal is received by the controller (i) from pressure sensor 201 fluidly coupled to the conduit subsystem immediately after the source pump to indicate that the pressure of the incoming source water is insufficient for the treatment system to operate properly or (ii) a demand for treated water (which may occur when, e.g., the level sensor 250 in the clean water storage tank 170 senses that the level in the clean water storage tank or service water supply tank 170 drops below a predetermined level). If so, the system controller 112 will initiate the treatment sequence.

In the event that raw source water is available from a pressurized source at a sufficiently high pressure to meet process flow requirements, the source pump 126 need not be operated. If the water pressure is outside the range programmed into the system controller 112, the controller can adjust pressure and flow in a manner to be described hereinafter for the desired balance. The type of source pump 126 that may be used is preferably a self-grinding style which is capable of handling solids, without damage, below the particle size allowed by the auto washing strainer 120. As previously noted, the strainer 120 may also be removed from the system process train if the raw water source contains particles below the threshold required for its use.

### Oil-Water Separator

An oil-water separator 124 may be an optional component of the system 110 because it is anticipated that most raw water sources to be treated using the system 110 will not be contaminated by oil to a degree that the amount of oil present in the water will not be removed by other process elements. However, inclusion of oil-water separator element 124 may be included in the treatment system 110 by having the controller 112 direct the source water through the conduit subsystem 116 to the oil-water separator 124 to separate oil in the source water from the water prior to redirecting the water into the primary water flow path of the conduit subsystem 116.

With raw water flowing into the system 110 at an acceptable rate and pressure, a sample point (“SP”) 206 for a hydrocarbon analyzer (or oil detector) electrically coupled to the controller can sense the presence or absence of “total petroleum hydrocarbons (“TPH”) (hereinafter referred to as oil) contaminants in the raw water at the sample point. Downstream of the SP 206 is the oil-water separator 124, which may be included to remove undissolved or emulsified oil and fuel contaminants from the raw source water. If an oil contamination level is detected at SP 202, which exceeds a predetermined threshold value, an output signal will be sent by the hydrocarbon analyzer to the system controller 112. The controller will, in turn, provide a control signal to activate valve 125 to direct the raw water flow into the oil-water separator. Another SP 203 measures the TPH downstream of the oil-water separator. If the TPH is too high, a suitable auto control valve 131 is adjusted such that all or a portion of the water is recirculated through a pressure regulating valve 117 and a pressure check valve 118 in conduit 129 to the inlet to the source pump. A pressure sensor 206 coupled to the conduit downstream of the oil-water separator monitors the discharge pressure of the oil-water separator. Oil separated from the water is collected and removed through conduit 128 for disposal or reprocessing. A flow control valve 119 may be fluidly coupled into the conduit 128 to regulate the flow rate of the waste exiting the system through conduit 128. Another pressure sensor 208 may be coupled into the waste conduit 128 to measure the waste flow discharge pressure of the oil-water separator. The pressure measurements of pressure sensors 201, 206, and 215 are then used by the controller to determine the differential in pressure between the input, output and reject outlet of the oil water separator to adjust the control valve 119 of the waste conduit 128.

If the oil threshold is not met, the raw water will bypass the oil water separator and continue downstream. The oil-water separator 124 is located first in the treatment process train to allow the removal of oil type contaminates from the raw water at the earliest possible opportunity to prevent oil fouling and degradation of downstream process elements.

### Particulate Strainer Filtration

A strainer 122, such as a self-cleaning automatic screen filter, may be fluidly coupled to the conduit subsystem 116 downstream of the oil-water separator 124. Strainer element 122 acts as a physical barrier to trap and remove from the water entering the downstream treatment elements solids of particulate sizes that could potentially inhibit water flow, clog filtration media and or otherwise disrupt the treatment process. A particle sensor sample point SP 208 or a turbidity sensor sample point (not shown) may be located upstream of the strainer 122 to provide information to the controller 112 as to whether the water being treated contains debris or particles larger than a predetermined threshold value. If the threshold value is met, the controller 112 will send a signal to actuate valve 121 and direct the water in treatment through the strainer element 122. Following the removal of particulates by the strainer 122, the partially treated water may be returned through a suitable valve 123, a check valve for instance, to the primary water flow path. The rejected waste stream is returned through a conduit 204 to the source water or otherwise properly disposed of. If the threshold particle value is not met, valve 121 will be positioned by the controller 112 to allow the water in treatment to by-pass the strainer 122. Pressure sensor 209 measures the pressure and flow sensor 211 measure the flow of the water in the conduit 116 downstream of the strainer 122. Preferably, strainer 122 will be selected to remove particles of approximately 100 micron or larger from the raw water. This will control the size of particles reaching the mixed media filter elements 140a through 140c to improve their process efficiency and reduce the frequency of filter backwash required.

### Primary Oxidation

The water in treatment next passes to the primary contact tank 130 for primary oxidation. Primary oxidation is performed by injecting ozone into the water in treatment and is performed in all operating configurations of the system 110. The water level in the primary contact tank may be monitored by a level sensor 210 and is controlled by adjusting flow control valve 131 based on feedback provided to the controller 112 by level sensor 210. When the level sensor 210 sends a demand signal to the controller for more water, the position of flow control valve 131 and the output of source pump 126 will be adjusted to maintain a predetermined water level in the primary oxidation tank or primary contact tank 130. Overflow waste is routed through conduit 200 back to the raw source source or otherwise properly disposed of Ozone may be injected into the primary contact tank 130 using water drawn from the same tank by feed pump 136, and directed through ozone injector 132. Ozone will be supplied to ozone injector 132 preferably by an ozone generator 134. As depicted in FIG. 4A, the amount of ozone supplied to the injector 132 may be controlled by the ozone flow control valve 133 based on a dissolved ozone reading taken at the dissolved ozone sample point 212 in the treatment process flow downstream of the primary contact tank 130. The controller will receive the input signal from the ozone sensor coupled to SP 212 and generate the control signal to the ozone flow control valve 133. If the concentration of ozone downstream of the primary contact tank 130 is not within a predetermined range, a signal is sent by the controller to either increase or decrease the rate of ozone injection, as needed. The rate of ozone injection may be measured by flow meter 135. The primary contact tank 130 is preferably a gravity cylinder (unpressurized) to reduce the amount of energy required to inject ozone into the raw water in treatment.

Preferably the primary oxidation tank 130 includes a dissolved air flotation element. When the tank 130 includes a dissolved air flotation element, the ozone injector is adapted to inject a combination of air and ozone into the primary oxidation subsystem for enhancing the separation of organic contaminants and oil from the water and the disinfection and oxidation of the resulting water separated from the organic contaminants and oil. Ozone is preferably used for several reasons. It is one of the most powerful disinfectant industrially available to eliminate bacterial and viral pathogens, it requires no consumables other than electricity, it enhances flocculation and coagulation of smaller particles remaining in the water in treatment, making them easier to filter, it lowers the surface tension of the water so particles come out of solution easier in the downstream mixed media filter elements (140a through 140c) and the membrane filter elements (142a through 142g), and it makes these same filter elements easier to backwash. Ozone inactivates algae and bio slimes created by algae which can cause bio fouling in the mixed granular media filter elements 140a through 140c and the membrane filter elements 142a through 142c. Bio fouling degrades the performance of these filters and reduces their effective filtration. In addition, ozone mediated oxidation prior to filtration can remove most taste and odor causing compounds, enhance water clarity and aesthetics, oxidize iron and manganese compounds, and provide an initial disinfection.

Preferably, the ozone injected into the treatment system (in both the primary contact tank 130 and the final contact chamber 160 is generated on-site by the ozone generator 134. Generation of ozone requires only ambient air and electricity, so it is much more feasible to produce the required ozone on-site than to transport chlorine and/or other treatment chemicals to the location of the water to be treated. The ozone used in the system 110 is preferably generated as needed rather than being stored, as would be necessary if, e.g., chlorine were used for disinfection. Chlorine is a very hazardous gas, and storage of chlorine to be used as a disinfectant creates substantial risk of health and environmental damage. Ozone can be easily monitored and measured using simple field tests, unlike other non-chlorine agents, which require the use of delicate and expensive test equipment that is not well suited for field use.

### Feed Pump

A feed pump 136 may be located downstream of the primary contact tank 130. The feed pump 136 serves two primary purposes: it is the primary pump used to deliver partially treated water through the remaining system elements and other apparatus downstream of the primary contact tank 130 under most operational circumstances, and it is used to direct water to ozone injector 132. Inputs from pressure sensor 214, flow sensor 216, and level sensor 210 are the primary inputs used by the controller 112 to control the output of feed pump 136.

### Mixed Media Filtration

As depicted in FIG. 4B, after primary oxidation, the partially treated water may flow through a plurality of mixed media filter elements, elements 140a through 140c for instance, as the next step in the treatment process. The filter media used in these treatment elements typically include a mixture of commonly used materials (e.g. anthracite, sand, and garnet). These mixed media filter elements will physically remove gross particles larger than approximately 0.5 microns to 1 micron from the partially treated water prior to the subsequent processing step(s). Preferably, mixed granular media filters are used ahead of the plurality of membrane filter elements, elements 142a through 142g for instance, because they can tolerate a heavier accumulation of solids and they demonstrate a more efficient capture and release of solids compared to membrane filters. Placing the mixed media filters ahead of the membrane filter elements therefore reduces fouling of the membrane filter elements which prolongs membrane filter throughput. The backwash water volume for mixed media filters is also lower than for membrane filters so capturing solids in a mixed media filter will result in less treated water being lost to waste due to frequent membrane filter backwashes.

The pressure differential between water entering the mixed media filtration elements and leaving the elements is measured by pressure sensors 214 and 218. The magnitude of the differential pressure is used by the controller 112 to determine whether a backwash operation is necessary to restore pressure and flow to within an acceptable range. Preferably, the mixed media filter elements 140a through 140c are configured for parallel flow so they can be independently controlled between the normal treatment processing mode of operation and the backwashing mode of operation. By noting the differential pressure measured by pressure sensors 214 and 218 and the output of the flow meter 216 prior to taking a mixed granular media filter vessel off-line and then selectively taking an individual mixed granular media filter element off-line and observing the change in output of the pressure sensors 214 and 218 and the simultaneous change in output of the flow meter 216 a calculation can be made by the controller 112 to determine which, if any, mixed media filter elements require backwashing. When a mixed media filter requires backwashing, that one element is taken out of the normal treatment flow mode and put into backwash flow mode while the remaining elements in the subsystem continue in the normal treatment processing mode. The controller activates suitable valves, valves 141a, 141b, 141c, 143a, 143b, and 143c for instance, according to a predetermined algorithm implemented by the applications software of the controller to remove one filter element out of the treatment flow and direct process flow through the remaining filter elements. Water flow leaving the mixed media filter elements 140a through 140c is checked at oxidation reduction potential (“ORP”) sample point SP 220 to ensure that no ozone remains in the partially treated water. The presence of too much ozone would be harmful to membrane filter elements 142a through 142g which are next in the treatment process train. Based on the ORP measurements taken at SP 220, the controller 112 can determine whether or not to activate the sodium bisulfite (SBS) injector 223 and if activated, how much SBS should be added to the partially treated water to neutralize the ozone present.

### Membrane Filtration

As depicted in FIG. 4B, in the plurality of membrane filter elements, elements 142a through 142g for instance, any remaining undissolved suspended solids in the partially treated water ranging in size down to approximately 0.1 microns are removed. On a limited basis, some of the dissolved contaminates may be removed as well. Readings of particle characteristics (size and number) by a particle counter or of turbidity by a turbidity meter (not shown) at SP 222, and of oxidation reduction potential (“ORP”) at SP 220 are used to determine if the membrane filter elements 142a through 142g are needed to further treat the already partially treated water. If the particle count and/or turbidity are above a predetermined threshold, the controller will activate a suitable valve 145 to direct the partially treated water through the membrane filter elements. If the particle count and/or turbidity levels are below the threshold, the membrane filter elements 142a through 142g are bypassed. Bypassing the membrane filter elements when feasible not only reduces energy consumption associated with maintaining pressure across the membrane filtration elements but also prolongs the useful life span of the membranes themselves.

During the normal mode of operation, the membrane filter elements will output two streams of water. The primary output is water treated by the membrane filters which continues downstream to a suitable valve 146, a three-way diversion valve for instance. The second output is the concentrate waste stream collected through conduit 180, which waste is collected for disposal/reprocessing or diverted back to the water source. Pressure sensors 218 and 226 are located respectively at the input and output of the membrane filter elements and provide inputs used by the controller 112 to calculate the differential pressure across the membrane filter elements 142a through 142g. When the differential pressure reaches a predetermined threshold, the controller 112 will activate a reverse flush process for the membrane filters. To accomplish the reverse flush process, the controller will activate the service pump 172, and configure the various valves, including valves 146, 148, 147a, 147b, 149a, 149b, 231 and 289, as appropriate, to supply clean water to the backside of the membrane filter elements 142a through 142g. Water used for the reverse flush process is then diverted through valve 181 to the waste stream conduit 182. When the frequency of reverse flush operations exceeds a predetermined threshold, the operator of the system may manually activate the clean in place (“CIP”) process by manually switching the CIP valve 184a. The CIP process is similar to the reverse flush process with the addition of CIP chemicals and a soak cycle to allow the CIP chemicals to remain in contact with the filter membranes for a predetermined duration. The frequency at which the membrane filter reverse flush and/or cleaning occurs is selected to optimize the loss of treated water due to reverse flush and/or cleaning processes and the increased energy required to overcome the higher differential pressure which results as the membrane filter fouling progresses.

Large bacterial organisms can fall within the particle size range for which membrane filtration is effective, and any such bacteria present will be removed in the membrane filtration step. Filtration membranes used in the membrane filtration subsystem encompass membranes often referred to as micro-filtration membranes as well as those referred to as ultra-filtration membranes, depending on membrane porosity, used singly or in combination. Preferably, the system may include ultra-filtration membranes, micro-filtration membranes, or both depending on the specific application. The use of membrane filtration, instead of the conventional sedimentation plus filtration treatment process, substantially reduces the volume of the filter media required, and thus reduces apparatus size and total space requirements for the treatment system.

### Activated Carbon Filtration

As depicted in FIG. 4C, the activated carbon treatment subsystem may include a plurality of activated carbon filter elements, such as activated carbon elements 144a and 144b configured in a parallel configuration. Each element is typically a vessel containing granular-activated carbon. Activated carbon elements are located downstream of the membrane filter elements 142a-142g to protect the granular activated carbon from any gross contaminants removable by the membrane filter elements. This preserves the activated carbon filter elements 144a and 144b from unnecessary fouling and saves them for removing organic compounds and/or other dissolved chemical compounds such as pesticides, industrial solvents and lubricants remaining in the partially treated water. Activated carbon elements provide a barrier against the passage of these types of contaminants which are physically adsorbed by the granular activated carbon.

Water leaving, or bypassing, the membrane filter elements 142a-142g is monitored for total organic carbon content at a TOC sample point SP 228 (or monitored by a specific UV absorption meter and/or a spectroscopy meter) prior to the water entering the activated carbon filter elements 144a and 144b. If the TOC content of the water is above the programmed threshold value, the controller 112 signal activates suitable valves 147a and 147b to direct the total flow of partially treated water through the carbon filter elements. After treatment in the carbon filter elements, the partially treated wastewater may be directed through valves 149a and 149b back into the primary water flow path for potential further treatment downstream. If the TOC content is below a predetermined threshold the activated carbon filter elements are by-passed, again saving energy required to maintain pressure through the activated carbon filter elements and extending the period of time before the activated carbon must be replaced or regenerated. If salinity is not present and analytical methods have verified the absence of other regulated compounds in the partially treated water for which reverse osmosis would be needed, the activated carbon filter elements 144a and 144b can be used to “polish” out any compounds left after treatment by the membrane filter elements. The presence or lack of salinity is determined at conductivity sample point SP 230.

Grab sample analyses, which an operator would perform in accordance with the current embodiment, can be used to verify the presence or absence of regulated compounds that do not impact conductivity and/or to verify the presence or absence of regulated compounds for which analytical sensor technology is not currently available. If the use of grab sample analysis is required, the controller 112 would demand that these sample inputs are entered into the control system at set intervals and if not performed, the water treatment system would fail safe and shutdown. The membrane filter elements 142a-142g and the activated carbon filter elements 144a and 144b are located upstream of the reverse osmosis elements to protect the reserve osmosis filter membrane elements from excessive suspended materials and TOCs. This approach extends the useful life of the RO membranes and improves its filtration effectiveness.

### Reverse Osmosis Filtration

Because the raw water supply may contain dissolved salts, in concentrations which may range from slightly brackish to the salinity of seawater, the system also includes a reverse osmosis subsystem. Reverse osmosis treatment elements operate under pressure so they have a fairly compact footprint and address the widest scope of contaminants, which are dissolved compounds. Under most uses, it is anticipated that reverse osmosis treatment elements will be used primarily to remove dissolved compounds from the partially treated water.

As depicted in FIG. 4D, the reverse osmosis subsystem may include a plurality of reverse osmosis elements, such as elements 150A1 through 150B2. Each reverse osmosis element utilizes a semi-permeable membrane desalination approach. Preferably, the reverse osmosis subsystem includes two banks of reverse osmosis elements in series. Each bank includes a plurality of reverse osmosis elements in parallel. In FIG. 4D, a first bank comprises reverse osmosis elements 150A1 and 150A2, and reverse osmosis elements 150B1 and 150B2 comprise a second bank of reverse osmosis elements configured in series with the first bank of elements.

Water flowing from, or bypassing, the activated carbon filter elements 147a and 147b is tested for the presence of dissolved solids, including salts, in sufficient concentration to determine if the water upstream of the reserve osmosis banks require desalination. If a sufficiently high concentration is detected at conductivity sample point 230, the controller 112 provides a signal to direct activation of a suitable valve 154, a three-way ball valve for instance, to route the partially treated water through conduit 153 to the reverse osmosis elements for removing the dissolved solids. If desalination is not required and it is confirmed that other chemical contaminates are not present in the partially treated water, the controller 112 may bypass the reverse osmosis subsystem by actuating valve 154 to direct the water through conduit 155, saving energy and prolonging the life of the reverse osmosis membranes.

To protect the reverse osmosis elements 150A1 through 150B2 from carbon fines in the water generated by the activated carbon filter elements 144a and 144b, a cartridge filter 156 may be located in the process flow upstream of the reverse osmosis elements 150A1 through 150B2. Pressure sensors 232 and 234 may be located across the cartridge filter 156 to monitor filter loading via signals to the controller 112.

When the controller 112 determines that treatment in the reverse osmosis subsystem is required, the controller 112 will utilize signals from pressure sensor 236 to determine if the flow stream pressure is sufficient for reverse osmosis operation. If the pressure is sufficient, booster pump 157 is not turned on. If the flow stream pressure is below the threshold level needed for reverse osmosis operation, the controller 112 will signal the booster pump 157 to operate at the required level to achieve the necessary water pressure upstream of the reverse osmosis elements. Prior to entering the booster pump 157, the partially treated water flows through a pressurized capillary buffer vessel 158 which decouples the water flow in the reverse osmosis element from the upstream treatment process flows. A level sensor 238 may be used to monitor the water level in buffer vessel 158.

Typically, a single pass through a reverse osmosis membrane will remove 98% of compounds over a molecular weight of 80. Depending on the specific chemicals present in the partially treated water and the level of treatment required, multiple passes through the reverse osmosis membrane may be necessary. The embodiment of the reverse osmosis elements depicted in FIG. 4D permits the reverse osmosis process t to be conducted via various modes of operation including, sequential application of the reverse osmosis membranes (low salinity) and single pass application of the reverse osmosis membranes (high salinity). The system may be readily modified to operate the reverse osmosis subsystem in other modes by adding additional valves and proposing steps to the system. The specific mode of operation and reverse osmosis membrane configuration selected will be based on the specific application, the desired operating pressure, the reverse osmosis elements selected, and/or the preference of the operator.

For raw water with low concentrations of salts, as when the raw water to be treated is brackish water from estuaries, the reverse osmosis subsystem can be set to operate in a sequential mode. In this scenario, the controller, based upon conductivity readings at SP 230 will control valves 154, 159 and 161 to direct the water first through the bank of elements 150A1 and 150A2 and then through valve 161 to the input of elements 150B1 and 150B2. The output of the treated water from the reverse osmosis elements 150A1, 150A2, 150B1 and 150B2 are then directed through a check valve 163 to the primary water flow conduit. If the treated water stills need treatment, the controller can adjust a suitable valve 165 to recirculate the treated water back through to the bypass-recirculation conduit 229 to the primary contact oxidation tank 130. The process concentrate or reject water removed from the banks of reverse osmosis elements flows may be directed through suitable valve 161 and/or 162 to a RO process concentrate conduit having a flow control valve 164 to control the flow rate of the concentrate. The conduit also has a flow meter 237 coupled therein to monitor the flow rate of the concentrate being rejected.

Alternatively, the controller can operate the reverse osmosis subsystem in a dilution process mode. Based on conductivity readings provided at SP 230 the controller can determine a percentage of partially treated water to send through the reverse osmosis element by adjusting valve 154 to direct the determined portion through the bank of elements 150A1 and 150A2 and then through valve 161 to the input of the bank of elements 150B1 and 150B2 while the remaining partially treated water will bypass the reverse osmosis process via conduit 155 and then recombine downstream of the reverse osmosis process to produce water with a safe salinity level. The dilution approach will only be utilized once it is determined that no toxic chemicals are in the partially treated water and the reverse osmosis elements are being used only to control salinity.

When dissolved compounds are high, as when the raw water to be treated is seawater, the reverse osmosis subsystem can be set to operate in a single pass mode. In this scenario, the controller, based upon conductivity readings at SP 230 will control valves 159 and 161 to alternately direct the water through the bank of elements 150A1 and 150A2 or then through the bank of elements 150B1 and 150B2. In other words, water is directed through only one bank of elements at a time. The output of the treated water from the reverse osmosis elements either 150A1, 150A2 or 150B1 and 150B2 is then directed through a check valve 163 to the primary water flow conduit. If the partially treated water stills need treatment, the controller can adjust the control valve 165 to recirculate the treated water back through the bypass-recirculation conduit 229 to the primary contact oxidation tank 130.

The process concentrate or reject water removed from the banks of reverse osmosis elements, either elements 150A1 and 150A2 or elements 150B1 and 150B2, flows through suitable valves 161 and/or 162 to the RO process concentrate conduit for discharge.

The multi-mode operation provided by the reverse osmosis subsystem allows a single membrane grade to successfully treat waters with a wide range of dissolved solids concentrations. An alternative to the multi-mode operation, which is considered within the embodiment of the disclosure, is to have replaceable reverse osmosis membranes. In this case, the specific reverse osmosis membranes can be selected based on the salinity of the raw water source. In addition to desalination, the reverse osmosis elements will also function to remove many chemical contaminants, organic chemicals (e.g., poisons, pesticides, pharmaceuticals), metals (e.g., mercury, arsenic, cadmium), and radioactive material that may remain in the partially treated water. When these types of chemical contaminates are present, all of the partially treated water leaving activated charcoal filtration will be processed through the reverse osmosis elements 150A1 through 150B2. Systems of the current embodiment of the allows for the use of compound specific analytical instrumentation, which may vary depending on the specific application, to determine necessary process steps (e.g., need for reverse osmosis process). For situations where automated analytical sensors are not yet available, the systems of the current embodiment allows for grab samples to be taken and test results to be manually entered into the controller 112. Systems of the current embodiment also allow for the use of analytical instrumentation to measure or detect surrogates to infer the presence or absence of regulated compounds when determining process steps and/or finished water quality. If the use of grab sample analysis is required, the controller would demand that these sample inputs are entered into the control system at set intervals and if not performed, the water treatment system would fail safe and shutdown.

A disadvantage of using reverse osmosis is that reverse osmosis membranes pull out hardness ions/alkalinity constituents which decreases the pH of the partially treated water. After the water is treated in the reverse osmosis elements, the pH of the partially treated water is determined at SP 290 downstream of the final oxidation chamber 160. Based on this pH reading, the controller 112 may determine the appropriate amount of buffer chemical to inject at buffer injector 166 to adjust the pH to an acceptable level for human consumption.

### Final Contract Oxidation/Ultraviolet Light Irradiation

After treatment in the reverse osmosis subsystem, virtually all contaminants have been removed from the treated water. However, the partially treated water may still contain pathogenic organisms and a small trace of low molecular weight compounds that can be toxic, which were not removed or destroyed in upstream treatment elements. To address these contaminants, the system may include a final contact oxidation/UV element 160 that subjects the treated water to a final advanced oxidation/disinfection treatment process. A venturi 167 is coupled into the primary water flow conduit upstream of the element 160 and a pressure regulator 168 is in parallel with the venturi 167 so that the water entering the element 160 is maintained at a constant pressure but at a variable flow above a minimum flow. The controller may adjust the valve 244 to regulate the flow of the ozone into the venturi 167. A flow meter 239 measures the flow of the ozone into the ozone injector.

The final contact oxidation/UV element 160 is preferably a compartment or chamber positioned inside the service supply tank 170 that is in the shape of a vertical serpentine passageway having an inlet 172 through which upstream water from primary water flow conduit enters the vessel. The chamber 160 is fitted with an ozone injector (not shown) which the controller 112 can direct to inject sufficient ozone into the water as it enters the chamber 160 to begin the disinfection process. Due to its shape, the time that it takes the water to travels through the serpentine passageway to the outlet 174 is sufficient time for the water to be exposed to the ozone for the disinfection process to accomplish a final disinfection of the treated water. A higher level of ozone is injected into the final contact vessel than is required for disinfection which causes ozone to remain in concentration. As the treated water is about to exit contact chamber 160, it is irradiated with ultraviolet (“UV”) light from an ultraviolet light source 176. The UV light hydrolyzes ozone to create OH hydroxyl radicals. The hydroxyl radicals breakdown the remaining contaminates, polishing the treated water and removing the ozone residual so no remaining ozone is in solution in the final treated water.

Water leaving the chamber 160 is directed into of the service tank 170 through conduit 175. The conduit 175 preferably includes various sampling points for monitoring and/or measuring various parameters. SP 290 is used to measure pH. SP 291 may be used to monitor UV radiation. SP 292 may be used to conduct a spectrographic analysis of the treated water using spectroscopy. SP 293 may be a SP for a turbidity sensor to measure turbidity. SP 294 may be used by an ozone sensor to measure any residual ozone concentration, and SP 295 may be used to measure conductivity to determine the residual dissolved solids concentration. If the tested conductivity and residual ozone parameter measurements are outside predetermined ranges, the level of ozone injection is automatically adjusted as needed to provide the final water quality specified.

The ozone used in the final contact chamber 160 is generated onsite by the ozone generator 134. The system 110 also includes an ozone destruct unit 300. Excess ozone from the primary contact tank 130 and the final contact chamber 160 may be vented through vent control valve 256 and conduit 205 to the destruct unit 300 where it will be decomposed into compounds safe for emitting into the atmosphere. The water exiting the contact chamber 160 may be routed back to the service supply tank 170 by the controller through valve 177, where it is held for distribution or service use within the system. The treated water reaching the service tank (finished water) is free of impurities, and is clean and safe for human consumption and use. Water may be routed from the service water supply tank 170 through conduits 178 and 229 and valve 298 to the customer or user. Prior to the controller actuating the valve, the controller evaluates the residual dissolved ozone concentration of the finished water at SP 296 to insure that it is suitable for human consumption prior to routing it to the customer.

During the transient mode of operation, based upon the measure parameters taken at the various sample points, the controller may determine that the finished water does not meet the specifications for potable water or may determine that a steady state condition of the water quality of the finished water has not been reached. In such scenarios, the controller may activate valve 177 to direct finished water through valve 177 to the bypass-recirculation conduit 229 to the input to the primary oxidation tank 130.

In the backwashing mode the finished water stored in the service water supply tank may be used as a source of clean water for backwashing processes for the membrane filters, activated carbon filters, and reverse osmosis elements when needed. In the event the water is needed for such backwashing processes, the controller activates the service pump to direct the water stored in the service water storage tank 170 through conduit 299 and valve 289 for use in backwashing treatment processes.

Ozone and UV radiation are preferred treatment options for the final oxidation process because they require no consumables and only require logistics support for repair activities. The treatment capability of the system can be extended and expanded by injecting hydrogen peroxide into the water prior to its entry into the tank 170. This variation in, or alternative embodiment of the system is not contemplated to be necessary in most treatment applications, but it is to be understood that the inclusion of hydrogen peroxide injection apparatus and the injection step in which it is used is within the scope of the disclosure.

### System Container

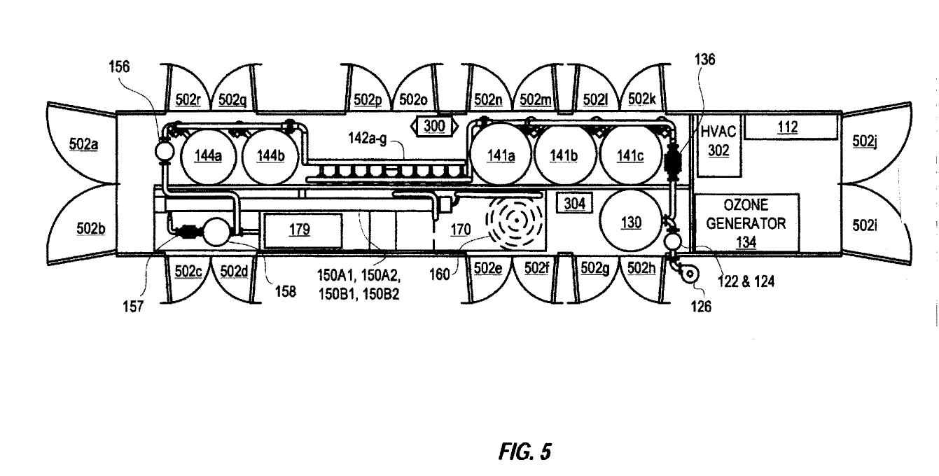

The apparatus described above for the system 110 is preferably laid out and connected in a highly compact arrangement for maximum portability. As depicted in FIG. 5, the embodiment of the water treatment system may be preferably packaged in such a manner as to be housed, shipped, and operated within a standard-sized shipping container 500 which serves as its support structure and protective environment. The shipping container 500 may be modified by adding access panels or doors such as doors 502a through 502r, strategically located in the container to allow access points for system operation, observation, maintenance, and repair. The container is also modified by adding supplemental diaphragm walls to increase the structural strength of the walls to compensate for the loss of structural strength resulting from the addition of the doors. The weight of the apparatus will be managed to allow for shipping to remote locations. Possible modes of transport include commercial truck, helicopter, and airdrop deployment.

It is contemplated that the system apparatus will be assembled at a fixed location, preferably within a standard-sized shipping container size. Enclosing the apparatus within such a shipping container not only protects the apparatus against the elements and other physical damage during transportation and set-up, but also provides security for the apparatus while in use at the treatment site. A suitable configuration layout of the equipment within a modified standard-sized shipping container is depicted in FIG. 5. The subsystems and elements of FIG. 5 corresponding to the same parts of FIG. 4A-4E are designated with like reference numerals. Preferably, the service water supply tank 170 may provide physical support for the reverse osmosis elements 150A1-150B2.

Operation in high temperature and high humidity conditions can be very destructive to electrical and electronic equipment and components, and it is contemplated that many sites where water treatment is needed will be in areas with harsh climates that experience extreme weather conditions, including but not limited to high heat and/or humidity levels. To protect the apparatus of the system and avoid interruptions in operation due to harsh climate or inclement weather, the container enclosure is provided with one or more cooling and dehumidifying units and an environmental control subsystem for controlling such units. As a means of avoiding heating of the interior of the container enclosure from the operation of, e.g., pumps and motors, heat generating equipment could, if desired or needed, be disposed outside the cooled and dehumidified volume of the container enclosure, or could be independently ventilated and/or cooled.

### Methods of Operation

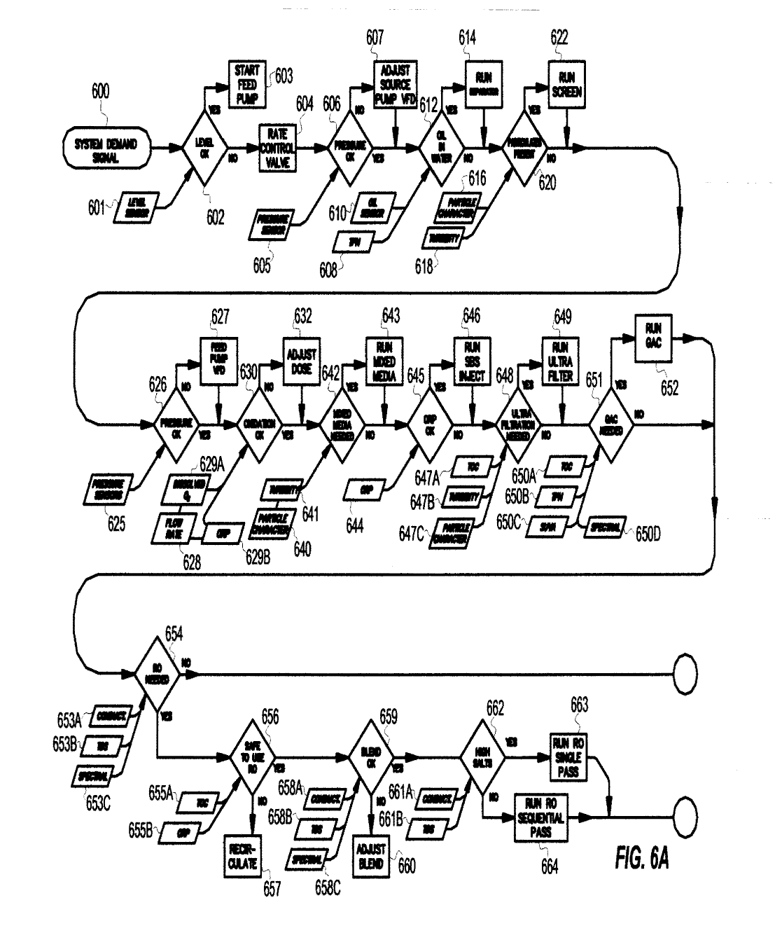

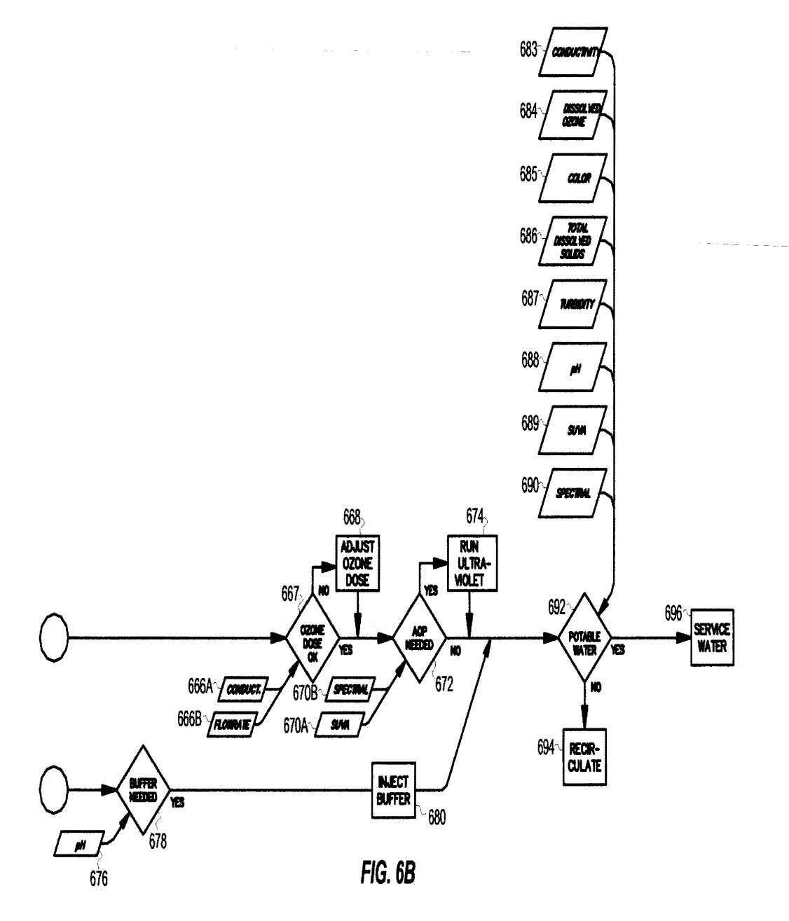

FIGS. 6A-6B are decision diagrams which depicts in more detail the process flow control logic describing the interaction and dependencies between the controller 110 and the various sensors and actuating means in the water treatment system, including a depiction of the sensor input and the controller output signals used for system 110 operation under various processing modes, conditions and sensor input data described in connection with the system 110 depicted in FIGS. 4A-4E.

Referring to FIG. 6A, in step 600 the controller initiates a system demand signal. Such a demand signal may occur when, e.g., the level in the clean water storage tank or service water supply tank 170 drops below a predetermined level. Another level sensor may be used to determine not only the level of treated water in the storage tank, but also to assure that the level of the water source is sufficient. In response to the system demand signal, the controller 112 in step 601 turns on the various sensors and monitors the input signals from the water level sensor 210 in the primary contact tank 130. In step 602 the controller determines if the water level in contact tank is acceptable to commence operations based upon the input signals from level sensor 210. If the level is acceptable, in step 603 the feed pump 136 is engaged. If the water level is not acceptable level, the controller in step 604 actuates the flow control valve 131 to route water into the primary contact tank 130 until the water level measured at level sensor 210 is sufficient.

In step 605, the controller next monitors the pressure at pressure sensor 209 to determine if the pressure upstream of the primary contact tank 130 is at an acceptable level. If the pressure is below an acceptable level, in step 606 the controller adjusts the output of source pump 126 until the pressure at pressure sensor 209 is at an acceptable level. In step 607, the pump adjusts its output. If the raw water is flowing into the system at an acceptable pressure, the controller continues to the next process step.

The controller next determines if there is oil present in the incoming water in step 608 in response to input signals from TPH sensor SP 202 or in step 610, from input signals from an oil sensor (not shown in FIG. 4A). In step 612, if oil is present and an oil-water separator is part of the system, the controller sends an output signal to actuate valve 125 to route water flow through the oil-water separator apparatus. In step 614, the oil-water separator removes the oil from the water. If the controller determines that oil is not present, the valve 125 is set to permit the water to bypass the oil-water separator.

In step 616, the controller next monitors the input signals from the particle sensor 208 or, in step 618, input signals from a turbidity sensor (not shown in FIG. 4A) to determine if the raw water includes particulates of a sufficient size to require straining If the controller determines that initial straining is required, in step 620 the controller actuates valve 121 to route the raw water to the particulate strainer 122 to remove the particulates. In step 622, the strainer removes the particulates. If the controller determines that initial straining is not required, in step it activates valve 121 so that the water bypasses the particulate strainer.

If a system demand signal is presented to the controller in step 600, the controller also references level sensor 210 in primary contact tank 130 to determine if the water level is adequate to engage feed pump 136. If the water level is adequate, the controller engages feed pump 136. If the water level is not adequate, the controller output signals to the pump 136 to pause until the water level in the tank is adequate. In step 625, the controller references pressure sensor 214. In step 626, the controller determines if the pressure value from sensor 214 is not sufficient. In step 627, the controller outputs a signal to the feed pump 136 to direct it to adjust the pump's operation until the pressure reaches a predetermined level. If the pressure at sensor 214 is sufficient for operation, the pump's operation remain the same.

The controller then monitors the input signals, in step 628 from flow meter 211 and in step 629A from the dissolved ozone sensor SP 212. Alternatively, in step 629B the controller can monitor an ORP sensor (not shown) to determine if the partially treated water leaving the primary oxidation tank 130 contains dissolved ozone within a predetermined concentration range. In step 630, the controller determines if the dissolved ozone is within the predetermined range. If not, in step 632 the controller sends an output signal to the ozone injector 132 for the ozone detector to either increase or decrease the rate of ozone injection, as determined to be needed. If the dissolved ozone is within the predetermined range, the controller continues to the next process step.

The controller references, in step 641 the turbidity sensor 213 or in step 640 a particle sensor (not shown) to determine the turbidity of water, as the basis for a further determination of whether mixed media filtration is needed. In step 642, the controller determines if mixed media filtration is needed. If filtration is needed, in step 643, the controller activate automatic valves 141a through 141c to route the water through the mixed media filtration elements. If filtration is not needed, the controller actuates the valve 141a through 141c so that the filtration elements 141a through 141c are bypassed.

In step 644, the controller monitors the water leaving the mixed media filters for ORP at SP 220 for determining if the oxidation/reduction level of the water is within predetermined limits. In step 645, the controller determines if the oxidation/reduction potential is within limits. If not, in step 646 the controller outputs a signal to the SBS injector 223 directing it to add sodium bisulfate to the water to reduce the oxidation reduction potential level of the water. If the oxidation/reduction potential level is within predetermined limits, the controller moves to the next process step.

In step 647A, the controller monitors the water leaving or bypassing the mixed media filtration elements for TOC content through TOC sensor SP 224. In addition or in the alternative, in step 647B the controller may monitor the signals from a turbidity sensor SP (not shown) or in step 647C the signals from a particle sensor SP 222, all of which may be disposed in the water flow entering the membrane filtration elements. In step 648, the controller determines if membrane filtration is needed. If the TOC or other measured water quality parameter is above the programmed threshold value, the controller activates the valve 145 controlling the flow of water through or around the membrane filter elements 142a through 142g. In step 649, the membrane filter elements treat the incoming water. If the water quality is within the predetermined limits, the controller actuates valve 145 so that the water bypasses the membrane filter elements.

In step 650, the controller monitors the water leaving or bypassing the signals from the membrane filtration elements for one or more water quality parameters relating to turbidity, including TOC sensor SP in step 650A, TPH sensor SP in step 650B, SUVA meter SP in step 650C, or spectroscopy meter SP 650D, to determine if the water needs to be treated by the activated carbon filtration elements 144a and 144b. In step 651, the controller determines if the water should be treated in the activated carbon filtration elements. If yes, the controller in step 652 actuates valves 146, 147a, 147b, 149a and 149b to route the water through the activated carbon filtration elements for treatment. If the controller determines that the measure water quality parameter is suitably low the carbon filtration/adsorption treatment elements are bypassed.

In step 653, the controller monitors the water quality parameters of the water exiting or bypassing the activated carbon filtration elements from, in step 653 A the input signals from conductivity sensor SP 230, in step 653B the input signals from a total dissolved solids (“TDS”) sensor (not shown), or in step 653C from a spectroscopy meter (not shown), which sensors tests for the presence of dissolved compounds in the water flowing from, or bypassing, the activated carbon filtration/adsorption elements. In step 654, the controller determine if reverse osmosis is required . . . . If the controller determines that reverse osmosis is not required, the control system actuates valve 154 so that the partially treated water bypasses the reverse osmosis elements.

In step 655, the controller monitors the water quality parameters of the water to determine if it safe to use the reverse osmosis elements by monitoring the input signals from, in step 655A, a TOC sensor SP 227 or in step 655B, an ORP sensor SP (not shown). In step 656, controller determines if it is safe to use the reverse osmosis elements. If it is not safe to use the reverse osmosis elements in step 657 it actuates valve 231 to route the water to a recirculation conduit 229 to recirculate the water. If the controller determines that it is safe, the controller advances to the next process step.

In step 658, the controller monitors the water quality parameters of the water by monitoring the input signals, in step 658A from a conductivity meter SP 230, in step 658B from a TDS sensor SP (not shown), or in step 658C from a spectroscopy meter SP (not shown). In step 659, the controller determines the portion of the water which needs to go through the reverse osmosis elements and the portion of the water that needs to bypass the reverse osmosis elements in order that the water quality of the recombined water stream downstream of the reverse osmosis elements will meet predetermined levels of dissolved compounds. In step 660, the controller adjusts the control valve 154 and pump 157 to allocate the water into a portion going through the reverse osmosis elements and a portion bypasses the elements.

In step 661, the controller monitors the water quality parameters of the water to determine the total dissolved solids of the water by monitoring input signals from, in step 661A from a conductivity sensor SP 230, or in step 661B from a TDS sensor SP (not shown). In step 662, the controller determines if the water is high salinity water. If it is, in step 663, the controller actuates valves at least 159 and 161 so that the water makes a single pass through the two banks of reverse osmosis elements 150A and 150B. If the water does not contain a high level of total dissolved solids, in step 664 the controller actuates valves 159 and 161 so that the water is sequentially treated by the two banks of reverse osmosis elements.

In step 666, the controller monitors the input signals, in step 666A from ORP sensor (not shown and, in step 666B ozone sensor (not shown) to determine the level of residual ozone in the partially treated water exiting the final contact oxidation chamber 160 following the treatment of the tested water with ozone to perform a final disinfection step. If the tested water quality parameters are outside predetermined ranges, in step 667, the controller outputs a signal to direct the ozone injector control valve 167 associated with the chamber 160 to adjust the level of ozone to be injected into the water during the final disinfection step. In step 668, the amount of ozone to be injected by the injector into the chamber 160 is adjusted. If the measured parameters are within predetermined ranges, the ozone injector continues to inject the same amount of ozone into the chamber 160t.

In step 676, the controller references the pH sensor SP 290 to determine if the pH of the water exiting the final contact chamber 160 is out of range. If the controller determines that the pH is out of range, in step 678 the controller directs the buffer injector 166 to inject a sufficient amount of buffer material to adjust the pH of the treated water. In step 680, the buffer injector injects the buffer material.

Depending, in part, upon the characteristics of the reverse osmosis membranes, the effectiveness of the activated carbon medium in removing all toxic organic compounds from the water, and, in further part, upon the treatment elements utilized in a particular treatment operation, there is a possibility that the water entering the final oxidation/disinfection chamber 160 may still contain organic chemicals that would prevent the finished water from meeting safety standards. In step 670, the controller may monitor in step 670A a SUVA meter SP or, in step 670B, a spectroscopy meter SP (not shown) to see if the toxic compound levels associated with organic chemicals are within the predetermined range In step 672, the controller will thereby determine if an advanced oxidation treatment process (“AOP”) needs to be undertaken. If the spectral analysis and the SUVA output is not within predetermined ranges, the controller will output a signal to the ultraviolet lamp 176. In step 674, the ultraviolet lamp 176 will radiate the treated water to further disinfect the water and destroy any remaining ozone. If the spectral analysis and the SUVA output and both within predetermined ranges, the controller moves to the next process step.

Alternatively, the system may have a buffer injector to inject hydrogen peroxide prior to its entry into the final oxidation/disinfection chamber 160. The buffer injector then injects the hydrogen peroxide. This variation in or an alternative embodiment of the system is not contemplated to be necessary in most treatment applications, but it is to be understood that the inclusion of hydrogen peroxide injection apparatus and the injection step in which it is used is within the scope of the current disclosure.

In steps 683-690, the controller may monitor input signals from a variety of other sensors and meters located on the outlet of the final contact oxidation vessel 160, such as conductivity sensor SP 295, dissolved ozone sensor SP 294, a color sensor, total dissolved solids sensor, turbidity sensor SP 293, ph meter SP 290, SUVA sensor SP 291, and spectroscopy meter SP 292 for a final analysis of the water quality of the treated finish water to determine if it is really potable water. If the controller determines that the measured parameters from the various sensors do not all fall within the predetermined ranges, in step 692, the controller outputs a signal to actuate valve 177 to recirculate the finish water back to the input of the primary oxidation tank 130. In step 694, the service pump redirects the water through the valve 177 to the recirculation conduit 229 back to the input of the primary oxidation tank 130. If the tested water is potable, in step 696 the control outputs a signal to activate valve 177 to store the water as service water in service water supply tank 170 or actuate valve 298 and engage pump 172 to directly send the water out to the user.

### Startup and Other Transient Modes of Operation

The current embodiment of the system apparatus will include an applications software application to program the controller 112 to perform a predetermined startup sequence. The purpose of the startup sequence is to ensure that the system 110 is started up safely, systematically, and in a process that allows confirmation that each major treatment subsystem and element is functioning properly and stabilized before additional treatment subsystems and elements are brought online. The startup sequence will also verify that the treated water is meeting the required water quality specifications for human consumption before it is allowed to enter the storage tank or be provided for end user consumption.

During startup the controller 112 will start the source pump 126 and configure the system to require all raw water be directed through the oil-water separator 124 and strainer particulate strainer 122 until a steady state condition is reached. Once a steady state condition is reached, the controller 112 and associated system sensors and instrumentation will determine whether these elements are still required based on the determinations made by the applications software run by the controller. At the same time, the controller 112 will configure primary contactor tank 130 and service pump 136 to recirculate the water in treatment through the primary contactor 130 and ozone injector control valve 133 until a predetermined level of dissolved ozone is established as measured by Sample Point (SP) 212. At this time the controller 112 will configure the system 110 to bring the mixed media filter elements 140a, 140b, and 140c online and add them to the existing recirculation loop for the water under treatment. When the turbidity of the water in treatment reaches a predetermined threshold, as measured at SP 213, the controller will configure the system to bring the membrane filter elements 142a through 142g online and continue growing the recirculation loop for the water under treatment. When the TOC level or comparable parameter of the water in treatment reaches a predetermined threshold, as measured at SP 228, the controller 112 will configure the system to bring the activated carbon filter elements 144a and 144b online therein adding them to the recirculation loop of the water under treatment. When the TOC level of the water in treatment reaches a predetermined threshold, as measured at SP 240, the controller will configure the system to bring the reverse osmosis elements 150A1 through 150B2 online by adding those elements to the recirculation loop. After the water exiting the reverse osmosis elements reaches a steady state condition, the controller 112 may then bring the final contact oxidation/UV vessel 160 online, including it in the recirculation loop. At this time, the entire system will be operating in a recirculation mode allowing the operator to confirm proper operation of all key elements. After this final stage reaches steady state and the treated water is confirmed safe for human consumption, the system 110 may exit the startup sequence and begin the normal mode of operation, supplying clean water for human consumption.

It should also be noted that the operator may also monitor all aspects of the operation of the system from a monitoring station and has the capability to provide user input to the controller. Accordingly, the controller also monitors for such user input, especially regarding the operators concerns about the potential presence of toxic compounds.

In the event the controller detects an upset condition in the system, the controller will cease operating the system in the transient mode and will return to a transient mode of operation.

### Normal Mode of Operation

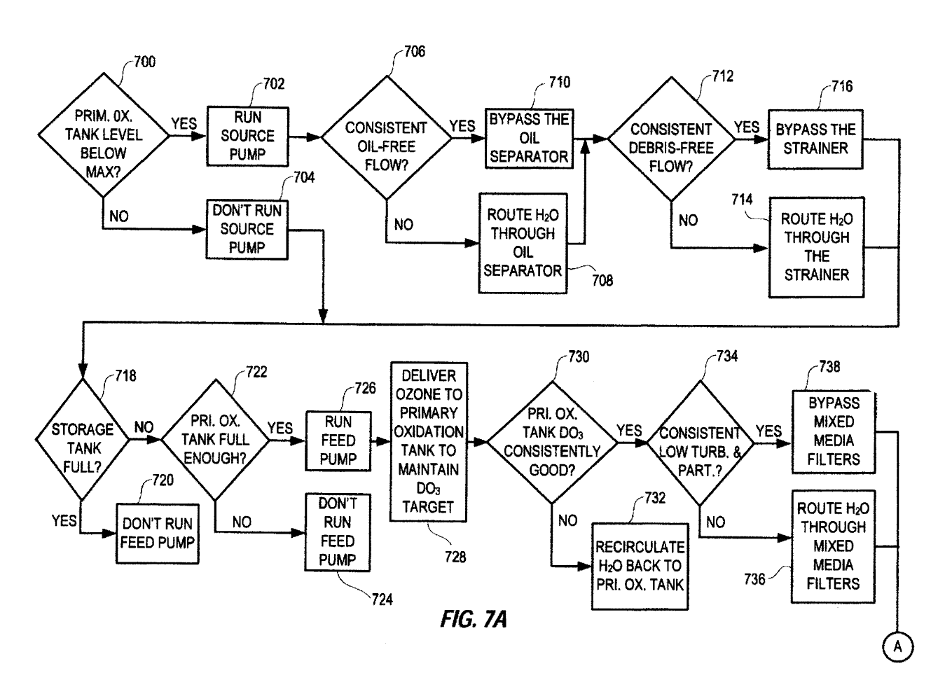

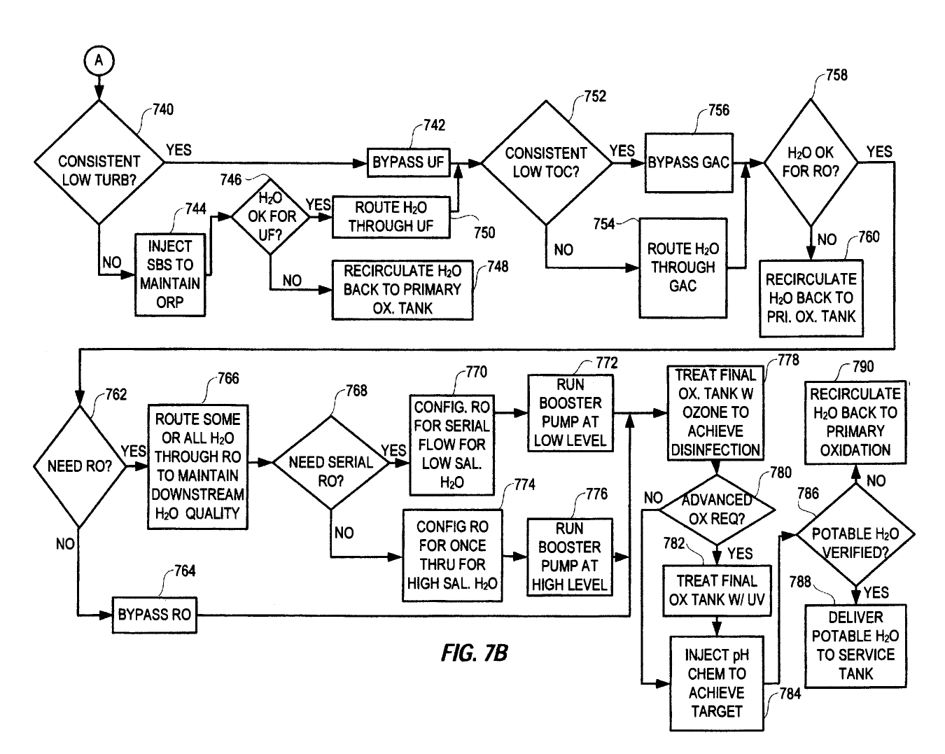

FIGS. 7A-7B are flow diagrams illustrating the method of operating the embodiment of the system 110 of FIGS. 4A through 4E in the normal mode of operation. As depicted in FIG. 7A, in step 700 the controller 112, based upon sensor input signals described in connection with the controller processes described in FIGS. 6A and B, determines if the primary oxidation tank water level is below the maximum. If the water level is low, the controller in step 702 output a signal to the source pump 126 to start pumping. If the water level is at a maximum, in step 704 the controller outputs a signal to the source pump not to operate and no additional source water is processed through the treatment subsystems.

In step 706, the controller determines if the water contains oil. If the water is not oil-free, in step 708 the controller outputs a signal to the valve 125 to direct the water flow to the oil-water separator and a signal to the oil water separator 124 so that it commences operating to remove the oil from the incoming source water. If the water is oil-free, the controller in step 710 activates the valve 125 so that the water bypasses the oil-water separator 124.

In step 712, the controller 112 determines whether the water contains particulates of a predetermined size that may interfere with the operation of the primary oxidation treatment tank. If the water does contain such particulates, in step 714, the controller actuates valve 121 to direct the water through the strainer 122 which strains the particulates exceeding a certain size, such as 100 microns, from the water. In the water does not contain such particulates, the controller in step 716 actuates the valve 121 so that the water bypasses the strainer 122.

In step 718, the controller determines if the service water supply tank 170 is full of water. If it is full, in step 720 the controller outputs a signal to the feed pump 136 to stop pumping. If it is not full, the controller, in step 722, the controller determines if the primary oxidation tank 130 is full. If the tank 130 is not full enough, the controller in step 724 outputs a signal to the feed pump 136 not to pump. If the primary oxidation tank 130 is full enough, the controller in step 726 output a signal to the feed pump to pump water from the tank 130.

In step 728, the controller outputs a signal to the ozone injector to inject ozone into the primary oxidation tank 130 to maintain the dissolved ozone concentration target needed to treat and disinfect the water in the tank. In step 730 the controller determines if the dissolved ozone level of the water exiting the primary oxidation tank 130 is consistently falls within the predetermined range. If it does not, in step 732, the controller outputs a signal to actuate valve 217b so that the water exiting the primary oxidation tank 130 is recirculated to the input of the tank. If the dissolved ozone level does falls within the predetermined range, the controller in step 734 determines if the turbidity and particle character falls within the predetermined range for acceptable water exiting the tank 130. If the water does not meet the turbidity and particle character requirements, in step 736, the controller outputs a signal to valves 141a, 141b, 141c, 143a, 143b, and 143c to route the water through the mixed media filter elements 140a, 140b, and 140c. If the water does meet the requirements, the controller in step 738 outputs a signal to valves 141a, 141b, 141c, 143a, 143b, 143c, 217a and 217b so that the water bypasses the mixed media filter elements.

In step 740, the controller next determines if the water upstream of the membrane filtration elements 142a through 142g consistently has sufficiently low turbidity levels and/or particle character. If the water does have sufficiently low turbidity levels and/or particle character, the controller in step 742 outputs signals to the valves 145, 146 and 148 so that the water bypasses the membrane elements 142a through 142g. If the water does not have sufficiently low turbidity levels and/or particle character, the controller in step 744 directs the SBS injector 223 to inject a sufficient amount of sodium bisulfite to maintain a suitable level. In step 746, the controller determines if the water meets a sufficient ORP level for the water to be treated in the membrane elements 142a through 142g. If the water does not meet the predetermined water quality criteria, the controller outputs a signal to valves 145, 146, and 148 so that the water is recirculated back to the primary oxidation tank 130. If the water does meet the particulate water quality criteria, the controller in step 750 outputs a signal to valve 145 to route the water through the membrane filtration elements for treatment.

In step 752, the controller determines if the partially treated water routed through the membrane filtration elements consistently has sufficiently low levels of TOC. If it does not, the controller in step 754 outputs a signal to valves 146, 147a, 147b, 148, 149a, and 149b so that the valves route the partially treated water through the granulated activated charcoal elements 144a and 144b. If the partially treated water does consistently meet the TOC water quality requirements, the controller in step 756 actuates the valves 146, 149a, 149b, and 148 so that the partially treated water bypasses the granulated activated charcoal elements. In step 758, the controller determines if the water quality parameters of the partially treated water is suitable for processing by the reverse osmosis elements 150A1 through 150B2. If the water does not meet the requirements, the controller in step 760 actuates valve 231 so that the water is recirculated back to the primary oxidation tank 130 for further treatment. If the partially treated water does meet the requirements, in step 762 the controller 112 determines if the water has sufficient levels of dissolved compounds that treatment of the water by the reverse osmosis elements would be helpful. If reverse osmosis treatment would not be helpful, the controller in step 764 actuates valves 154 and 231 so that the partially treated water bypasses the reverse osmosis treatment elements. If reverse osmosis treatment would be helpful, the controller in step 766 determines that some or all of the partially treated water should be routed through the reserve osmosis elements in order that predetermined downstream water quality level can be maintained and positions valve 154 and 231 to route either all or a predetermined portion of the water through the reverse osmosis subsystem. In step 768, the controller determines if the partially treated water has low or high salinity concentrations. If the water has low levels of dissolved compounds or conductivity, the controller in step 770 actuates valves 159 and 161 to route the partially treated water sequentially through the two banks 150A and 150B of reverse osmosis elements, respectively. The controller next in step 772 outputs a signal to the booster pump 157 to have it operate at a low head pressure level. If the water has high levels of dissolved compounds or conductivity, the controller in step 774 actuates valves 158 and 161 to route the water being treated alternately through one of the banks of the reverse osmosis elements to the output for a predetermined time period. In step 776, the controller outputs a signal to the booster pump 157 to have it operate at a higher head pressure level.

In step 778, the controller routes the partially treated water for treatment in the final oxidation chamber 160 with ozone being injected into the water by the ozone injector in order to achieve disinfection. In step 780, the controller next determines if advanced oxidation treatment is required. If it is required, the controller in step 782 directs the ultraviolet lamp to irradiate the ozone-treated water with UV light. In step 784, the controller determines the pH level of the water at SP 290 and then directs the buffer injector 166 to inject a buffer chemical into the water to achieve the targeted pH level for human consumption. In step 786, the controller receives sensor input signals from a variety of sensors at SPs, for instance at SPs 291 through 295, that measure a variety of water quality parameters and uses these inputs to determine if the water quality of the finish treated water is potable water suitable for human consumption. If the controller determines that it is potable water, in step 788, the controller actuates valve 177 to deliver the potable water to the service water supply tank 170. If the controller determines that the water is not potable, the controller in step 790 actuates valve 177 to recirculate the water back to the primary oxidation tank 130 through recirculation conduit 229.

### Backwashing Mode of Operation

As with all filtration elements or components, filter media will become loaded with contaminants filtered from the fluid flowing through the element, and will require replacement, or backwash to flush accumulated contaminant materials from the media and out of the filtration subsystem. Water used for backwash in the example of FIG. 4E is drawn from the service water supply tank 170 and is routed through the treatment element apparatus that is to be cleaned, in a path that may be essentially a reverse of the illustrated treatment flow path during normal operation. Backwash water, with entrained contaminant materials, can be returned to the raw water source, or otherwise appropriately disposed of

[symbol]

The source for backwash water and the backwash flow paths are both subject to variation while remaining within the scope of the current disclosure, and the paths shown in FIGS. 4A-4E are not to be taken as limiting. It will be understood that backwashable elements and components of the system 110 will not require backwash at the same time, due to factors such as uneven contaminant loading. The controller is designed and operated to be capable of establishing the most efficient and effective backwash flow path in differing loading circumstances, typically based upon pressure differentials detected by pressure sensor components.

Although the current disclosure has been provided with reference to specific embodiments, these descriptions are not meant to be construed in a limiting sense. Various modifications of the disclosed embodiments, as well as alternative embodiments of the current disclosure will become apparent to persons skilled in the art upon reference to the description of the current disclosure. It should be appreciated by those skilled in the art that the conception and the specific embodiment disclosed may be readily utilized as a basis for modifying or designing other structures for carrying out the same purposes of the present disclosure. It should also be realized by those skilled in the art that such equivalent constructions do not depart from the spirit and scope of the current disclosure as set forth in the appended claims.

It is therefore, contemplated that the claims will cover any such modifications or embodiments that fall within the true scope of the current disclosure.

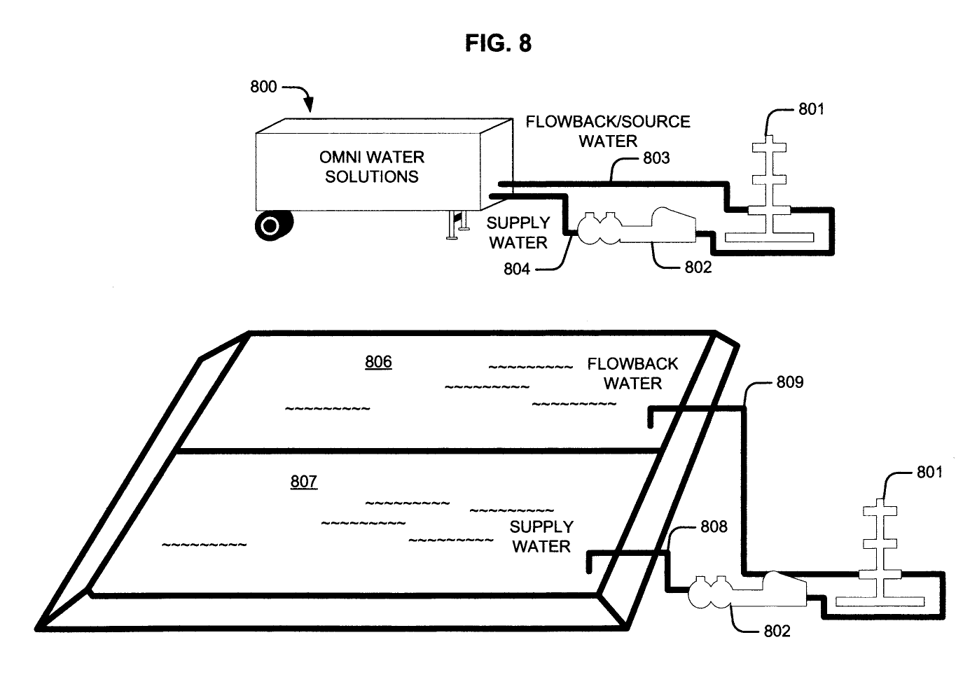

Additional Embodiments FIG. 8 illustrates two hydrostatic fracking systems. More specifically, FIG. 8 illustrates a water treatment system 800 of embodiments and two oil wells 801. While both oil wells 801 have associated therewith hydrostatic pumping units 802, one of the oil wells is connected to water treatment system 800 and the other oil well is not. Thus, the oil well 801 connected to water treatment system 800 has source piping 803 that routes flowback water from the oil well 801 to the water treatment system 800. The water treatment system 800 of the current embodiment treats the flowback water and discharges the treated water via supply piping 804. In FIG. 8 the supply piping 804 is illustrated as being connected back to the oil well 801 via its hydrostatic pumping unit 802. However, it is often the case that the supply piping 804 from the water treatment system 800 might be routed to another oil well 801 or to some other point of use or perhaps a storage tank.

In the absence of water treatment system 800, as illustrated by the other oil well 801, the operator of the oil well 801 has had to build a flowback retention pool 806 as well as a water supply pool 807 and the supply and flowback pipeline 808 and 809 respectively. This situation means that that operator has to pay for the use of the land for these facilities (particularly the pools) in addition to building them. These operations necessitate certain costs, delays, complications, etc. Further still, the operator has had to find, pay for, etc. the water to fill and/or maintain supply pool 807. Additionally, construction of flowback retention pool 806 usually has to make provisions for ensuring that the flowback water does not leak out of, leach from, or otherwise escape from the flowback retention pool 806. Moreover, because the flowback water might contain certain regulated materials, the operator must also pay for the disposal of the flowback water as well as its transportation to a disposal facility.

Indeed, water (from many sources) will often contain a number of impurities. Broadly speaking, these impurities will fall into two categories: organic and inorganic impurities. Inorganic impurities can further be subdivided between those that are soluble and those that are insoluble and/or mechanically separable from water. The soluble impurities will either be ionic or nonionic carbon-based compounds. As to the inorganic impurities, these too will usually include soluble and insoluble and/or separable impurities. Flowback water will also tend to include other impurities. For instance, the water pumped into the oil wells 801 to fracture their corresponding formations will often contain propants (for instance, sand), friction reducers, oxygen scavengers, corrosion inhibitors, scale inhibitors, drilling “mud,” and biocides added by the operators in various combinations and at certain concentrations. The quality of the flowback water from the oil wells 103 will reflect these additives to some extent.

In addition, flowback (and/or other source) waters might also exhibit the presence of impurities classified by whether they are volatile or semi volatile organic compounds. Water, in some instances might also contain pesticides (whether organophosphorous or not), pharmaceuticals, metals (heavy and/or otherwise), and certain radiological elements/compounds. As to the volatile organic compounds some species which can be of interest include benzene, toluene, xylenes, ethylbenzene, etc. Moreover, there are a wide variety of volatile organic compounds (VOCs) that might be of interest to the operators of the oil wells and/or others. Some such representative VOCs include: chlorinated benzenes, alkanes, alkenes, etc., ketones, MTBE, brominated benzenes, acolein, chloroform, methylene chloride, styrenes, vinyl acetate and/or chloride, theylbenzene, trichloroethylene, chloromethane, acrolonitrile, carbon disulfide, carbon tetrachloride, etc. Semi-volatile chemicals of interest to some include benzo (a) pyrene, chlorinated phenols and/or benzenes, chrysene, nitrophenols, fluorene, metylphenols, napthalene, 2 methyl napthalene, 1,4 napthoquinone, phenanthrene, phenol, pyrene, phthalates, fluoranthene, diphenylamine, acenaphthylene, bis(2-chloroethyl)ether, dibenzofuran, etc. As noted above, pesticides might also be of interest to certain parties. These pesticides include chlordane, alpha-BHC, beta-BHC, delta-BHC, gamma-BHC, heptachlor, aldrin, heptachlor epoxide, endosulfan I, dieldrin, endrin, endrin ketone, endrin aldehyde, endosulfan II, 4,4-DDT, endosulfan sulfate, toxaphene, etc. Various metals can also be of interest such as mercury, arsenic, trivalent chromium, hexavalent chromium, copper, nickel, zinc, lead, selenium, cobalt, lithium, tin, etc. Oil well operators tend to be concerned about the presence of iron, manganese, and boron species among the metals and/or metalloids in particular.

The removal of some of the foregoing impurities can be desirable before re-use of flowback water or the (re)use other types of source water. For instance, certain impurities (iron and manganese) can precipitate within pumps, heat exchangers, pipes, etc. as undesirable “scale.” The presence of oils (and/or other similar hydrocarbons) can foul certain types of equipment while other carbon based compounds can create undesirable oxygen “demand” in certain waters. Further, suspended solids can settle thereby creating sedimentary deposits within equipment and/or score or otherwise abrade equipment if not removed from the source water. Furthermore, waterborne microbes can give rise to noxious odors, tastes, etc. as well as posing biologic challenges. For instance, the introduction of certain bacteria into an oil (or other hydrocarbon) bearing formation can lead to biological decomposition of the oil therein at a potentially large economic loss to the operator.

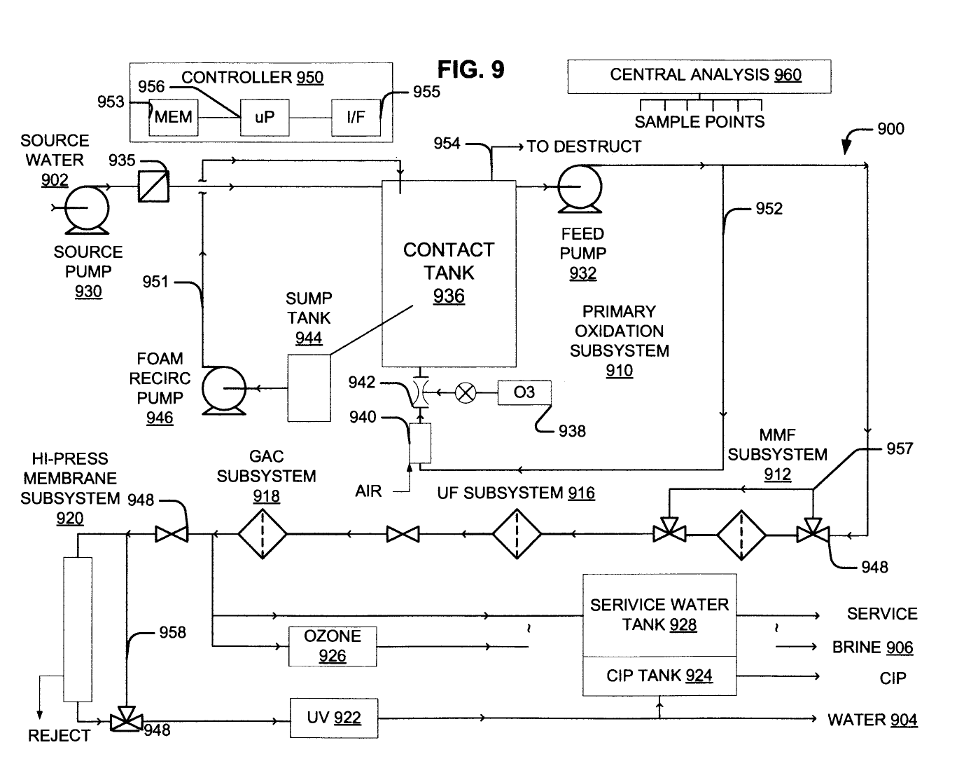

Moreover, at the time that the hydrostatic fracking operation is complete and flowback begins, the initial flowback water might be relatively close in quality to that pumped into the oil well. This is so, of course, because as the flowback begins, the last water pumped in to the well is likely to be in or near the casing thereof. It will therefore tend to flowback first followed by water that has absorbed or entrained some chemical species from the well and/or its underlying formation. As time increases, water from locations further from the casing begins flowing from the well with an attendant increase of such species. Total dissolved solids (TDS) in flowback water often reflect such trends. Initially, in some wells, TDS can be in the range of several thousand to 10,000 to 20,000 mg/l. As the flowback in such wells reaches steady state (weeks or months later), TDS can exceed 100,000 mg/l for about a tenfold increase. Other measurements of water quality in the flowback can show similar trends. Thus, it can be desirable for treatment systems for such water to dynamically adapt to water quality with little or no human intervention (including but not limited to manual modification of the technologies in the corresponding treatment trains). Accordingly, it might now be helpful to consider FIGS. 9-14.

FIG. 9 illustrates a schematic diagram of a water treatment system. In some embodiments, the systems 900 include certain water treatment subsystems (or technologies) arranged in order such that subsystems earlier in the order remove materials in the water that might clog, foul, or otherwise degrade subsequent subsystems in the order. Moreover, many of the technologies underlying the subsystems are mechanical in nature rather than chemical so that such subsystems use little or no consumables. Indeed, in some cases, what consumables might be used are generated on site, within the system, and/or are chosen for other reasons such as, perhaps, optimizing aspects of such systems 900. Responsive to sensed water conditions, system controllers of embodiments bypass particular subsystems if those water conditions indicate that treatment by those subsystems might not be altogether necessary. Such controllers also recirculate water exiting particular subsystems if the condition of that water indicates that further processing by that and/or previous subsystems might be desirable.

More specifically, FIG. 9 illustrates a system 900 of various embodiments including its source water 902 and the treated water 904 and treated brine 906 it can produce. Such systems 900 can be used to treat flowback water from various oil wells 801 and/or other water sometimes found in oilfields. Thus, systems 900 often treat water with potentially large amounts of oil, suspended particulate matter, dissolved compounds, salts, and other chemicals but little if any in the way of debris or relatively large particulate matter (>100 microns). Moreover, systems 900 of the current embodiment can do so while responding to the time-varying concentrations of these materials, without human intervention, and in relatively energy efficient manners.

The system 900 of the current embodiment includes primary oxidation subsystem 910, mixed media filtration (MMF) subsystem 912, ultrafiltration (UF) subsystem 916, granular activated carbon (GAC) filtration subsystem 918, high pressure (HP) membrane subsystem 920, ultraviolet (UV) irradiation chamber 922, clean-in-place (CIP) tank 924, secondary oxidation manifold 926, service tank 928, and a number of other components. Those components include source pump 930, feed pump 932, contact tank 936, ozone source 938, turbulence chamber 940, ozone eductor (venturi) 942, foam sump tank 944, and foam recirculation pump 946. Systems 900 of the current embodiment also include a screen filter 935. The foregoing components and various valves 948 (not all of which are shown) can be said to define various paths in system 900 including foam recirculation path 950, oxidation recirculation path 952, ozone destruct path 954, MMF bypass path 957, HP bypass path 958, etc.

The subsystems of system 900 (and certain components that can be deemed subsystems) are arranged to remove impurities from source water 902 such that once a particular impurity has been removed, subsystems subsequent to its removal can operate more or less without regard to its presence in source water 902. This ordering of the subsystems allows subsystems particularly well-suited to remove certain types of impurities to be placed downstream in the order where they need not accommodate other, earlier-removed, impurities during their operation. Indeed, during system 900 startup (and/or upsets), a controller 950 can sense the water quality after most (if not all) of the subsystems and (if the water quality is not suitable for these later-in-the-order subsystems) recirculate the water until it is suitable for subsequent treatment. Moreover, the recirculation of partially treated water to earlier systems (where it mixes with less thoroughly treated water) can conserve energy because the partially treated water dilutes the less thoroughly treated water thereby reducing the power to treat a given volume of the (diluted) less thoroughly treated water. Although, some additional energy might be used in re-treating the treated water (mixed in with the untreated water). It might be worth noting that the impurities removed from the partially treated water either remain in the filters which removed them from the water or exit the system 900 via various mechanisms (thereby avoiding any additional energy consumption to re-remove them from the water).

With reference still to FIG. 9, the screen filter 935 occurs first after the source pump 930 in systems 900. Screen filter 935 collects relatively large solids (greater than or about equal to 100 microns in size) entrained in the source water 902 thereby preventing fouling of subsequent components, subsystems, etc. Primary oxidation subsystem 910 occurs next in the ordering of the system 900.

Primary oxidation subsystem 910 performs an initial disinfection of the source water 902 and oxides iron and manganese species. It also helps separate oils (and other hydrocarbons) in source water 902 and helps coagulate particulate matter in the source water 902. As such, primary oxidation subsystem 910 can enhance downstream filter performance and longevity as well as, perhaps, reducing fouling of the mixed media filters in MMF subsystem 912. Moreover, the primary oxidation subsystem 910 oxidizes many iron and manganese species present in the source water 902. It might be worth noting here that primary oxidation subsystem 910 is termed “primary” in part or entirely because it occurs first in the system 900 order. Regarding MMF subsystem 912, which occurs next in the order, it tends to tolerate (and remove) solid/particulate matter better than the membrane subsystems (low and/or high pressure) which occur later in the ordering of system 900. Indeed, MMF subsystem 912 removes particulate matter down to about 0.5 micron in size from the partially treated water flowing from the primary oxidation subsystem 910.

Next in the order, system 900 includes UF subsystem 916. With the organics (at least partially) sterilized, the iron and manganese compounds oxidized, and at least some of the particulate matter removed from the source water 902 (by the primary oxidation subsystem 910), the UF subsystem 916 is positioned to remove undissolved and suspended materials still remaining in the source water 902 (down to about 0.1 micron including some of the larger bacteria). With most of the undissolved and/or suspended materials removed from the source water 902 (by the previous subsystems), the GAC subsystem 918 is positioned in system 900 to remove many of the VOCS, semi volatile chemicals, and/or at least some dissolved compounds from source water 902. In the current embodiment, the nominal pore size of the filters in the UF subsystem 916 is 0.03 micron).

Accordingly, following treatment by the GAC subsystem 918, the water (or rather the product water of system 900 to this point) is largely brine (the remaining species usually being salts and/or their dissolved anions and cations). Since many uses allow for brine, system 900 of many embodiments, at this point, has produced product water of at least adequate quality for such uses. As such, this treated brine 906 can be stored in service tank 928 or delivered to various points of use via secondary oxidation manifold 926. It can be noted here that secondary oxidation manifold 926 can act much like a subsystem in that it provides some treatment to the source water 902 (or more accurately, the brine that will become treated brine 906 within secondary oxidation manifold 926) and that it has a particular spot in the ordering of system 900. Indeed, by providing another oxidation treatment, secondary oxidation manifold can inactivate (or sterilize) any remaining pathogens (whether bacterial or viral) in the treated brine 906 before delivery to its various points of use. In the alternative, or in addition, system 900 can route the treated brine 906 to service tank 928 for subsequent use or in backwashing, cleaning, etc. portions of system 900.

In the alternative, or in addition, to producing treated brine 906, system 900 can further process treated brine 906 to produce desalinized product water (or treated water 904). In some embodiments, system 900 does so by routing the treated brine 906 to the HP membrane subsystem 920. While FIG. 9 illustrates HP membrane subsystem 920 as containing one HP membrane filtration element, it can be the case that HP membrane subsystem 920 contains more than one such element. Furthermore, HP membrane subsystem 920 can include one or more reverse osmosis (RO) filters, nanofiltration (NF) filters, or combinations thereof. System 900 places HP membrane subsystem 920 toward the end of the order so that it can be used on water with all but salt and other ionic species removed there from thereby allowing that subsystem to operate in an efficient and reliable manner in most scenarios.

Further still, permeate from HP membrane subsystem 920 can be routed to UV irradiation chamber 922 for sterilization before delivery to some or all of its point(s) of use in the current embodiment. Of course, if desired, treated water 904 can be routed to CIP tank 924 for subsequent use and/or for backwashing and/or cleaning other subsystems of system 900. Note that the UV irradiation chamber 922 can be deemed a subsystem because of its treatment of the water passing there through. System 900, accordingly, places the UV irradiation chamber 922 of the current embodiment last in the ordering of system 900 (for treated water 904) as shown by FIG. 9.

With continuing reference to FIG. 9, it might now be helpful to discuss a nominal treatment process of systems 900 in more detail. Thus, depending on user desires and at steady-state, source water 902 flows into the system 900 and passes through one or more of the treatment subsystems. Often, that path begins with the primary oxidation subsystem 910, then the MMF subsystem 912, the UF subsystem 916, and then the GAC subsystem 918. That combination of subsystems (or some subset thereof depending on source water 902 conditions) will normally produce brine which is relatively free of most unwanted species in the source water 902. That brine can be stored in service tank 928 and/or can be sterilized by passage through the secondary oxidation manifold 926 then output by system 900 as treated brine 906.

In the alternative, or in addition, that brine can be passed through HP membrane subsystem 920 to produce treated water 904. Furthermore, that desalinized brine (water) can be sterilized by passage through UV irradiation chamber 922 to produce treated water 904. Treated water 904 can be stored in service tank 928 and/or can be output by system 900. As is disclosed further herein, though, the source water 902 (or partially treated water derived therefrom) can bypass certain subsystems, can be recirculated through subsets of the subsystems, and (once treated to various degrees) can be used for backwashing and/or cleaning certain components of system 900.

Moreover, sensors (not shown) allow the controller 950 to direct such operations as well as starting up system 900, maintaining it at steady-state operations (water conditions permitting), and/or responding to transients, upsets, and the like which might affect system 900. The controller 950 of the current embodiment, moreover, can include a memory 953, a communications interface 955, and a processor 956 in communication with one another as illustrated by FIG. 9. The memory 953 stores processor readable instructions which when executed by the processor 956 cause the processor 956 to execute methods such as those disclosed herein. Furthermore, the communications interface 955 allows the controller 950 to communicate with various sensors, users, and end effectors (motors, valves, pumps, variable frequency drives, etc.) associated with system 900.

With continuing reference to FIG. 9, it might now be helpful to consider some of the subsystems and/or components of system 900 with more specificity. For instance, source pump 930 can be any type of pump capable of pumping source water 902 into system 900. Diaphragm pumps, screw pumps, self grinding pumps, etc. can be used for source pump 930 although other types of pumps could be used. Its size, of course, depends on the desired capacity of the system 900 (as measured by the amount of treated brine 906 and/or treated water 904) desired by users plus an allowance for the fraction of the source “water” diverted as reject, used for cleaning, backwashing, etc. As illustrated, source pump 930 discharges its throughput to screen filter 935 which can be selected so as to prevent debris and large conglomerations of solid materials from entering the remainder of system 900.

Primary oxidation subsystem 910 lies downstream from the source pump 930 and screen filter 935. While the bulk of the source water 902 that enters the primary oxidation subsystem 910 will flow onward during most operations, primary oxidation subsystem 910 includes two recirculation loops 951 and 952. One recirculation path 952 provides for the introduction of an oxidizer/coagulant while the other provides for the removal of foam caused by the introduction of that oxidizer and/or agitation of the source water 902 within the primary oxidation subsystem 910. With ongoing reference to FIG. 9, primary oxidation subsystem 910 includes the contact tank 936, feed pump 932, the turbulence chamber 940, the ozone source 938, the ozone eductor 942, the foam sump tank 944, the foam recirculation pump 946, and perhaps part of the ozone destruct path 954.

During nominal operations, source water 902 typically flows under pressure from the source pump 930 through the screen filter 935 and into an oxidation chamber (not shown) of the contact tank 936. If the oxidation chamber is not at an operational level, the inflow from the source pump 930 is controlled to bring the oxidation chamber up to that level. Once at or above the operational level, a fraction of the source water 902 flows through a weir and into a wet well (or dearation or settling chamber) of the contact tank 936. The settling chamber is sized and shaped to allow the water flowing into it to become still (and remain so for some residence time) so that air (and/or other gases) entrained and/or dissolved in the source water 902 have time to rise to the top of the settling chamber thereby mechanically separating themselves from the water. In the meantime, the now dearated water flows out of the settling chamber due to the action of the feed pump 932 drawing water into its suction port.

Considering again the oxidation chamber of the contact tank 936, a fraction of the water pumped through the feed pump 932 is bled back to aid in aerating the water in the oxidation chamber. More particularly, that fraction of water is routed through the turbulence chamber 940 where high pressure air from an air source is injected into the water bled from the feed pump 932. The turbulence in the water and the air injected into the turbulence chamber 940 results in a rapid mixing of these two fluids in the turbulence chamber 940. One result thereof is that the mixture leaving the turbulence chamber 940 is highly agitated air-saturated water with a significant fraction of its volume being occupied by micro bubbles of air. The ozone eductor 942, moreover, happens to be placed near the turbulence chamber 940 so that these micro bubbles have little time to combine into larger bubbles. As the air/water mixture passes through the ozone eductor 942, it creates a low pressure region at and/or near the throat of the ozone eductor 942. The low throat pressure draws ozone from an ozone source into the air/water mixture in the ozone eductor 942 resulting in the creation of more micro bubbles (but of ozone) as well as causing some ozone to go into solution in the water.

The ozone eductor 942 is also positioned at, near, or in the oxidation chamber of the contact tank 936 such that the stream of water, air, and ozone from the ozone eductor 942 jets into the water resident in the oxidation chamber creating corresponding turbulence. That turbulence brings the resident water into intimate contact with the (now dissolved) air and ozone and/or the micro bubbles thereof. As a result, any dissolved organic material in the resident water becomes oxidized thereby causing some treatment of the source water 902 (which will ultimately flow into the settling chamber and thence onward through system 900). However, the agitation caused by the water/air/ozone jet (along with turbulence from the entry of source water 902 from source pump 930) tends to create some foam in the aeration chamber. That foam is usually created from certain organic materials in the source water 902. The foam, of course, tends to float to the top of the aeration chamber and, were it not controlled and/or removed, could become somewhat of a nuisance. Moreover, because the substance of that foam represents a concentration of certain constituents of the source water 902, removal of the foam from the system 900 represents another generally mechanical treatment performed by system 900 on the source water 902.

In the current embodiment, accordingly, primary oxidation subsystem 910 provides mechanisms for controlling the foam and for mechanically separating the material which tends to form that foam. For instance, FIG. 9 illustrates foam recirculation path 950. As noted above, agitation in the oxidation chamber of the contact tank 936 tends to cause the foam to arise. Further still, many of the oxidants that could be injected via the ozone eductor 942 tend to increase the amount of foam created in the aeration chamber. The foam (perhaps aided by certain control actions of the controller 950) will tend to seek some level in the aeration chamber, as does the water therein. Thus, the outlet which drains to the foam sump tank 944 can be positioned 1) above the expected surface of the water in the aeration chamber during nominal operations and 2) below any level at which the foam might become a nuisance. In some cases, that drain can be positioned at that nominal liquid level or perhaps a bit above the same. In such a position, the drain will therefore preferentially draw the foam liquor (formed as the individual foam bubbles collapse) off of the surface of the water resident in the aeration chamber of the contact tank 936.

From there, the foam liquor drains to the foam sump tank 944. The foam recirculation pump 946 pumps the foam liquor from the foam sump tank 944 to spray bars positioned in the contact tank above the aeration chamber. In addition, at some point along the foam recirculation path 951 an anti-foam agent is injected into the recirculating foam liquor. Thus, as the anti-foam agent-laden liquor sprays from the spray bars it can contact a relatively large proportion of the individual foam bubbles in the aeration chamber. Many of the foam bubbles therefore collapse under the action of the (possibly) mechanically aggressive spray and the action of the anti-foam agent therein. The collapsing foam bubbles form the liquor that then flows out of the drain and to the foam sump tank 944. A foam level sensor 1033 in the oxidation chamber determines how much anti-foam agent is introduced into the recirculating liquor and determines when (and to what extent) the liquor is discharged from the foam recirculation loop via an appropriately placed valve 948 for disposal or other disposition.

As a result, primary oxidation subsystem 910 removes those materials from source water 902 that tend to foam under such circumstances. More specifically, primary oxidation subsystem 910 tends to remove dissolved (and suspended) organic material (for instance, oil) from source water 902. System 900 takes advantage of this tendency of primary oxidation subsystem 910 by using other treatment technologies (that might not handle oily or organic chemicals as well as primary oxidation subsystem 910) downstream there from. Indeed, one task performed by primary oxidation subsystem 910 can be said to be protecting MMF subsystem 912, UF subsystem 916, GAC subsystem 918, and HP membrane subsystem 920 from contact with such carbonaceous and/or oily materials.

By way of contrast, many systems available heretofore use “skimmers” and/or other passive technologies to separate bulk oil from source waters 102. However, primary oxidation subsystem 910 of embodiments consumes less physical volume (on a per gallon of water to be treated basis) than such heretofore available systems. Primary oxidation subsystem 910 therefore contributes to reducing the physical size of the system 900 such that it can fit within an industry-sized standard shipping container and/or trailer.

With continuing reference to FIG. 9, feed pump 932 happens to be positioned in the next location in system 900. Feed pump 932 can be any type of pump capable of handling the throughput at its position in system 900. In some embodiments, for instance, a centrifugal pump is used for feed pump 932. Feed pump 932 pumps liquid from primary oxidation subsystem 910 toward the MMF subsystem 912. Of course, as mentioned elsewhere herein, a fraction of the flow developed by feed pump 932 is bled off for use in aerating the liquid in the aeration chamber of the contact tank 936. The remainder of the flow continues on to the MMF subsystem 912 during nominal operations.

The MMF subsystem 912 of the current embodiment includes three mixed media filters of similar configuration. Of course, other embodiments provide MMF subsystems 912 in which the mixed media filters have differing configurations. Nonetheless, the mixed media filters of the current embodiment include a series of progressively finer media through which the liquid pumped by the feed pump 932 passes. For instance, the multimedia filters can include a bed of fine gravel through which the liquid first passes followed by a bed of finer sand, anthracite, etc. Other types of and numbers of filtration materials are within the scope of the disclosure. As the water undergoing treatment passes through the mixed media filters (in parallel) of the current embodiment, the media of the filters captures particulate matter of increasingly smaller average sizes (down to about 0.5 microns).

FIG. 9 further illustrates that water flowing through system 900 for treatment can pass through UF subsystem 916. UF subsystem 916 can include one or more UF membranes capable of filtering particulate matter down to about 0.03 microns. As such, UF subsystem 916 can filter out much of the suspended particulate matter and even some of the larger species of dissolved matter in source water 902. For instance, UF subsystem 916 can remove some of the larger bacteria from source water 902. Note that if users so desire, system 900 can omit a bypass path for UF subsystem 916 although some embodiments do provide such bypath paths (whether manual or automated). For systems 900 without an UF bypass path (as illustrated by FIG. 9), this configuration ensures that little if any suspended matter ever reaches the GAC subsystem 918 (or other downstream technologies) during nominal operations. Moreover, the ordering illustrated by FIG. 9 also ensures that the suspended matter loading on the GAC subsystem 918 will be relatively low during nominal operations for systems 900 of the current embodiment.

Moreover, the staged filtration of source waters 902 represented by the various beds of mixed media in the MMF subsystem 912 and the UF filters in the UF subsystem 916 contrasts with passive sedimentation approaches in systems heretofore available. Indeed, this staged filtration contributes to reducing the physical size (on a per gallon of source water 902 to be treated) of the system 900 of embodiments. Accordingly, systems 900 tend to be smaller than even less capable systems heretofore available. Systems 900 can even fit in industry-sized standard shipping containers and/or trailers. Note also that the position of GAC subsystem 918 in the order of system 900 contributes to the relatively small size of systems 900 of embodiments. More specifically, by relieving the GAC subsystems 918 of most loading except for dissolved organic capture, the order of system 900 optimizes GAC subsystem 918 for that role, particularly as that optimization pertains to the physical size of systems 900 as measured by its footprint on volume of water to be treated basis.

With regard to the GAC subsystem 918, it acts to remove most remaining organic compounds from the source water 902 (or partially treated water). More specifically, the GAC subsystem 918 of the current embodiment removes most organics and dissolved organic compounds from the source water 902. Thus, water issuing from the GAC subsystem 918 tends to be mostly free of pesticides, solvents, lubricants, etc. making that water suitable for use as treated brine 906 or for further treatment by HP membrane subsystem 920.

While FIG. 9 illustrates that systems 900 of the current embodiment use GAC to absorb such species, any technology capable of absorbing (or otherwise removing these species) can be placed where FIG. 9 illustrates GAC subsystem 918 in the ordering of system 900. For instance, powdered, extruded, bead, impregnated, and/or polymer coated activated carbon absorption technology can be used if it provides sufficient surface area for the desired throughput of system 900. Note also, that FIG. 9 also illustrates that systems 900 of the current embodiment do not provide bypass paths around the GAC subsystem 918. In this manner, systems 900 of the current embodiment help ensure that no (or relatively few) VOCs or semi-volatile organic species reach the point where treated brine 906 exits the GAC subsystem 918 (and/or points downstream). Of course, if desired, systems 900 can include bypass paths around GAC subsystem 918 if desired.

As disclosed further herein, system 900 of the current embodiment branches downstream of the GAC subsystem 918. One branch delivers treated brine 906 to the service tank 928 and/or to points of use via secondary oxidation manifold 926. The service tank 928 can be sized to hold enough water or brine for backwashing operations of the various subsystems up to and including the GAC subsystem 918 in the order of the system 900. It can also be sized to hold additional treated brine 906 for use at various points of use outside of system 900 if desired. Furthermore, the secondary oxidation manifold 926 can communicate with a source of ozone or other oxidizer suitable for sterilizing the treated brine 906. Moreover, the secondary oxidizer manifold 926 can be shaped and dimensioned to provide adequate contact time for the oxidizer such that, at desired flow rates, the treated brine 906 flowing from the secondary oxidation manifold 926 of the current embodiment is likely to be mostly or entirely sterilized.

With ongoing reference to FIG. 9, the system 900 also branches toward the HP membrane subsystem 920 from the GAC subsystem 918. Thus, if users so desire, system 900 can be used to remove salinity from the treated brine 906 from the GAC subsystem 918. HP membrane subsystem 920, depending on the membranes employed therein, can be used to remove many remaining compounds from the treated brine 906. For instance, most species with molecular weights over 80 tend to be rejected by HP membrane subsystem 920. This means that any remaining VOCS and/or semi-volatile compounds (such as poising, pesticides, pharmaceuticals, etc.) will likely be removed from the water permeating through the membranes of the HP membrane subsystem 920. Additionally, many radioactive and/or metallic species will likely be rejected by the HP membrane subsystem 920.

Furthermore, depending on the quality of the treated brine 906 (as measured by its conductivity in many situations), HP membrane subsystem 920 can be configured in a variety of manners to treat the incoming treated brine 906. For instance, if it has a relatively low salinity, the controller 950 can configure HP membrane subsystem 920 such that the treated brine 906 passes through a single (bank of) high pressure membrane for filtration. If the quality of the treated brine 906 is somewhat lower (high saline content) the controller 950 can configure HP membrane subsystem 920 such that the treated (but high salinity) brine 906 permeates through two, three, or more HP membrane filters (or banks thereof). In addition, system 900 can be configured in a “staged” manner. In addition, using HP membranes in various staged configurations, one set of HP membranes can be operated to provide product waters of differing salinities at differing throughputs despite source waters 902 of varying salinity. The staging of the HP membranes therefore provides a wide variety if capabilities within a relatively small subsystem footprint. Again, the ordering the system 900 (along with the staged operation of the HP membrane subsystem 920) contributes to the relatively small physical size of the system 900 (especially on a per gallon of treated water basis).

No matter how the controller 950 configures the HP membrane subsystem 920, whether staged or not, the resulting lower-salinity permeate then flows through the UV irradiation chamber 922. In this way, a second sanitizing treatment is applied to the permeate before it exits system 900. This further ensures that the resulting treated water 904 includes no (or few) active bacteria, viruses, or other pathogens. Of course, if desired, the resulting treated water 904 can be stored in CIP tank 924 for cleaning subsystems throughout system 900 and/or for use elsewhere. Thus, CIP tank 924 can be sized to hold enough water for such purposes as well as storage for subsequent uses if desired.

However, in some embodiments, CIP tank 924 is sized only t hold enough treated water 904 to service the system 900 once and little more. Similar considerations can apply to the service tank 928. Thus, the sizing of these tanks 924 and/or 928 can contribute to the ability of system 900 to fit within one standard size shipping container and/or trailer.

In some scenarios, the source water 902 might or might not contain certain species. Or, those species might be at such a low level as to meet users desires as-is. In such cases treating the source water 902 as if it contained all potential species would result in expending energy, consumables, etc. and/or causing wear on various system 900 components needlessly. Doing so could also potentially reduce the throughput of system 900 below what it might be otherwise. Accordingly, system 900 can include various sensors in communication with the controller 950 to monitor the source water 902 (and/or the various partially or entirely treated waters in system 900). Thus, if prior to a particular subsystem, the water in system 900 contains a low enough concentration of the species to be removed by that subsystem, the controller 950 can bypass that subsystem so long as such conditions persist. If conditions change, and the species appears (or begins to appear or increases in concentration above some threshold), the controller 950 can close (or throttle) the bypass path to direct some or all of the water through the particular subsystem.

On the other hand it could occur in some scenarios that a particular species appears downstream of the subsystem that nominally removes it from source water 902. For instance, during start up scenarios it might be the case that water of initially unknown quality might be in system 900 or various portions thereof. In other scenarios, an upset might occur in which a particular subsystem fails or becomes ineffective. In yet other scenarios, an upset occurs affecting the source water 902 itself such that some species gradually (or otherwise) increases. For instance, over time, flowback/produced water tends to increase in both dissolved and suspended matter as well as in the organic compounds contained therein. As a result, system 900 can be instrumented with sensors downstream of one or more subsystems and which allow the controller 950 to monitor the waters exiting the various subsystems for the presence of the organic species that those subsystems should have removed.

When one or more of these “exit” sensors detects that a species exists in the water that a foregoing subsystem should have removed, the controller 950 can automatically reconfigure system 900 to recirculate water from that point back to the source of source water 902 source for re-treatment. Thus, the species-containing water will pass through the treatment train of system 900 in the order of the subsystems shown by FIG. 9 (with bypasses possible in some scenario) until it reaches the subsystem capable of its removal. At some point enough of the impurity will have been removed from the recirculating water such that the as-sensed concentration of the species at that subsystem exit will have dropped below a corresponding threshold. The controller 950 can again configure system 900 to allow the now sufficiently treated water to reach (and be treated by) subsequent subsystems. Eventually, the system 900 will again begin/resume producing treated brine 906 and/or treated water 904 and/or other product waters of adequate quality for desired uses having recovered automatically from the upset or other occurrence.

Note that instrumentation tubing can route water (and/or brine) from the various subsystem entrance and exit points in system 900 to a common analysis cabinet 960 (or other structure) of some embodiments. The common analysis cabinet 960 can provide for determination of the water quality at the various sensed points. Moreover, because the common analysis cabinet 960 of the current embodiment can include one set of sensors that sense the samples taken from the various sample points, no cross-calibration needs to occur between differing sensors of a similar nature throughout system 900 (as would be the case with individually placed sensors). The current embodiment therefore allows for less expensive operation of systems 900 while improving the precision and accuracy with which controllers 950 control such systems 900.

The common analysis cabinet 960 can include provisions to time the various samples and/or to flush the common set of sensors with a solvent or other fluid so that residue from one sample will not affect subsequent samples. In some systems 900 the timing includes a round robin schedule for sample points related to the various subsystems in operation. However, it can be the case that samples from one or more sample points (for instance the oxidation inlet sample point 1009) can be analyzed more frequently than others so as to detect upsets where they are more likely to occur in a timely manner. Moreover, the common set of sensors allows the controller 950 and/or users to analyze water throughout the system 900 for a wide variety of species limited only by the types of sensors in common analysis cabinet 960.

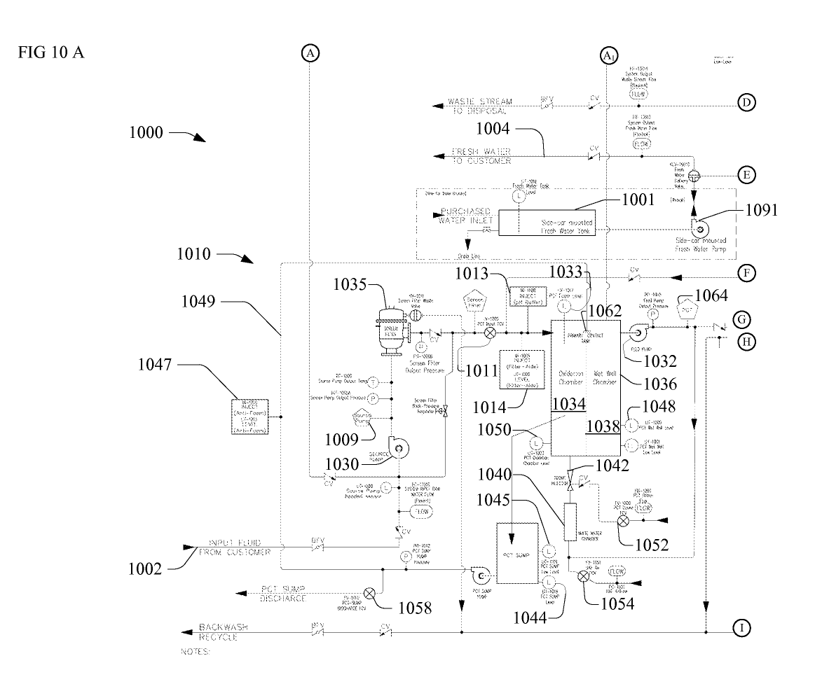

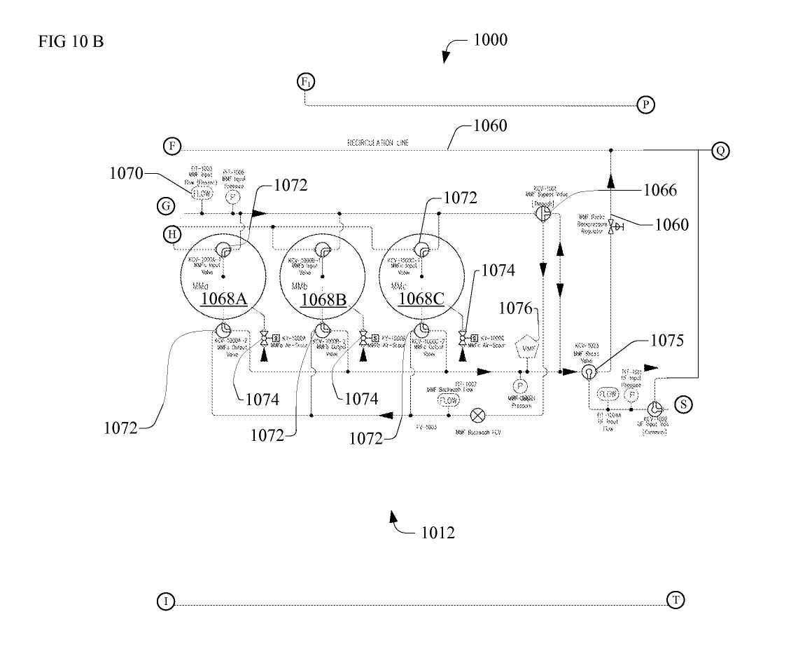

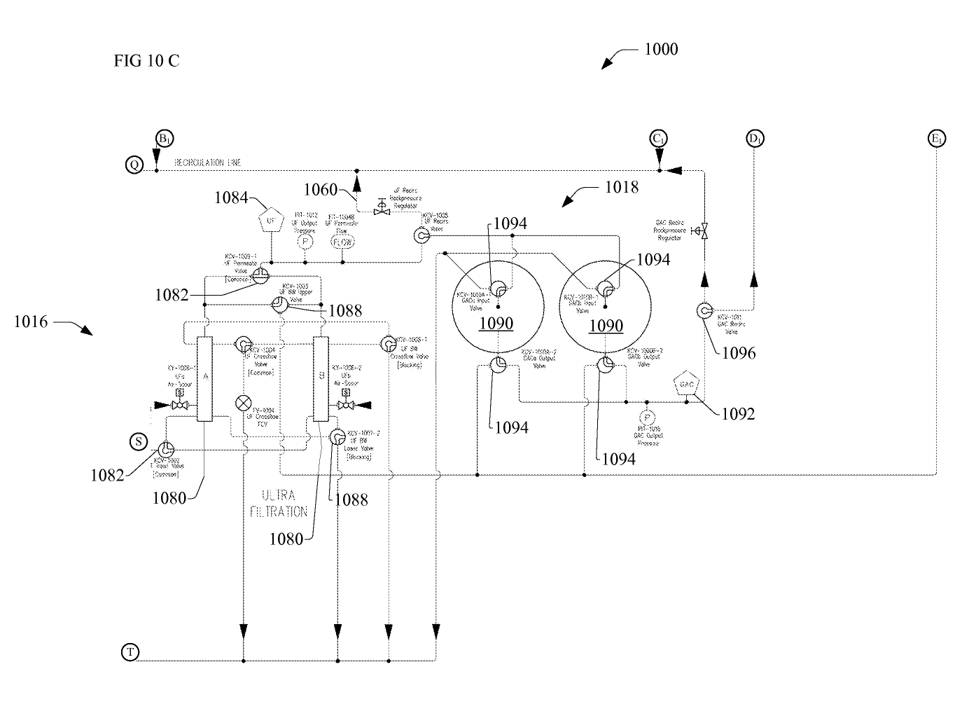

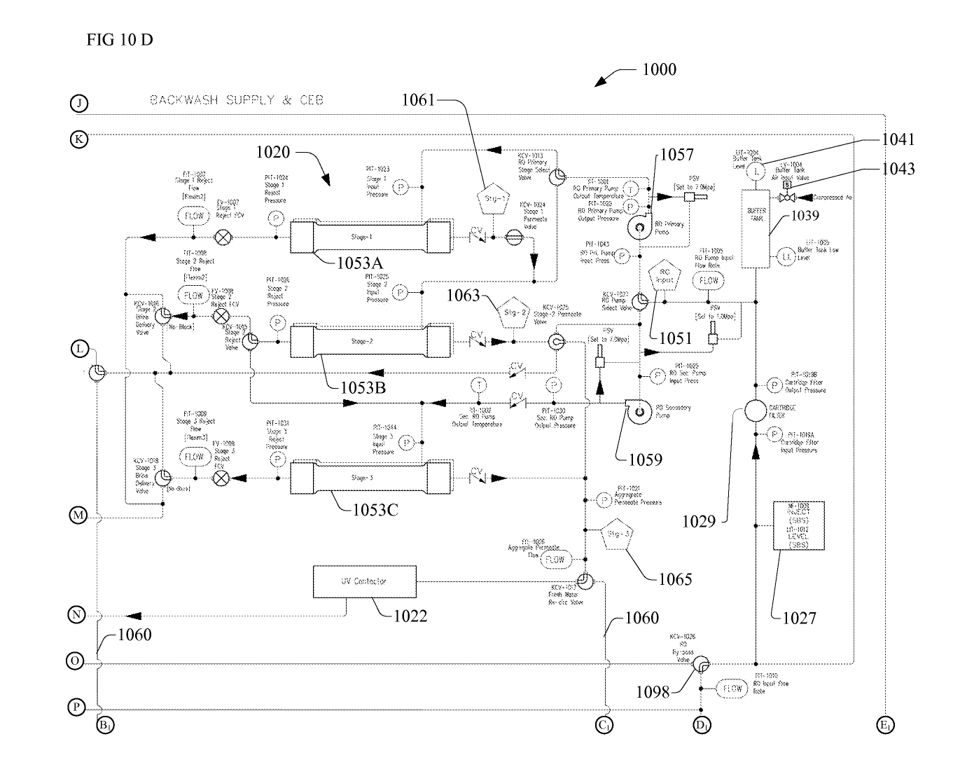

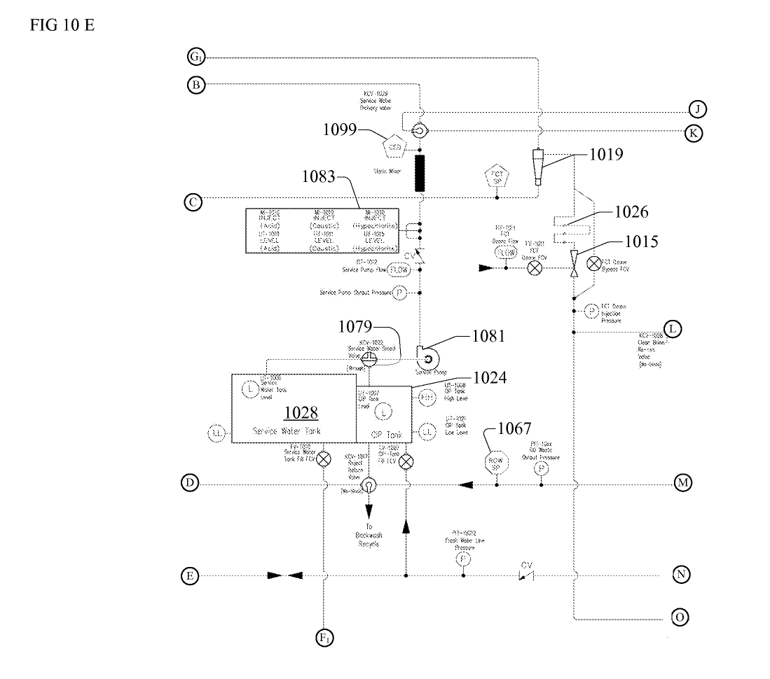

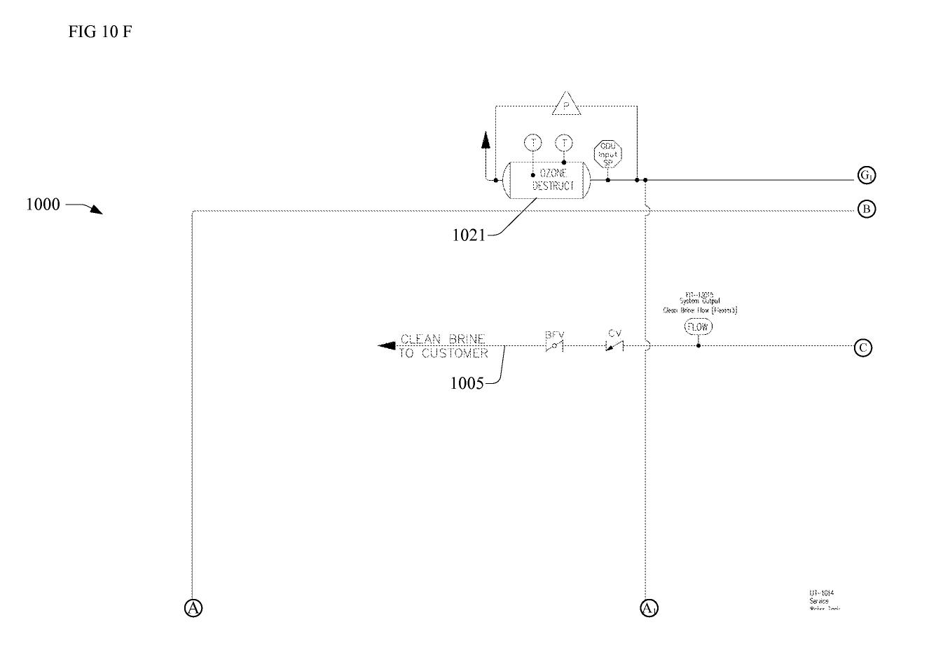

FIG. 9 therefore illustrates embodiments of system 900 that can produce treated brine 906, treated water 904, or some combination thereof. Moreover, system 900 can produce these types of product “water” which are relatively free of active pathogens, suspended matter, dissolved matter, VOCs, semi-volatile organic compounds, organic compounds, salts, metals and metallic compounds, radioactive material, etc. and/or combinations thereof. Further still, product waters can be withdrawn from intermediate points throughout system 900 such that system 900 can produce product waters of varying treatment levels as selected by users. It might now be helpful to consider systems 1000 of various embodiments as illustrated by FIG. 10A to FIG. 10F.

FIG. 10A to FIG. 10F illustrate a schematic diagram of another water treatment system. Systems 1000 and systems 900 share similar subsystems in a similar ordering. Notwithstanding the level of detail shown in FIG. 10, the disclosures related to FIG. 10 will (for the sake of clarity) forego discussion of certain aspects of system 1000 which those skilled in the art will understand without further explicit elaboration. Thus, with regard to FIG. 10, it might now be useful to disclose systems 1000 of the current embodiment from the source water 1002 inlet to the points where various product waters (treated water 1004 and treated brine 1005 among others) leave these systems 1000.

Accordingly, source water 1002 flows into system 1000 under the action of source pump 1030 and is pumped through screen filter 1035. Screen filter 1035 will stop relatively large particulate matter (larger than about 100 microns in size) from entering system 1000. Screen filter 1035 can be a self-washing filter if desired with a conduit which connects its waste side to the backwash recycle path 1008. In this way solid matter that might build up on the screen filter 1035 can be flushed to some convenient disposal point and/or to the source from which the system 1000 draws source water 1002.

However, most of the source water 1002 (now without relatively large solids entrained therein) will usually flow onward through system 1000. Indeed this water can be sampled by oxidation inlet sensor to determine its quality prior to treatment by primary oxidation subsystem 1010. Of course, the oxidation inlet sensor might be a collection of sensors such that various water quality parameters can be determined before the water enters the primary oxidation subsystem 1010. However, due to the nature of primary oxidation subsystem 1010 such sampling might not be necessary as is further disclosed elsewhere herein. That result can be so because primary oxidation subsystem 1010 will recirculate the water therein until it is adequately cleaned for the mixed media filtration (MMF) subsystem 1012 in most scenarios. In the alternative, or in addition, the oxidation inlet sensor can be located in a common analysis cabinet such as common analysis cabinet 960 (see FIG. 9). Accordingly, henceforth (and for other such sensors), the oxidation inlet sensor will be referred to as the oxidation inlet sample point 1009. Samples may therefore be drawn from the oxidation inlet sample point 1009, analyzed for a variety of water quality related factors, and then discarded back into source water 1002. In the current embodiment, the sample drawn from oxidation inlet sample point 1009 could be analyzed by a particulate sensor, a turbidity sensor, a total organic carbon (TOC) sensor, etc.

A flow control valve 1011 controls the flow rate of water into the oxidation chamber 1034 of the contact tank 1036 as determined by the oxidation chamber level sensor 1050. In this way, the level in the oxidation chamber 1034 can be maintained at a desired point and/or within some selected range. If desired, an additive can be injected into the source water 1002 entering the primary contact tank 1036 to aid in coagulating particulate matter therein. In some embodiments, the filter aid used is a flocculant such as an alum derivative and in some embodiments polyaluminium chloride. This additive can be stored in a filter aid tank 1014 and injected in proportion to the flow rate of water flowing into the oxidation chamber 1034 and/or the turbidity of the source water 1002. Note, that by assisting in the coagulation and flocculation of particulate matter, the injected filter aid can make the filters downstream from the primary oxidation subsystem 1010 (in the MMF subsystem 1012, the UF subsystem 1016, and the GAC subsystem 1018 more efficient.)

In addition or in the alternative to the injection of filter aid, systems 1000 of some embodiments inject a pH buffer into the source water 1002 entering the primary oxidation subsystem 1010. The pH buffer which is stored in the pH buffer tank 1013 can be any buffer capable of raising the pH of the source water to approximately 9.5 or greater and in some embodiments is sodium hydroxide. The resulting increased pH can compensate for the drop in pH of the water as some portions of system 1000 remove (predominately) alkaline materials from the water therein. It can also enhance the ability of certain subsystems (for instance the UF subsystem 1016 and the HP membrane subsystem 1020) to reject certain species (for instance iron and/or manganese species). In the alternative, the amount of pH buffer injected into the primary oxidation subsystem 1010 can be inversely proportional to the pH of the permeate (water) exiting the HP membrane subsystem 1020 as measured at HP exit sample point 1065 and/or the pH of the brine leaving the GAC subsystem 1018 as measured at GAC exit sample point 1092.

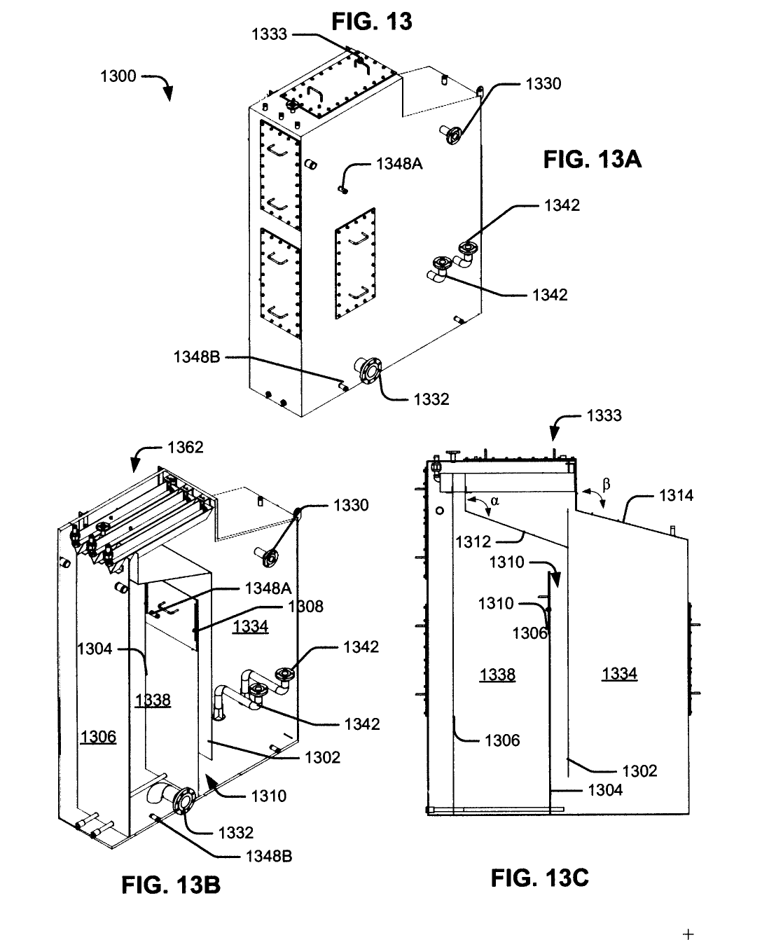

With continuing reference to FIG. 10, the source water 1002 (with or without filter aid, pH. buffer, and/or large particulate matter) enters the contact tank 1036 via the oxidation chamber 1034. As is further disclosed with reference to FIG. 13, the water level in the oxidation chamber 1034 is maintained at a level to enable foam which can form therein to be drawn off to the foam sump tank 1044. More specifically, oxidation chamber level sensor 1050 drives flow control valve 1011 to maintain the oxidation chamber 1034 level at or near that foam-removal level. While the incoming source water 1002 (as agitated by the turbulence caused by the source pump 1030 and/or the flow control valve 1011) might cause some foam, the action of the water/dissolved air stream entering the oxidation chamber 1034 via ozone eductor 1042 causes the majority of the foam in most scenarios.

On that note, a combination of ozone (or other oxidizer) and dissolved air is injected into the water in the oxidation chamber 1034 via ozone eductor 1042. The ozone in most scenarios oxidizes organic compounds in the water in the oxidation chamber 1034 and enhances the coagulation and flocculation of particulate matter entrained therein. The dissolved air injected under pressure (along with water recirculating from the feed pump 1032) rapidly expands to the lower pressure of the oxidation chamber 1034 thereby forming bubbles which interact with oil(s) and other organic compounds in the water resident therein. That interaction largely causes the foam present in oxidation chamber 1034 during many operating conditions. The resulting foam (or its liquor) drains off to foam sump tank 1044 thereby mechanically removing much of this organic matter from the oxidation chamber 1034 (and hence from the source water 1002). In addition, the micro bubbles that tend to form from the dissolved air as it expands also tend to adhere to (suspended) particulate matter as it coagulates in the water. The buoyancy of the micro bubbles also tends to cause this particulate matter to float to the surface of the water, where it also drains off to the foam sump tank 1044. Moreover, the ozone injected with the dissolved air tends to further enhance the likelihood that any (dissolved) particulate matter that resides in the oxidation chamber 1034 will be filtered out by one or more of the downstream subsystems. And, of course, the ozone in the oxidation chamber (and points downstream) also acts to deactivate biofilms and/or sterilize biological pathogens (such as bacteria and/or viruses).

With further regard to the ozone eductor 1042, it combines fluids from threes sources: water which is bled from the feed pump 1032, ozone from the ozone source 1052, and compressed air from compressed air source 1054. The compressed air can come from any source such as a compressed air tank, air compressor, etc. It is fed into the turbulence chamber 1040 which is configured to rapidly mix it with the water bled from the feed pump 1032. Note that the amount of air flowing into the turbulence chamber 1040 can be generally proportional to the flow of water through the primary oxidation subsystem 1010 as measured by MMF flow sensor 1070. In some embodiments, the amount of air is adjusted in proportion to the concentration of various species (which dissolved air flotation can treat for) detected in the incoming source water 1002. Thus, the amount of dissolved air injected into the source water 1002 removes these species and helps downstream equipment perform as desired. As a result, the water exiting the turbulence chamber 1040 can be partially or fully saturated with dissolved air. From the turbulence chamber 1040, the water/dissolved air mixture enters the ozone eductor 1042 under pressure from the feed pump 1032 (and compressed air source 1054). As it flows longitudinally through the throat of the venturi shaped ozone eductor 1042, the mixture creates a low pressure zone. That low throat pressure helps draw the ozone from ozone source 1052 into the water/dissolved air mixture. Thus, the ozone source 1052 can operate at or near atmospheric pressure thereby enabling relatively low cost production of ozone for such uses. Moreover, the turbulence inherent in the flow of the water/dissolved air mixture can rapidly mix the ozone into that mixture before the combined water, dissolved air, and ozone mixture enters the oxidation chamber 1034.

Furthermore, the combined mixture recovers much of its pressure as it exits the throat of the ozone eductor 1042. Thus, when the mixture enters the oxidation chamber 1034, it enters as a high velocity jet with the ozone and air thoroughly dispersed in the water. The jet of water mixes rapidly with the water in the oxidation chamber 1034 thereby bringing the dissolved air and ozone (micro bubbles) into intimate contact with the materials entrained in the water in the oxidation chamber 1034. One result is that organic matter in the resident water foams as noted previously. And, as also noted, that foam can be drawn off (along with any flocculated particulate matter therein) such that much of the entrained organic matter (and some particulate matter) in the resident water is mechanically separated there from and thence discharged from system 1000.

Systems 1000 of embodiments include provisions for managing foam that might form in oxidation chamber 1034. More specifically system 1000 includes foam recirculation pump 1046, anti-foam additive source 1047, and foam spray bars 1062 as part of foam recirculation loop 1049. Foam recirculation pump 1046 can draw foam (or its liquor) from the foam sump tank 1044. From there, system 1000 can route the foam liquor to a point where the anti-foam additive stored in the anti-foam additive source 1047 can be injected into the liquor. In some embodiments, the anti-foam additive is a surfactant such as petroleum naptha, light aromatic naptha, or 1,2,4-trimethylbenzene. If desired, the level of foam in the oxidation chamber 1034 as measured by foam level sensor 1033 can determine the rate at which the anti-foam additive is injected into the recirculating foam liquor. Thus, in scenarios in which the oxidation chamber 1034 happens to be generating more foam than desired, relatively large amounts of anti-foam additive can be injected into the recirculating foam to control (decrease) the amount of the same. Conversely, if the foam level falls below some threshold level, the system controller can cause less anti-foam additive to be injected into the system 1000.

From the anti-foam additive injection point, system 1000 can route the recirculating foam (with or without anti-foam additive mixed therein) to the foam spray bars 1062. In systems 1000 of some embodiments the foam spray bars 1062 stretch across the top of the oxidation chamber 1034 and are oriented to direct the spray of foam liquor issuing therefrom down and into the foam floating in the oxidation chamber 1034. Depending on the pressure developed by the foam recirculation pump 1046 and the rate at which anti-foam additive is being injected, the spray can aggressively attack the foam bubbles. Between the mechanical interaction of the spray droplets and the foam-collapsing effects of the anti-foam additive, the spray causes a fraction of the foam to collapse thereby forming foam liquor. That foam liquor drains down through the foam to the level of the water in the oxidation chamber 1034.

From there, the drain to the foam sump tank 1044 draws the foam liquor to that tank for further recirculation and/or discharge from the system 1000. Indeed, foam discharge valve 1058 can be controlled to open responsive to the level of foam liquor accumulated in foam sump tank 1044 as measured by sump level sensor 1045. The amount of organic and/or other foam-forming matter (and flocculated particulate matter) in system 1000 decreases accordingly with the same being directed to a point for disposal. If desired, the anti-foam additive added in the foam recirculation loop 1049 can be recovered from the discharged liquor if desired. In some embodiments and depending on the type of oil, system 1000 can remove about 90% or more of non-emulsified hydrocarbons at concentrations up to about 3% by weight. Thus, water resident in the bottom portion of the oxidation chamber 1034 (below the foam level and or those levels at which agitation might be occurring) can be relatively free from organic and or other foam-forming materials. For systems 1000 treating oil well flowback water the foregoing capabilities can remove much of the oil and even some of the particulate matter entrained in the flowback water even toward the end of the flowback period when such materials can be relatively concentrated.

As is further disclosed with reference to FIG. 13, a relatively large fraction of the source water 1002 (now relatively free of foam-forming materials and with a reduced or eliminated suspended particulate load) flows from the oxidation chamber 1034 to the dearation chamber 1038 of the contact tank 1036 rather than being recirculated or discharged via the foam sump tank 1044. It does so by way of a baffle and weir arrangement (see FIG. 13) of the contact tank 1036. The set of baffles is arranged such that it forms a passageway from the oxidation chamber 1034 to the weir that begins below the level of both the inlet to the oxidation chamber 1034 from the source pump 1030 and the inlets from the ozone eductors 1042. Thus, most if not all of the foam-creating agitation in the oxidation chamber 1034 tends to occur above the opening to this passageway. Accordingly, water from the oxidation chamber 1034 that does flow into it is usually and largely free of suspended particulate matter and/or foam and/or foam-causing materials. In this way, the water flowing into the dearation chamber 1038 is somewhat more treated than the source water 1002 entering the system 1000.

As the partially treated water flows over and/or through the weir the relatively mild agitation caused thereby allows some dissolved air, ozone, and/or other gases to escape solution from the water. Additionally, the dearation chamber 1038 can be sized and shaped to allow the water resident therein some stilling or settling time before it is drawn into the outlet leading to the feed pump 1032. The stilling time allows more gases to escape from solution thereby further dearating the water in the dearation chamber 1038. A vent is provided from the dearation chamber 1038 such that the dissolved air and/or ozone injected into the system 1000 via the ozone eductors 1042 does not pressurize the contact tank 1036 and/or the system 1000. System 1000 can route such gases to the ozone destruct unit 1021 for destruction of the ozone or to some other point at which the ozone and/or other gases therein can be disposed of in a controlled manner.

Thus, partially treated water flows from the dearation chamber 1038 under the action of the feed pump 1032. The feed pump 1032 can be driven at a speed determined by the level of water in the dearation chamber 1038 as measured by dearation chamber level sensor 1071 so that water tends to flow from the primary oxidation subsystem 1010 at a rate approximately equal to its inflow from the source pump 1030 less the amount of foam liquor discharged via sump discharge valve 1058. Of course, some of the water discharged from the feed pump 1032 is recirculated via the ozone eductor 1042 as is further disclosed elsewhere herein.

A water quality sample point can be positioned downstream from the feed pump 1032 (and the branch to the ozone eductors 1042) for determination of the quality of the water at the exit of the primary oxidation subsystem 1010. The analysis of samples drawn from the oxidation subsystem exit sample point 1064 can include analysis for the particulate level therein, turbidity, its TOC, etc. Thus, the controller can determine the extent to which the primary oxidation subsystem 1010 has clarified the source water 1002. In addition, or in the alternative, the controller can sense the degree to which the partially treated water contains organic and/or other carbon-based compounds. If the partially treated water exiting the primary oxidation subsystem 1010 passes user selected criteria for it and/or is sufficiently free of organic materials, the controller can allow the water to pass to the MMF subsystem 1012. In addition, or in the alternative, some or all of this partially treated water can be drawn from the system if users desire to use water of its quality. In other words, the term “partially treated water” as used herein refers to water at points in the system 1000 downstream of the inlet to the screen filter 1035 and, therefore, can be context specific herein.

If the partially treated water exiting the primary oxidation subsystem 1010 does not meet the quality-related criteria, the controller can position the MMF bypass valve 1066 and/or MMF recirculation valve 1075 to direct the water exiting the primary oxidation subsystem 1010 back to the inlet of the primary oxidation subsystem 1010 via recirculation path 1060 for further treatment thereby. During system 1000 startup (and/or during upsets) it might be the case that the water at the oxidation subsystem exit sample point 1064 might not meet certain criteria for entry into the MMF subsystem 1012. Thus, during system 1000 startup (and/or upsets) it can be expected that the water might be directed to the recirculation path 1060 for (further) treatment until it reaches or exceeds those criteria. This control approach coupled with the presence of (the screen filter 1035 and) the primary oxidation subsystem 1010 upstream of the MMF subsystem 1012, protects the mixed media filters of the MMF subsystem 1012 from becoming fouled with organic materials and/or suspended particulate matter in the source water 1002. At some point though, in most scenarios, the water quality will reach or exceed those criteria and the controller will direct the partially treated water into the MMF subsystem 1012.

MMF subsystem 1012 of the current embodiment comprises three similar MMF filters 1068 connected (mechanically) in parallel. Together, they can remove much of the particulate matter entrained in oil well flowback water as well as other source waters 1002. Depending on the positioning of the MMF backwash valves 1072, the water will flow through the MMF filters 1068. As noted elsewhere herein, those filters comprise beds of anthracite, sand, garnet, and/or the like in various beds. Generally, the beds of such media which are nearest the upstream side of the MMF subsystem 1012 capture coarser particulate matter than those toward the downstream side of the MMF subsystem 1012 such that none of the beds are ordinarily subjected to particulate matter of a size much larger than that which it is selected to filter. Moreover, in the current embodiment, the various beds of the MMF filters 1068 filter out increasingly fine particulate matter as the water flows through them thereby increasing the service time of the MMF filters 1068 between cleanings and/or back washings. As another result, water passing the MMF exit sample point 1076 will usually be free from suspended particulate matter (as well as organic material removed by the primary oxidation subsystem 1010). If not, and responsive to the MMF exit samples, the controller can position MMF recirculation valve 1075 to direct that water through recirculation path 1060 for further treatment by the primary oxidation subsystem 1011 and/or the MMF subsystem 1012.

Note that the MMF exit sample point 1076 can be positioned to allow detection of how well MMF subsystem 1012 (and primary oxidation subsystem 1010) is performing. In addition, or in the alternative, the MMF exit sample point 1076 can allow the common analysis cabinet to sense the oxygen reduction potential of the partially treated water. The controller can therefore determine whether (and to what extent) residual ozone from the primary oxidation subsystem 1010 might remain in the water. If the residual ozone happens to be higher than some threshold, the controller can adjust the amount of ozone being injected into the system 1000 via the ozone eductors 1042.

It might be the case due to an upset (or perhaps at system 1000 startup) that too much suspended particulate matter reaches the MMF filters 1068. In such cases, the controller can detect this occurrence through an increase in the differential pressure across the MMF filters 1068 and position the MMF backwash valves 1072 for backwashing. More specifically, the controller can position the MMF backwash valves 1072 to allow backwash water into the downstream side of one of the three MMF filters 1068A at a time and to direct the backwashed water (and material entrained therein) out of the upstream side of that filter 1068As and to the backwash recycle path 1008. In some scenarios, the controller configures the MMF backwash valves 1072 such that two of the MMF filters 1068B and C (for instance) provide backwash water for the other MMF filter 1068A. In other words, the inlet MMF backwash valves 1072 for the two MMF filters 1068B and C are positioned to accept water from the feed pump 1032 and to filter it through their respective mixed media beds. The filtered water then flows out of their corresponding outlet MMF backwash valves 1072 and then through the outlet MMF backwash valve 1072 of the filter to be backwashed. The filtrate from these two MMF filters 1068B and C then flows backwards (upstream) through the third MMF filter 1068A releasing and washing away any debris and/or particulate matter loading the mixed media beds of the third MMF filter 1068A. Note that because (in the direction of flow of the filtrate in such scenarios) the porosity of the beds increases as the filtrate flows through the MMF filter 1068A, any material released from one bed of a filter will largely flow through the remaining beds and out to the backwash recycle path 1008.

In some scenarios, backwashing the MMF filter 1068 might not free the filter of the load of particulate matter captured thereby. Instead, a stepped backwashing operation might be desired. For instance, if particulate matter (and or debris) has accumulated on the MMF filter 1068, the controller can modulate the backwashing of an MMF filter 1068 in manners such as the following. Prior to positioning the MMF backwash valves 1072 for backwashing operations, the controller places MMF backwash flow control valve (FCV) 1077 in a relatively low flow rate position. It then positions the MMF backwash valves 1072 in their backwashing positions and allows a low flow of filtrate to backwash the MMF filter 1068. The low flow rate, as determined by MMF backwash FCV 1077, partially fluidizes the bed(s) of the MMF filter 1068. The controller can then pulse compressed air through MMF air supply valves 1074 to further fluidize the bed and to dislodge debris and/or particulate matter from within the beds thereof. Moreover, in some embodiments, the MMF filter(s) 1068 can be arranged with the beds of the finest porosity near the bottom of the MMF filter 1068. The MMF air supply valves 1074 can also be positioned at or near the bottom of the MMF filter 1068. Thus, the bubbles forming from the compressed air in the MMF filter 1068 will tend to carry the captured particulate matter up through the MMF filter 1068.

At some point, the controller can close the MMF air supply valve 1074 and further open the MMF backwash FCV 1077 thereby stepping up the backwash flow rate through the MMF filter 1068. The increased filtrate flow rate can be selected such that it will likely wash the released particulate matter to the backwash recycle path 1008. Thus, even if an upset delivers a heavy concentration of particulate matter to the MMF subsystem 1012, the controller can restore the system 1000 to nominal operations in most scenarios without user intervention.

At some point, samples drawn from the MMF exit sample point 1076 might indicate that the water quality of the MMF filtrate is adequate for further treatment by downstream subsystems such as the UF subsystem 1016. Or, it could be the case that the water entering the MMF subsystem 112 is already of sufficient quality (being largely free of organic materials and/or suspended particulate matter) as to be treatable by the MMF subsystem 1012 and/or other downstream subsystems. In such situations, the controller could bypass the water around the MMF subsystem 1012 by positioning MMF bypass valve 1066 and MMF recirculation valve 1075 to allow that bypass. However, depending on user desires, that is not usually how systems 1000 of the current embodiment operate. Instead, the water usually flows through MMF subsystem 1012 and thence to the UF subsystem 1016 for further treatment.

In the UF subsystem 1016 the water is passed through one or more UF membranes such that particulate matter down to about 0.5 microns is removed from the water. This capability of the UF subsystem allows systems 1000 to remove the majority of any remaining particulate matter in the partially treated water, and more specifically, when oil well flowback source water 1002 is being treated. No matter the source of the source water 1002, the UF subsystem 1016 illustrated by FIG. 10 happens to include two independent and parallel UF filters 1080 although more or less filters could be add to the subsystem and/or some of them could be arranged in series if desired. In the current embodiment, though, one of the UF filters 1080 can remain in service while the other one is backwashed and/or cleaned such that system 1000 can remain operational even while such activities are occurring. When either UF filter 1080 is operating, if samples drawn from the MMF exit sample point 1076 indicate that the quality of water exiting the MMF subsystem 1012 is adequate for treatment by the UF subsystem 1016, then the UF valves 1082 can be positioned to pass the water through one or both UF filters 1080.

The UF exit sample point 1084 can allow samples to be taken for analysis by sensors of the common analysis cabinet which include particulate and/or turbidity sensors. Thus, the system 1000 controller can verify the performance of the UF subsystem 1016. If for some reason (such as during system 1000 startups and/or upsets) samples drawn from the UF exit sample point 1084 indicate that more than some threshold amount of dissolved compounds are escaping from the UF subsystem 1016, then the controller can position the UF recirculation valve 1086 to direct the water to the recirculation path 1060. The water from the UF subsystem 1016 can then, in some scenarios, return to the inlet of the primary oxidation subsystem 1010 for further treatment therein (and/or in subsequent systems) to remove the material causing it to not meet its corresponding threshold(s).

With continuing reference to FIG. 10, system 1000 of the current embodiment includes no bypass path around the UF subsystem 1016. Thus, the water being treated must flow through the UF subsystem 1016 to reach the GAC subsystem 1018, the HP membrane subsystem 1020, and/or other treatment subsystems downstream from the UF subsystem 1016. In this way, few if any dissolved compounds are likely to reach such treatment subsystems other than ones that those treatment subsystems can adequately cope with and/or remove. Systems 1000 of some embodiments, though, provide bypass paths around the UF subsystems 1016.

Moreover, UF subsystems 1016 can be backwashed in some embodiments. For instance, system 1000 can include a backwash path from the GAC subsystem 1018 to route GAC filtrate to the UF filters 1080 for this purpose among others. When it is desired to backwash one (or both) UF filters 1080, the controller can position the UF backwash valves 1088 to route the GAC filtrate to one or the other (or both) of the UF filters 1080. Note that, depending on the configuration of the UF filters 1080, it might be desirable to route that filtrate to differing points (for instance both ends thereof) on the UF filters 1080 to facilitate release of the material that might be loading, fouling, or degrading these filters. In any case, the backwash water from the UF filters 1080 can be routed through various UF backwash valves 1088 to the backwash recycle path 1008 for disposal.

When samples drawn from the UF exit sample point 1084 indicate that the partially treated water at that point is of adequate quality for treatment by the GAC subsystem 1018, the controller can position the UF recirculation valve 1086 to direct the water from the UF subsystem 1018 accordingly. Within the GAC subsystem 1018 of the current embodiment, the partially treated water is further treated to remove any remaining organic compounds and, more specifically, VOCs and semi-volatile organic compounds. Thus, many pesticides, solvents, lubricants, etc. still retained in the partially treated water can be absorbed by the granular activated carbon thereby polishing the water if no (or little) salt is present or if the presence of salt therein is allowed. In other words, for scenarios in which treated brine 1005 is adequate for the uses for which users desire product water, the GAC subsystem 1018 provides a polishing treatment to the water (or rather the brine). Thus, if samples drawn from the GAC exit sample point 1092 indicate water quality consistent with proper GAC subsystem 1018 performance, then the controller can position GAC recirculation valve 1096 to direct the water downstream to other treatment subsystems in system 1000. Of course, the sensors used to analyze samples drawn from the GAC exit sample point 1092 can include one or more a spectrometer, a TOC sensor, and/or a sensor based on ultraviolet (UV) absorption, or combinations thereof.

In some situations (such as during system 1000 startups and/or upsets) the partially treated water at the exit of the GAC subsystem 1018 might not be suitable for use as either treated brine 1005 and/or for treatment by the HP membrane subsystem 1020. For instance, the TOC detected therein might be above some threshold. Responsive to samples drawn from the GAC exit sample point 1092, therefore, the controller can divert that water to the recirculation path 1060 via positioning the GAC recirculation valve 1096. Accordingly, the GAC filtrate can be returned to earlier treatment subsystems for removal of the material causing such a condition(s). Note also that systems 1000 of the current embodiment do not include bypass paths around the GAC subsystems 1018 although they could. Thus, in the current embodiment, water (or brine) downstream of the GAC subsystem 1018 will likely contain no or little organic material thereby ordinarily making it compatible with the membranes in the HP membrane subsystem 1020 as well as suitable for many uses as treated brine 1005.

Of course, there might be scenarios (upsets for instance) in which the GAC filters 1090 might become fouled or loaded with some species that might degrade their performance. For such situations and/or perhaps others, systems 1000 of the current embodiment provide for backwashing the GAC filters 1090. More specifically, when conditions warrant backwashing and/or at other times, the controller can position GAC backwash valves 1094 to direct backwash water through the GAC filters 1090 (one at a time or in parallel). In either case, the back wash water flows through the granular carbon thereby causing the release of materials previously absorbed therein. The resulting backwash water is then routed through the GAC backwash valves 1094 to the backwash recycle path 1008 for disposal.

With ongoing reference to FIG. 10, as noted elsewhere herein, some uses allow for treated brine 1005 rather than treated water 1004. Accordingly, systems 1000 of the current embodiment include provisions to output the brine from GAC subsystem 1018 as a product water. More specifically, if desired, the controller can position HP membrane bypass valve 1098 to direct this brine to the secondary oxidation manifold 1026 for another oxidation treatment (if desired) before it is output as treated brine 1005. Accordingly, upstream from the secondary oxidation manifold 1026 is an ozone eductor 1015. It draws ozone (or another oxidizer) in from oxidizer source 1017. Because of the low pressure created in ozone eductor 1015 the oxidizer source can operate more or less at atmospheric pressure. This allows for conventional ozone generators to be used and lessens the cost of producing the ozone over what it might be otherwise. The secondary oxidizer manifold 1026 is situated downstream from the ozone eductor 1015 and has a geometry sufficient to mix the ozone from the oxidizer source 1017 with the brine flowing there through as illustrated by FIG. 10. Note that a bypass path around the secondary oxidizer manifold 1026 can be provided in systems 1000 of some embodiments such that the brine need not receive this secondary oxidation treatment.

However, to prevent unreacted ozone from exiting the system 1000, system 1000 can also route the brine (with/without ozone therein) through ozone separator 1019. Ozone separator 1019 can be any type of device capable of allow ozone dissolved in the brine to come out of solution. For instance, ozone separator 1019 could be a cyclonic device, a spray-based device, etc. without departing from the scope of the disclosure. As illustrated, though, system 1000 routes the ozone from the ozone separator 1019 to the ozone destruct unit 1021 so that it can be disposed of in a controlled manner. FIG. 10 also illustrates that systems 1000 of the current embodiment route the ozone-free or nearly ozone-free but now-sterilized brine from the ozone separator 1019 to a point from which users can access it as desired.

Returning to the exit from the GAC subsystem 1018, system 1000 can also route the brine from the GAC subsystem 1018 to the service tank 1028. The amount of brine flowing into the service tank 1028 can be controlled by a FCV such that system 1000 will fill the service tank 1028 without overflowing it. The controls associated with that FCV can also provide that it remain closed (or partially closed) when other demands (for instance, user demands and/or demands from the HP membrane subsystem 1020) call for brine from the GAC subsystem 1018. Moreover, as is disclosed further herein, the brine that does make it into the service tank 1028 can be used to backwash various portions of system 1000.

In some scenarios it might be the case that users wish that the brine from the GAC subsystem 1018 be treated further. For instance, some uses call for salt-free water (or water with some maximum level of salinity) for which the brine from the GAC subsystem 1018 might or might not be suitable. For such scenarios, and/or other reasons, systems 1000 of embodiments make provisions to treat the brine with high pressure membranes 1053 such as those in the HP membrane subsystem 1020.

More specifically, when it is desired to remove salinity or certain other dissolved compounds from the brine that have not already been removed by upstream subsystems, the controller can position the HP membrane bypass valve 1098 to direct the brine to the HP membrane subsystem 1020. However, residual ozone (from the primary oxidation subsystem) that might still be dissolved in the brine could have some deleterious effects on certain types of HP membranes 1053. Systems 1000 of some embodiments therefore include a source of sodium bisulfite (SBS) positioned upstream of the HP membrane subsystem 1020. In such systems 1000 the controller can determine whether residual ozone remains in the brine at the GAC exit sample point 1092. If the concentration of residual ozone is above some threshold the controller can activate SBS source 1027 to inject SBS at a rate proportional the amount of ozone sensed in the brine. Of course, the common analysis cabinet can analyze such samples for other parameters related to the quality of the brine. In that way, and perhaps others, the HP membrane filters 1053 can be protected from exposure to ozone as well as exposure to other materials that the upstream subsystems normally remove from the source water 1002.

As FIG. 10 also illustrates, systems 1000 of embodiments include a cartridge filter 1029 positioned between the GAC subsystem 1018 and the HP membrane subsystem 1020. One function that it can perform is to capture carbon fines that might escape from the GAC filters 1090. While not essential to the practice of the current disclosure, the cartridge filter 1029 of the current embodiment does, therefore, help protect the high pressure membranes.

Furthermore, FIG. 10 illustrates that the HP membrane subsystem 1020 of embodiments includes damping tank 1039 at or near its inlet. Of course, the damping tank 1039 could be positioned anywhere between the feed pump 1032 and the booster pumps 1057 and/or 1059 of the HP membrane subsystem 1020. More particularly, many embodiments position the damping tank 1039 downstream of the HP membrane bypass valve 1098 and upstream of the booster pumps 1057 and 1059. One purpose that it can serve is to de-couple the flow rates developed by the feed pump 1032 and one or both of the booster pumps 1057 and 1059. Another purpose that it can serve is to absorb, damp, or otherwise reduce or eliminate hydraulic shocks that might develop in locations in the system 1000 between the feed pump 1032 and the booster pumps 1057 and/or 1057. In the current embodiment, the damping tank 1039 communicates with a compressed air source 1043 and, perhaps, a vent in some embodiments. It also includes a damping tank level sensor 1041. Additionally, damping tank 1039 can be designed to hold an internal pressure at least as high as the maximum pressure that can be developed by the feed pump 1032 and, perhaps, several times that amount.

With regard to absorbing hydraulic shocks, those skilled in the art will appreciate that dearated water (or brine) happens to be relatively incompressible. Accordingly, a sudden closing (or even opening) of a valve in system 1000 (or at least those portions wherein dearated fluid is present) can cause a shock to travel from the valve up and/or downstream from the valve. Colloquially such shocks are often referred to as “water hammers.” Water hammers, of course, can have a deleterious effect on various components. More specifically, as a hydraulic shock travels through a filter (such as the GAC filters 1090, UF filters 1080, MMF filters 1068, etc., that shock momentarily reverses the flow of water as it passes. This momentary backflow can dislodge particulate matter (and/or debris if present) that the filters had previously and effectively captured from the water in the system 1000. Thus, the momentary backflow can release this captured material thereby re-introducing it into the partially treated water. While not wishing to be held to this theory, it is speculated that one reason that HP membranes (and more specifically reverse osmosis (RO) membranes often fail in the field is that their operation (and the operation of other equipment in systems where they are found) allows such hydraulic shock-related releases. This in turn leads to fouling of these membranes and overall poor, unreliable performance of such heretofore available systems.

Damping tanks 1039 of embodiments though mitigate these hydraulic shocks. They are operated to maintain a volume of trapped air over the water therein. Should a hydraulic shock occur in system 1000 it will encounter the damping tank 1039 and travel into the water therein. However, the compressed air will allow the relatively incompressible water in the tank to compress the air further rather than reflecting the hydraulic shock back into the system 1000. Accordingly, damping tank 1039 at least damps these hydraulic shocks and therefore (it is believed) reduces or eliminates shock-related releases from the filters of systems 1000 of the current embodiment.

Damping tank 1039 also absorbs temporary mismatches between the flow rates developed by the feed pump 1032 and the booster pumps 1057 and/or 1059. In this regard, those skilled in the art will appreciate that two or more pumps operating in series with one another will likely have some mismatch between the flow rates they develop. Eventually, at steady-state or during slow changing conditions, the system 1000 controller can balance these flow rates by sensing the same and adjusting the speeds of the pumps to cause the flow rates to match. But, some shorter term imbalances might occur nonetheless. In which case, if one of the booster pumps 1057 or 1059 or both happen to be drawing more brine than the feed pump 1032 is delivering (through the various intervening components), then that booster pump 1057 and/or 1059 will begin to draw brine from the damping tank 1039. The level of the water therein as sensed by damping tank level sensor 1041 will fall and the controller can either slow down the booster pump 1057 and/or 1059 or speed up the feed pump 1032 (or a combination thereof). Thus, the flow mismatch should drop and, if desired, such corrective action can persist until the level in the damping tank 1039 is restored to some nominal level.

If, on the other hand, the booster pump 1057 or 1059 (or both) happens to be drawing less brine than the feed pump 1032 is delivering, the level in the damping tank 1039 will rise. Upon sensing this, the controller can speed up the booster pump 1057 and/or 1059, slow down the feed pump 1032, or a combination thereof. As a result, the flow rates of the pumps will come back into balance perhaps after the level of brine in the damping tank 1039 is restored to some nominal level. In addition, or in the alternative, the controller can vary the pressure in the damping tank 1039 via the compressed air source 1043 and/or vent (not shown) to force water into/out of the damping tank 1039 to balance the flow rates of the pumps 1032 and 1057 and/or 1059 for short periods of time. Thus, both mechanically (hydraulically) and water quality-wise, the brine flowing from the GAC subsystem 1018 should, in most scenarios, be acceptable for treatment by the HP membrane subsystem 1020.

Nonetheless, system 1000 can be configured such that when conditions call for the use of the HP membrane subsystem 1020 it can be brought online slowly. For instance, HP membrane bypass valve 1098 can be a slow acting valve. Systems 1000 of some embodiments therefore use gate valves for these valves. In addition, or in the alternative, the booster pumps 1057 and 1059 can be driven by variable frequency drives and started/stopped with ramped speed profiles. Furthermore, during either starting up or stopping the HP membrane subsystem 1020, brine from the GAC subsystem 1018 can be recirculated through the GAC subsystem 1018 and the earlier subsystems via the recirculation path 1060. In this manner, the brine at the exit of the GAC subsystem 1018 will likely not be deadheaded (or otherwise create hydraulic shocks) which could lead to the release of particulate matter from earlier subsystems.

Moreover, system 1000 can include an HP membrane inlet sample point 1051 for determining the quality of the incoming brine. Furthermore, that sample point can allow the controller to sense the salinity of the incoming brine and, responsive thereto, direct the operation of the HP membrane subsystem 1020. As noted elsewhere herein, the HP membrane subsystem 1020 of embodiments includes two booster pumps 1057 and 1059 and three (banks of) HP membrane filters 1053. In the current embodiment, the banks of high pressure membrane filters 1053 happen to all be RO membrane filters. However, it could be the case that the membranes be nanofiltration (NF) membranes or a combination of RO and NF membranes. Given the sensed salinity of the incoming brine (and various user selected criteria for whether the permeate water from the HP membrane filters 1053 and/or the rejected brine from the same is usable), the controller can position the HP membrane valves 1055 so that the HP membrane subsystem 1020 produces various streams of product waters of varying salinity from low salinity product water to high salinity product water (brine).

HP membrane subsystem 1020 of the current embodiment can operate in stages as further disclosed herein. For instance, the stage 1 HP membrane filter 1053A can be used to produce permeate with salinity somewhat greater than the permeate from the other HP membrane filters 1053B and C (when each filter is operated independently of each other). The stage 2, HP membrane filter 1053B can be used to produce a permeate with an intermediate salinity as compared to the permeate of the other two HP membrane filters 1053A and C. Meanwhile, the stage 3, HP membrane filter 1053C can be used to produce permeate with the least salinity. Moreover, the HP membrane filter 1053 stages need not be operated independently from one another. Indeed, when used in conjunction with one another, the various HP membrane filter 1053 stages can expand the range of incoming brine that can be treated by the HP membrane subsystem 1020. For instance, in various scenarios, Stage 1 can be used first to remove approximately 10-20% of the salinity from relatively concentrated incoming brine. Stage 2 can use the resulting less saline permeate to produce much less concentrated saline product water than stage 1 could produce if used alone. Indeed, the permeate could have a saline concentration as low as 30% of the incoming brine concentration if desired. Furthermore, by dividing the loading of the two HP membrane filters 1053A and B in such manners, the achievable throughput of the HP membrane subsystem 1020 can be increased elative to that when HP membrane filter 1053A is used by itself.

Of course, the permeate from HP membrane filter 1053B can also be sampled at the HP membrane stage 2 exit sample point 1063. And, if conditions indicate that further processing might be desirable, the controller can route the permeate to the recirculation path 1060 for further processing. In scenarios wherein the permeate has adequate quality at that point, the permeate can be directed to the UV irradiation chamber 1022 for disinfection with UV radiation with the primary booster pump 1057 providing the pressure to drive the permeate through the two HP membrane filters 1053A and B. From there the permeate, or rather treated water 1004 can be directed to various points of use as FIG. 10 illustrates. Meanwhile, in these scenarios, the controller can direct the reject (relatively concentrated brine) to a point for disposal.

In other scenarios, HP membrane filters 1053B and C (stage 2 and 3) can be used in tandem to produce more product water with low saline content than stage 3 would be capable of producing if used alone. More specifically, stage 2 (HP membrane filter 1053B) can process some or all of the brine first followed by processing of some or all of the permeate by stage 3 (HP membrane filter 1053C). In one scenario, this two stage processing occurs as users might desire. In other scenarios, though, the controller can direct the permeate from HP membrane filter 1053B responsive to its quality as sensed at HP membrane stage 2 exit sample point 1063. In either scenario, the primary booster pump 1057 provides the pressure to drive the permeate through the membranes in HP membrane filter 1053B. The secondary booster pump 1059 can be used to provide the pressure to drive that permeate through the membranes of HP membrane filter 1053C. Moreover, in such scenarios, the controller can direct the permeate from stage 3 (HP membrane filter 1053C) to the UV irradiation chamber 1022 and then on to various points of use. The reject from either or both HP membrane filters 1053B and/or C can be passed through the secondary oxidation manifold 1026 and thence to various points of use or it can be routed to some point for disposal.

In other scenarios, where throughput might not be that much of a concern but low salinity is desired, RO stage 3 can be used by itself. For instance, system 1000 can be operated using only stage 3 (HP membrane filter 1053C). In such scenarios, the controller (responsive to the salinity being measured via HP membrane inlet sample point 1051) directs the brine to HP membrane filter 1053C and drives secondary booster pump 1059 to develop the pressure for doing so. In such cases, the permeate from the HP membrane filter 1053C can be directed to the UV irradiation chamber 1022 and thence to the CIP tank 1024 (for storage and/or subsequent use) and/or to various points of use as illustrated by FIG. 10. Brine (or the reject) from HP membrane filter 1053C can be directed to the secondary oxidation manifold 1026 for sterilization (and subsequent use) or it can be directed to some point where it can be disposed of. In the alternative, or in addition some of the reject (whether from HP membrane filters 1053 A, B, and/or C) can be directed to the backwash recycle path 1008 for further processing should its quality as measured at reject sample point 1067 indicates that further processing might recover some type of usable product water therefrom. To direct the reject accordingly, the controller can position reject backwash recycle valve 1069 to do so. Note also that the backwash, rinse, cleaning, etc. water in the CIP tank (as with other backwash water) can be recycled to the source water 1002 inlet to reprocess it. This feature of system 1000 of embodiments allows system 1000 to recapture as much water as is desired from the source water 1002.

While several illustrative scenarios for uses of the HP membrane subsystem 1020 are disclosed herein, these scenarios are not limiting. Indeed, the HP membrane subsystem 1020 can be operated in a number of other manners. For instance, all HP membrane filters 1053 could be operated in parallel or all three could be aligned in series (with appropriate valves, check valves, pumps, interconnecting piping, etc. if desired). Moreover, while the permeate from each of the HP membrane filters 1053 can be considered as product waters, the brine (or reject) thereof can also be considered product waters if users desire brine with the corresponding qualities.

Note also that regardless of the configuration of the HP stages, each permeate source of the current embodiment has associated therewith an exit sample point 1061, 1063, and 1065 respectively. Moreover, HP subsystem stage 3 exit sample point 1065 happens to be positioned such that all permeate produced by the HP membrane subsystem 1020 of the current embodiment passes through/by it. Accordingly, the controller can determine the quality of the permeate from any of the HP membrane filters 1053 via this sample point if desired. Thus, should the permeate being produced deviant from some desired quality threshold by more than a selected amount, the controller can recirculate the permeate back to the primary oxidation subsystem 1010 (and other upstream subsystems) for further processing. To do so, the controller can position HP membrane permeate recirculation valve 1095 such that the permeate from the HP membrane subsystem 1020 is directed to recirculation path 1060. Otherwise, HP membrane subsystem recirculation valve 1095 can be in a position wherein it directs the permeate to the UV irradiation chamber 1022 and thence to the CIP tank 1024 and/or various points of use.

Still with reference to FIG. 10, systems 1000 of the current embodiment also comprise several other aspects and more specifically aspects related to automatically servicing system 1000. As disclosed elsewhere herein it might become desirable at some point to backwash various components of system 1000. Notably, FIG. 10 illustrates that the UF subsystem 1016 and the GAC subsystem 1018 of the current embodiment can have backwash water (or brine) routed to them. Further, as is disclosed elsewhere herein, backwash water/brine can be routed to the primary oxidation subsystem 1010. Moreover, in some embodiments, the MMF subsystem 1012 could have backwash water routed to it. Though in the current embodiment that is not the case. Instead, MMF subsystem 1012 creates its own backwash water in the current embodiment.

One component that enables backwashing such subsystems and/or their components is service tank 1028. It receives the backwash water (or brine) from the GAC subsystem 1018 via HP membrane bypass valve 1098 and an FCV that allows the controller to control the filling of the service tank 1028 while potentially meeting demands for brine elsewhere. Thus, the service tank 1028 could be full much of the time and awaiting some condition that might indicate the desirability of backwashing one or more components in system 1000. For instance, the controller might sense that the differential pressure across one or more of the UF filters 1080 or across one or more of the GAC filters 1090 has increased beyond a threshold indicative of a particular loading of these filters. The controller might also monitor flow rates through such components and or monitor the water quality downstream of such components to determine that some condition (for instance, an upset) might call for a backwash operation.

Accordingly, at such times or as desired, the controller can use service/CIP selection valve 1079 to select the service tank 1028 as the source of service water for the operation of interest. It could also start service pump 1081 to begin the flow of service water to the component(s) for which backwashing is indicated. In addition, the controller could position which ever valves (for instance, service/CIP selection valve 1087, UF backwash valves 1088, GAC backwash valves 1094, and/or other valves associated with such subsystems) would direct the backwash water through these components and then to the backwash recycle path 1008. Note that the service/CIP selection valve 1079 could be positioned to allow brine from GAC subsystem 1018 to flow directly to such components via HP membrane bypass valve 1098. Regardless of the source of backwash water, the controller could allow that flow to continue for a selected time, until a selected quantity of backwash water is used, until grab samples (or samples drawn from appropriate sample points) indicate that the backwash operation is complete. The controller could then reposition the affected valves and/or turn off the service water pump 1081 to complete the backwash operation. Of course, the effected components could be automatically returned to service by the controller as might be desired.

In the alternative, or in addition, certain conditions (or user desires) might indicate that it could be beneficial to clean-in-place (CIP) certain components in system 1000. For instance, in some scenarios, it might be desirable to do so with treated water 1004 as opposed to brine. Further, it could be the case that certain additives could aid in such CIP operations. Indeed, some fouling conditions of certain filters, membranes, etc. could be aided by adjusting the pH of the CIP water (or brine) with an acid, caustic, or other pH altering additive. In addition, or in the alternative, certain fouling conditions can be aided by the addition of an oxidizer such as ozone, hypochlorite, etc. to the cleaning water. Thus, the service provisions of systems 1000 of the current embodiment include a CIP additive chemical injection point 1083 in the backwash/CIP line from the service water and/or CIP tanks 1028 and/or 1024. Note that in the current embodiment, system 1000 uses hypochlorite as the CIP oxidizer. Although, if convenient, ozone source 1052 (disclosed with reference to the primary oxidation subsystem 1010) could be the source of oxidizer for the CIP and/or backwash water. No matter the source of the CIP oxidizer, the CIP/backwash line could include a backwash/CIP sample point 1099 such that the controller can sense the makeup of the CIP/backwash water and adjust it accordingly via the CIP chemical injection point 1083.

One scenario for which CIP operations might be called for is a periodic servicing of the primary oxidation subsystem 1010. As a potential entry point for source water 1002, it might be the case that primary oxidation subsystem 1010 or some of its components (for instance, source pump 1030, FCV 1011, oxidation chamber 1034, certain foam recirculation components, etc.) might become fouled with oily material, bio slime, etc. from time-to-time. Or it could be the case that some users desire to clean such components at certain times (for instance, before/at system startup at a new site, for a new use/application, etc.). In such scenarios, the controller could select the CIP tank 1024 as the source of the service water (here treated water 1004) using service/CIP selection valve 1079 and start the service pump 1081. Again other valves could be positioned to direct the service water (along with its additives if any) to the primary oxidation subsystem 1010 and, more specifically, to a point upstream of the source pump 1030. Such routing would allow the service water to circulate through the primary oxidation subsystem 1010 and/or its component parts cleaning the same as it circulates. Additionally, the feed pump 1032 could be left on with flow paths open through out system 1000 (as desired) allowing the service water to flow through and clean various downstream components as well. System 1000 could then be drained of the service water thereby leaving a clean system 1000 ready for new (or resumed) operations.

About when it is desired for operations to begin, system 1000 could then be filled with water. For instance, source pump 1030 could be turned on to pump source water 1002 into the primary oxidation subsystem 1010. However, it might be the case that some users might want to start with system 1000 filled with treated water 1004. In other scenarios, service tank 1028 could be used to fill up the system 100 (up to and including the GAC subsystem 1018) with treated brine 1005. In addition, or in the alternative, CIP tank 1024 could be used to fill the HP membrane subsystem 1020 and/or points downstream with treated water 1004. Or, it might be the case that a user might want to fill the system 1000 with commercially available (and/or “municipal”) water 1003. Accordingly, system 1000 could include a water side car 1001 in which commercially available water 1003 could be stored. Pump 1091 could then be turned on and used to fill the system 1000 with the commercially available water 1003. However the system 1000 is filled, the source pump 1030 could then be turned on and (if driven by a variable speed motor) ramped into operation to begin pumping source water 1002 into system 1000.

At some point, primary oxidation subsystem 1010 could begin recirculating the source water 1002 (and that water which was used to fill the system 1000) until sampling at oxidation exit sample point 1064 indicates that the (partially treated) source water 1002 is of adequate quality such that it can be admitted to MMF subsystem 1012. Then, the partially treated water could be recirculated through the primary oxidation and MMF subsystems 1010 and 1012 respectively until sampling at MMF exit sample point 1076 indicates that the partially treated water is of adequate quality for admission to the UF subsystem 1016 (and thence recirculated). Once sampling at the UF exit sample point 1084 indicates that the partially treated water is of adequate quality for treatment by the GAC subsystem 1018, it could be admitted thereto and recirculated until of adequate quality for either 1) use with or without further sterilization, 2) storage in service tank 1028, or 3) admission to the HP membrane subsystem 1020 for further processing.

As disclosed elsewhere herein, if treatment by HP membrane subsystem 1020 is desired, then HP subsystem 1020 can be ramped into operation while the partially treated water recirculates through some or all of the upstream components. The HP membrane subsystem 1020 stages (HP membrane filters 1053) can then be configured to operate in accordance with the salinity of the incoming brine and/or the throughput desired by the user(s). The permeate and/or reject from the HP membrane subsystem 1020 could then be directed to various points of use and/or the CIP tank 1024 as desired. Thus, system 1000 can operate to produce various product waters including treated brine 1005, treated water 1004 (of various salinity levels) and/or intermediate product waters drawn from various points in system 1000 as desired. Thus, FIG. 10 illustrates systems 1000 of various embodiments and, more specifically, systems 1000 configured to automatically treat oil well flowback water with time-varying water quality.

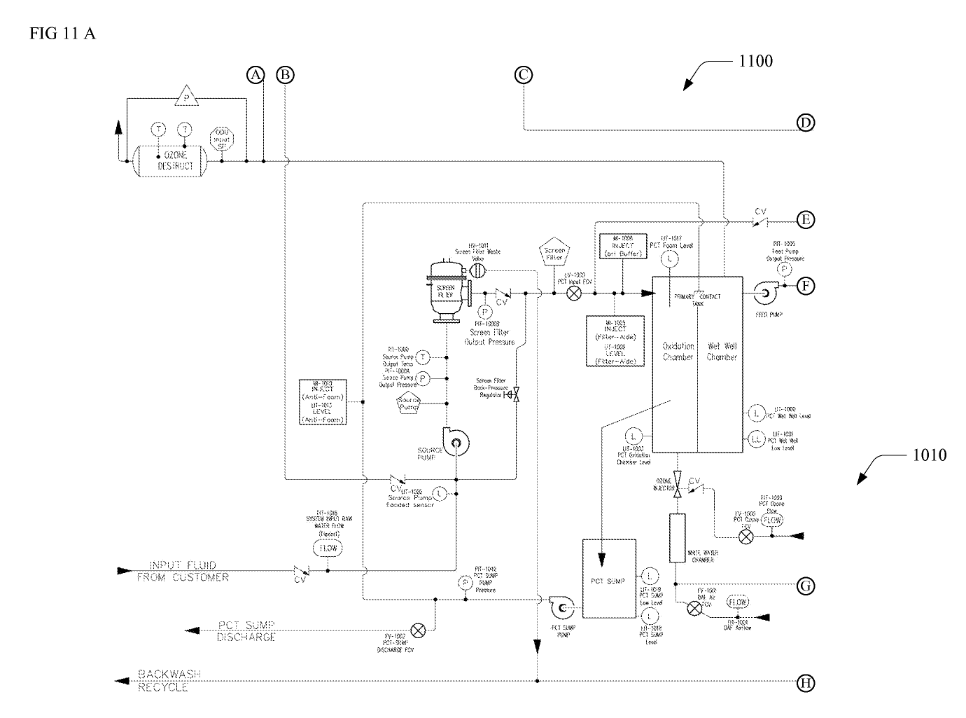

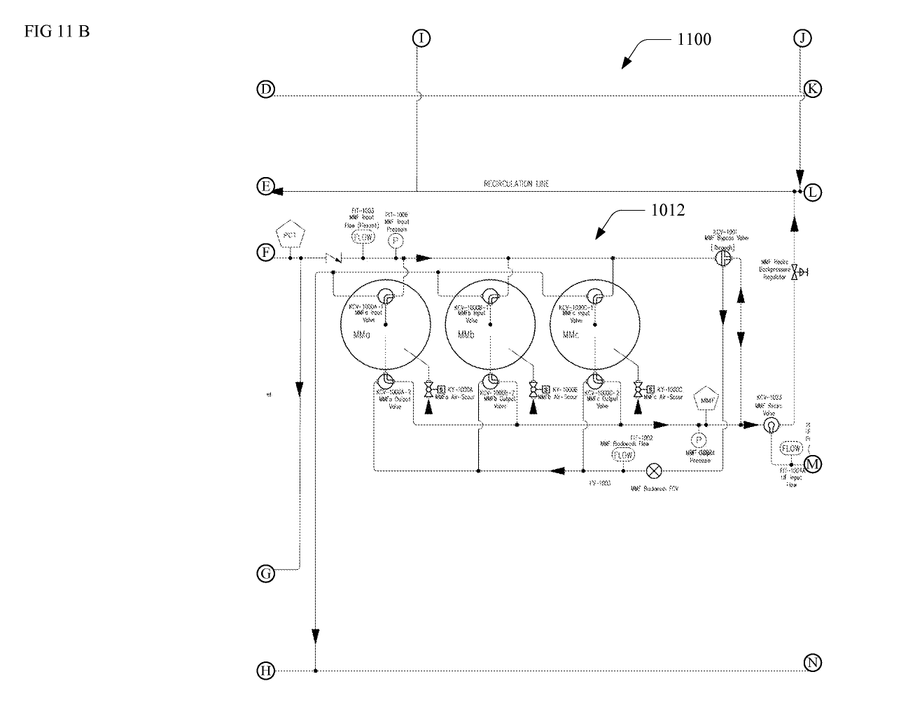

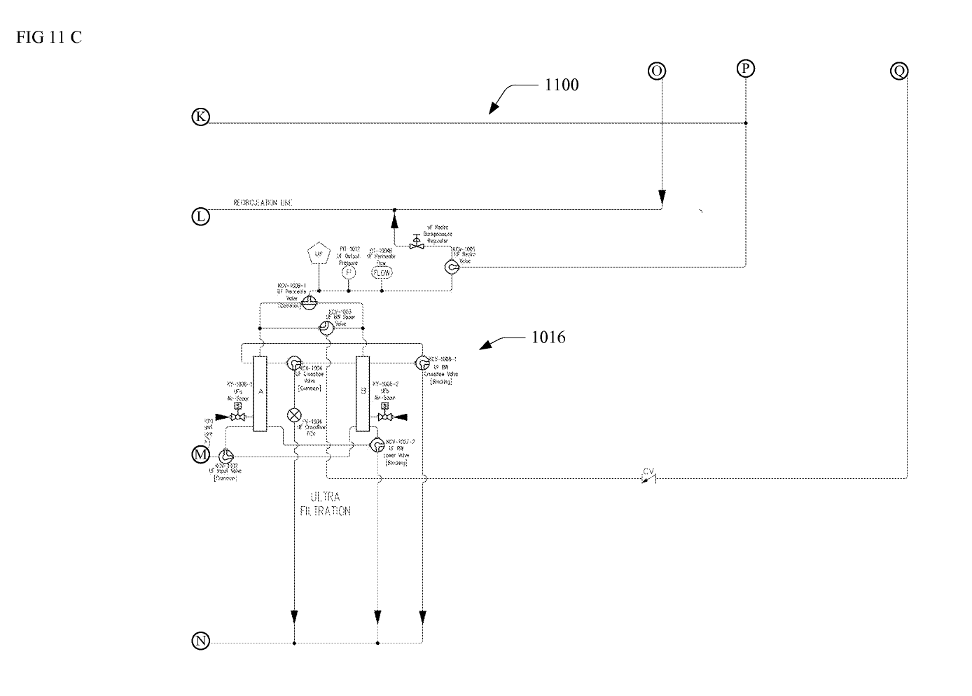

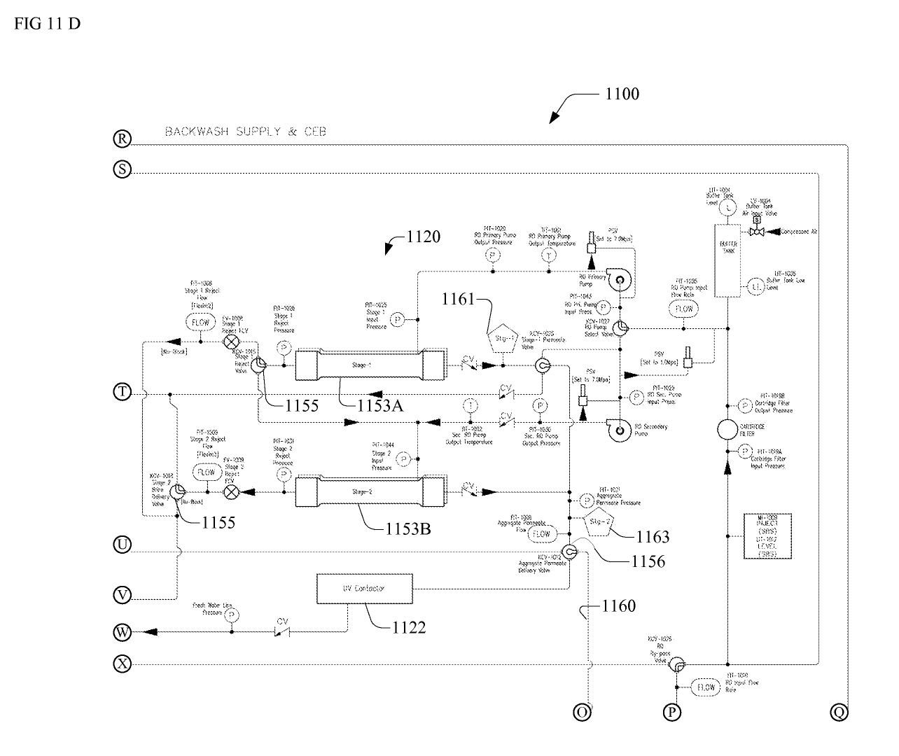

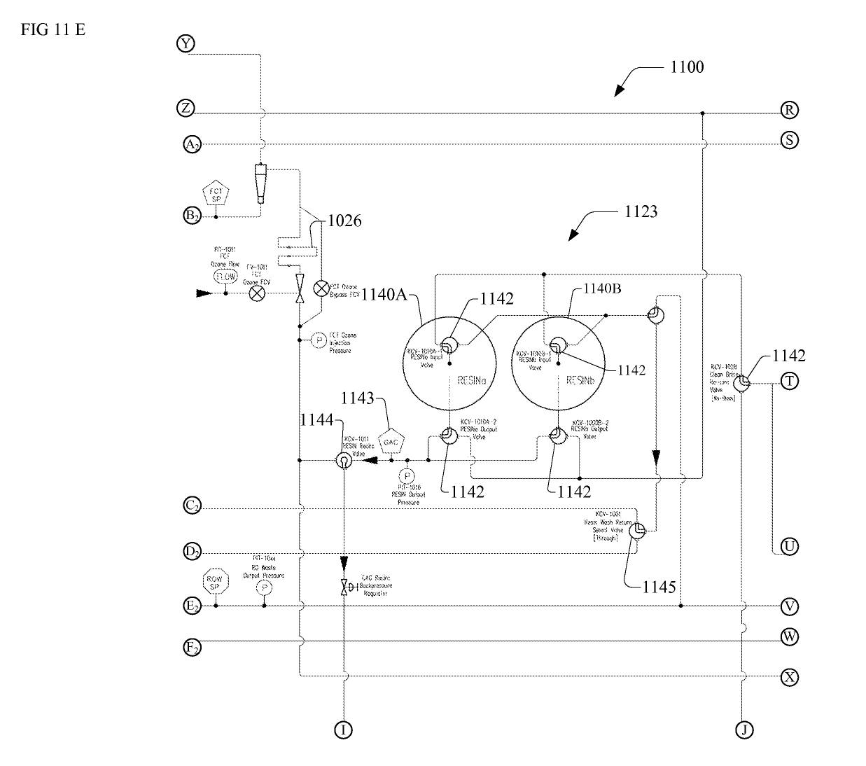

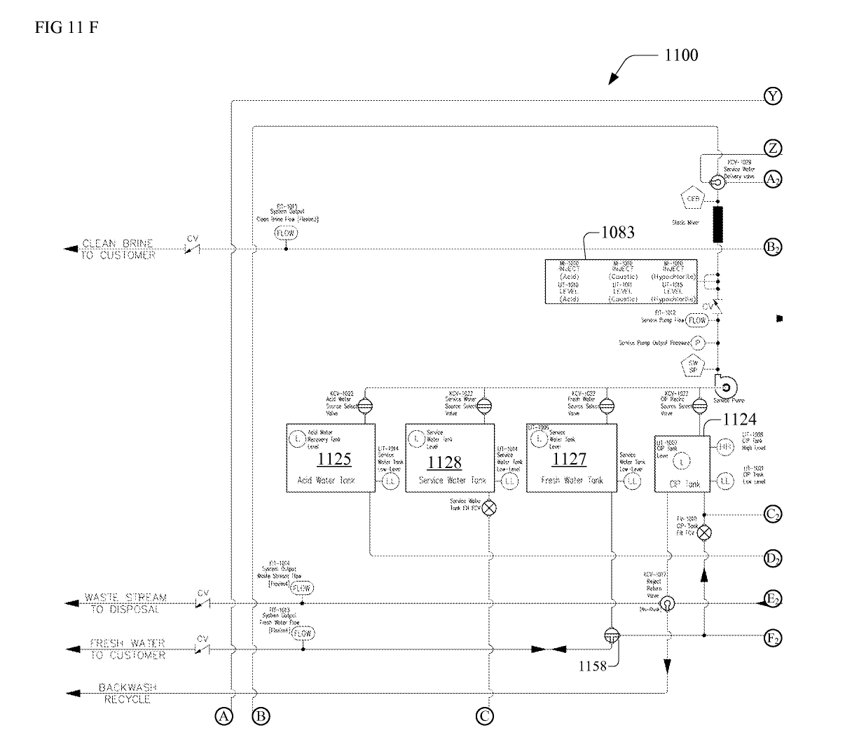

FIG. 11A to FIG. 11F illustrates a schematic diagram of yet another water treatment system. System 1100 can also be used for many oil field source waters (including flowback water with a wide range of salinity). System 1100 of the current embodiment differs from system 1000 (of FIG. 10) in several ways. First, system 1100 includes no GAC subsystem even though it could without departing from the scope of the current disclosure. In addition, system 1100 of the current embodiment only includes two RO filters 1153A and B in its HP membrane subsystem 1120. System 1100 does include an ion exchange subsystem 1123 as well as acid water tank 1125 and treated water tank 1127.

However, system 1100 operates in a somewhat similar manner to system 1000 in that the subsystems (and/or similar components) are ordered in the system 1100 such that upstream subsystems protect downstream subsystems from materials that might degrade the performance of the downstream components. The controller of system 1100 bypasses systems when their inlet conditions allow and recirculates (partially treated) waters from the various subsystems until that water is of adequate quality for admission to the next subsystems in the order. Note also, that all subsystems can be backwashed and/or cleaned in place such that the system 1100 controller can automatically direct system 1100 startups, shutdowns, upset recoveries, etc. as well as nominal and/or steady-state operations. For instance, all filters are selected such that they can be backwashed. Note also that whereas system 1000 directs brine from the GAC subsystem 1018 to the HP membrane subsystem 1020 and/or other destinations, system 1100 directs brine from the UF subsystem 1016 to somewhat similar destinations.

With continuing reference to FIG. 11, in the current embodiment, the primary oxidation subsystem 1010, the MMF subsystem 1012, and the UF subsystem 1016 can be operated much as previously disclosed with reference to FIG. 10. However, from there some differences exist in the way that the system 1100 controller controls system 1100 and the way that the system 1000 controller controls system 1000. For instance, the two RO filters 1153A and B are connected in such a manner that the permeate from both passes in parallel to the exit of the HP membrane subsystem 1120 as illustrated by FIG. 11. The brine (reject) from RO filter 1153A can be routed to the inlet of RO membrane filter 1053B, though, if desired. Note that HP membrane subsystem 1120 can be operated with these filters in tandem to produce product water having salinity in a variety of ranges if desired. Moreover the throughput when operated in tandem can be higher than if RO filter 1153B were operated alone.

The permeate from one or both RO filters 1153A and/or B (whether operated in tandem or in parallel) can be directed to several destinations via RO permeate delivery valve 1156. In some scenarios, in which either or both of the RO exit sample points 1161 and/or 1163 reveal that the permeate is not yet at a quality for other uses, permeate delivery valve 1156 (or the controller) directs the permeate to the recirculation path 1160 for further treatment by subsystems up to and/or including HP membrane subsystem 1120. In some scenarios, the permeate delivery valve 1156 can direct the permeate to the UV irradiation chamber 1122 for delivery to various points of use and/or the CIP tank 1124. Additionally, if desired, some or all of the RO permeate can be delivered to the treated water tank 1127 via the treated water delivery valve 1158. In addition, or in the alternative, the permeate delivery valve 1156 can direct the water to the ion exchange subsystem 1123 as is disclosed further herein. As to the RO reject (or RO brine) from one or both RO filters 1153A and B, it too can be directed to the ion exchange subsystem 1123 if desired via certain HP membrane valves 1155 But, in many situations, the HP membrane valves 1155 will direct the RO reject to a point for disposal.

With regard to the ion exchange subsystem 1123, it can be included in systems 1100 of the current embodiment to remove boron and similar species from source water 1002. By way of comparison, systems 1000 as illustrated by FIG. 10 can utilize their HP membrane subsystems 1020 for such purposes. However, since the resin beds 1140 have considerably less head loss associated therewith as compared to the HP membrane filters 1053 of system 1000, system 1100 represents a more energy efficient method of removing boron from oilfield source waters 1002 than system 1000.

In the current embodiment, the ion exchange subsystem 1123 includes resin beds 1140 made from Amberlite 743 resin available from the Dow Chemical Company of Midland, Mich. Other ion exchange resins could be used without departing from the scope of the current disclosure. Thus, the resin beds 1140 can capture boron from the source water 1002 if desired. Note also that the resin beds 1140 can capture other anions such as sulphates and chlorides depending on their composition and/or the quality of the waters reaching the ion exchange subsystem 1123. Of course, the resin beds 1140 can be operated in parallel or one at a time as user desires and water conditions suggest. Indeed, the controller can (based on inlet water conditions as sampled at RO exit sample points 1161 and/or 1163) bypass the resin beds 1140A and B or flow water through them for treatment by positioning treated brine recirculation valve 1144 accordingly. Moreover, the controller can recirculate the water exiting the ion exchange subsystem 1123 if the quality of the water exiting the resin beds 1140A and/or B is not adequate to meet downstream desires. Of course, that water quality can be detected via ion exchange exit sample point 1143. In such scenarios, the controller (responsive to those exit water conditions) could use ion exchange recirculation valve 1144 to recirculate the water to the primary oxidation subsystem 1010 and other subsystems downstream thereof. However, if the sampling at ion exchange exit sample point 1143 indicates that the water there does meet downstream quality criteria, then the controller can direct the treated water there from to the secondary oxidation manifold 1026 for sterilization if desired via ion exchange recirculation valve 1144.

It can be noted that the ion exchange subsystem 1123 (or rather the resin beds 1140) can be backwashed and/or cleaned in place. To do so, the controller can reposition the resin backwash valves 1142 to direct backwash water to the beds. Note also, that the resin backwash select valve 1145 on the resin backwash discharge line from the resin beds 1140A and B can direct the backwashed water from the resin beds 1140 to either a point for disposal and/or to the acid water tank for subsequent use in backwashing other components of system 1100. Of course, the controller can continue the backwashing of the resin beds 1140 for a selected time, until a selected amount of water has flown there through, etc. When the resin bed 1140 backwash is complete or as might be desired, the controller can reposition the resin backwash valves 1142 and the resin backwash select valve 1145 to place one or both resin beds 1140A and/or B in service.

With continuing reference to FIG. 11, system 1100 of the current embodiment includes several tanks related to the service of various system 1100 components. These tanks each hold differing types of water for use in servicing (backwashing, cleaning-in-place, etc.) the various subsystems and/or their components. For instance, the CIP tank 1124 can receive RO permeate from the RO filters 1153A and/or B. It can also (or in the alternative) receive backwash water from the resin beds 1140 via the resin backwash select valves 1145 if desired. Note that both the RO permeate and resin backwash water represent relatively high quality water in that both have been treated by (or of a quality representative of water treated by) at least the primary oxidation subsystem 1010, the MMF subsystem 1012, the UF subsystem 1016, and the HP membrane subsystem 1020. Thus, the water therein can be used for servicing any of the subsystems of system 1100. One exception though is that the water in the CIP tank 1124 might have already been used to backwash the resin beds 1140 and, therefore, might have only a marginal subsequent effect thereon.

The treated water tank 1127 can also receive RO permeate from the RO filters 1153A and/or B. As such, that water an be used to service all components of system 1100. More specifically, that water (as an RO permeate) will often have a low pH (meaning its acidic) particularly if during its treatment little or no pH buffer is added in the primary oxidation subsystem 1011. If, additionally, that water happens to have a low boron concentration it can be used to backwashed or clean the ion exchange resin beds 1140 since its low pH can facilitate cleaning of these components and their release of previously captured boron and/or other captured anions.

As in system 1000, service tank 1128 can be configured to receive brine. In the current embodiment, that brine can come from the UF subsystem 1016 as in system 1000 of FIG. 10. Thus, the brine in the treated water tank 1127 can be used to backwash the UF system 1016 and perhaps other components upstream thereof if desired (and the system is configured to allow such uses).

The acid water tank 1125 of the current embodiment happens to be configured to only receive the backwash water from the resin beds 1140. As such it does represent water treated by the subsystems up to and including the HP membrane subsystem 1120 in the ordering of the subsystems in system 1100. Thus, the water stored therein can be expected to be at least somewhat acidic in many scenarios and can be used for many servicing tasks calling for acidic water with or without the addition of an acidic additive via CIP chemical injection point 1083.

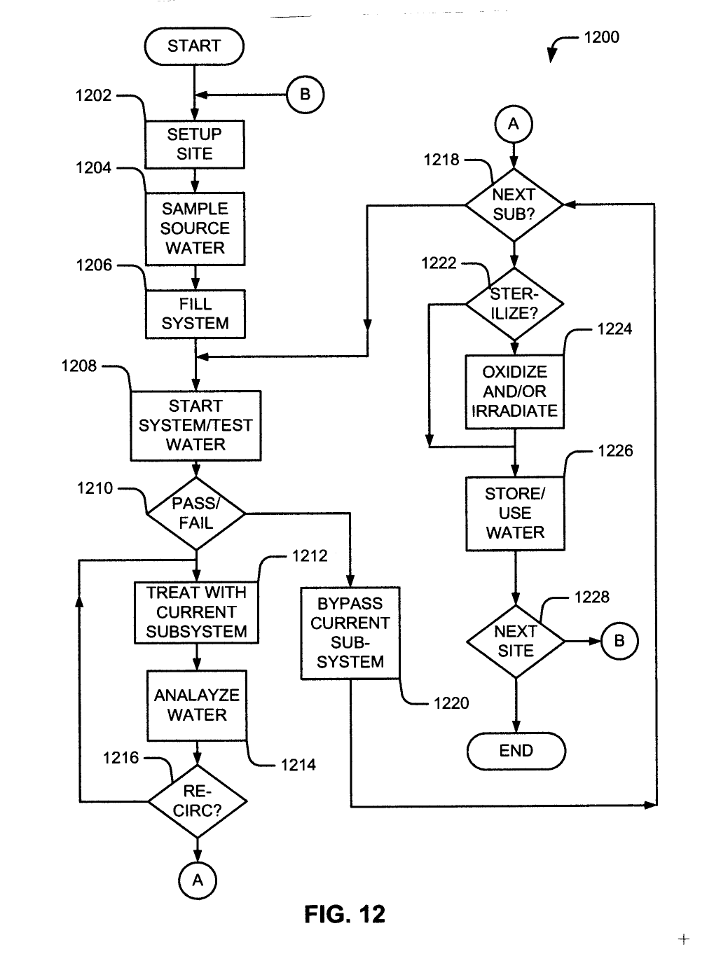

FIG. 12 illustrates a flowchart of a method for controlling water treatment systems. Methods in accordance with embodiments include various operations such as setting up a water treatment system (such as water treatment systems 800, 900, 1000, and/or 1100) at a site where it is desired to treat water. More specifically, water at such sites might be scarce due to the nature of the environment, climate, weather, site-remoteness, etc. Thus, purchasing or otherwise obtaining water could be quite expensive. Yet, certain users (such as oil well operators) might desire large quantities of water and some times those quantities can be measured in the millions of gallons. Moreover, because such sites might be remote from support systems, facilities, personnel, etc. these operators often desire for the system to be self-deploying, autonomous (or nearly so), and efficient with its use of energy as well as water. Accordingly, it might be desired to use one of the water treatment systems disclosed herein. The selected system (hence forth, system 1000) can be pulled into the site behind a conventional tractor as with most tractor trailer combinations. Moreover, the system 1000 can be delivered on-site cleaned and/or filled with water. Or, the system 1000 can be delivered cleaned and with a water side car 1001 for subsequent filling of the system 1000. Of course, the system 1000 need not be cleaned. See reference 1202.

At reference 1204, a user could sample the source water 1002 and have it analyzed. In this way, system 1000 could be customized to meet the particular quality of the on-site source water 1002. In many scenarios, the source water 1002 will contain a number of species including but not limited to: organic materials such as oil; industrial chemicals such as solvents, lubricants, drilling “mud,” etc.; particulate matters, dissolved compounds particularly salt, a wide variety of other species from within oil wells such as radioactive material leached from the underlying reservoirs, boron, etc. Thus, having some insight into the nature of the source water 1002 might be useful but is not necessary for the practice of the current disclosure.

The system 1000 could be filled with water (if not already full) as indicated at reference 1206. The water used to fill the system 1000 could come from a municipal water system, an industrial water system, from a water well, from surface water, from the water side car 1001, etc. In the alternative, or in addition, the fill water could be the source water 1002. Of course, lower quality water (or brine) could be used to fill one or more of the more upstream subsystems (such as primary oxidation subsystem 1010) while more downstream subsystems (such as HP membrane subsystem 1020) could be filled with higher quality water such as treated water 1004 which had been previously stored.

At reference 1208 the system 1000 could be started by activating source pump 1030 and/or feed pump 1032 with the various valves being configured to initially recirculate water from each of the subsystems to be used (for instance, subsystems 1010, 1012, 1016, 1018, 1020, and/or 1123) back to the source water 1002 inlet. Of course, the subsystems to be used could be a function of what type of product water various users desire. If some user desires treated water 1004, then all of the foregoing subsystems 1010, 1012, 1016, 1018, 1020, and 1123 could be placed in operation with water recirculating through them. In the alternative, the more downstream subsystems could be held in standby mode (thereby consuming little or no energy) while the more upstream subsystems bring the source water 1002 and/or partially treated waters up to an adequate quality for treatment by the more downstream subsystems. As part of starting the system 1000 and/or as part of ongoing operations, the source water 1002 could be sampled at oxidation inlet sample point 1009.

If the analysis of that sample by the sensors in the common analysis cabinet indicates that the quality of the incoming source water should be treated by the primary oxidation subsystem 1010, the controller can direct that the water be directed into the primary oxidation subsystem 1010. Moreover, the controller can cause the primary oxidation subsystem 1010 to circulate the foam created by the injection of the dissolved air and ozone (via the ozone eductors 1042) through the foam recirculation loop 1049. During such operations the controller can cause anti foam from anti foam additive source 1047 to be injected into the recirculating foam responsive to the level of foam in the oxidation chamber 1034 as measured by the foam level sensor 1033. In this manner, as the foam liquor sprays from the spray bars 1062, it can cause the foam in the oxidation chamber 1034 to collapse into liquor floating on the surface of the water in the oxidation chamber 1034. That liquor can drain to the foam sump tank 1044 for further recirculation and/or discharge from the system 1000 via foam discharge valve 1058. Thus, the material in the foam liquor (including coagulated and flocculated particulate matter) can be mechanically removed from the source water 1002.

With such foam-forming material removed from the partially treated water resident toward the bottom of the oxidation chamber 1034, that partially treated water can flow through the baffles in the contact tank 1036 and over the weir therein. Moreover, as the partially treated water becomes relatively still in the dearation chamber 1038, air, ozone and other gases dissolved therein can escape from solution and be vented (and/or destroyed) in the ozone destruct unit 1021. Of course, the controller can be injecting filter aid from filter aid tank 1014 and/or pH buffer from pH buffer source 1013 into the source water 1002 in the primary oxidation subsystem 1010. If so, these injections can be responsive to the residual ozone as measured at GAC exit sample point 1092 and the rate of water flowing into the primary oxidation subsystem 1010, respectively. See reference 1212 of method 1200.

With continuing reference to FIG. 12, method 1200 can continue with the partially treated water exiting the primary oxidation subsystem 1010 being sampled at oxidation subsystem exit sample point 1064. See reference 1214. If the analysis by the common analysis cabinet reveals that the partially treated water does not meet the criteria for treatment by the MMF subsystem 1012, that water can continue to circulate in the primary oxidation subsystem 1010. If, however, the analysis reveals that the water quality meets the criteria, method 1200 can continue with the controller positioning the MMF bypass valve 1066 to allow the partially treated water to flow to the MMF filters 1068. See references 1216 and 1218.

In the meantime, MMF subsystem 1012 has been recirculating water via the recirculation path 1060 to the source water 1002 inlet and continues to do so in many scenarios. However, when the sampling and analysis of the partially treated water at the MMF exit sample point 1076 indicates that the partially treated water meets the criteria for treatment by UF subsystem 1016, the controller can position the MMF recirculation valve 1075 to allow the partially treated water to proceed to the next subsystem, here the UF subsystem 1016. See reference 1220. In methods 1200 in accordance with the current embodiment, such treatment repeats through references 1212, 1214, 1216, and/or 1218 with the partially treated water nominally reaching the next subsystem in system 1000 as the system 1000 starts up. Of course, at any point and if the partially treated water exiting one subsystem meets the criteria for treatment by the next two subsystems in the order of system 1000, the next subsystem in that order can be bypassed (assuming that a bypass path and/or valve is available in the system 1000 being operated). See reference 1220.

At some point, the partially treated water will meet the criteria for either treated brine 1005 or for treated water 1004. In such scenarios, the controller can direct such product waters to the corresponding storage tanks (the service tank 1028, the CIP tank 1024, the water side car 1001, etc.) and/or to various points of use. However, in some scenarios, the controller and or system 1000 might be configured to direct those product waters to one or more components for sterilization. For instance, the controller can direct some or all of the brine from the GAC subsystem 1018 (or the reject from the HP membrane subsystem 1020) through the secondary oxidation manifold 1026 for oxidation (and/or sterilization) with hypochlorite or some other oxidizer. In other scenarios, the controller can direct the permeate from the HP membrane subsystem 1020 through the UV irradiation chamber 1022 for sterilization by exposure to UV radiation. Of course, that UV radiation might also cause any residual ozone to react with some of the permeate thereby forming OH radicals and further sterilizing the permeate while destroying the ozone too. See references 1222 and 1224. It might be the case though that some of these product waters might not be sterilized, in which case method 1200 can omit sterilizing the water at reference 1224 and proceed to reference 1226 from reference 1222.

At reference 1226 some or all of the product waters might be stored in one or more tanks as previously indicated. In addition, or in the alternative, some or all of the product waters might be directed to various points of use as might be desired. Method 1200 could continue with partially treated water being treated by the various subsystems per references 1210, 1212, 1214, 1216, 1218, 1220, 1222, 1224, and/or 1226 as conditions in the system 1000, source water 1002, the various partially treated waters, etc. suggest. Upsets might therefore cause the method 1200 to recirculate water through various subsystems until the quality of the partially treated water meets criteria for treatment by subsequent subsystems per references 1212, 1214, 1216, and/or 1218. Of course, in the meantime, the system 1000 could respond automatically to changes in the source water 1002 (such as those likely to occur over time with flowback water) while still producing the desired product waters such as treated water 1004, treated brine 1005, and/or product waters drawn from other points in the system 1000.

However, it might occur that the treatment of water at the current site might come to an end. For instance, the flowback water might become predominately oil indicating that an oil well for which the flowback is being treated (and/or re-used) might be near production. In which case, the inflow of source water 1002 could be stopped and replaced with some other water while the partially treated source water 1002 still in the system 1000 is treated and subsequently flows from the system 1000 as transformed into product water (along with certain system 1000 rejects such as brine from the HP membrane subsystem 1020). At some point, treatment could stop, certain components could be backwashed, and/or the system 1000 could be drained. If desired, CIP water from CIP tank 1024 and CIP chemicals from CIP chemical injection point 1083 could be directed into various system 1000 components. The CIP water could remain circulating in system 1000 for some period of time and/or until sampling thereof indicates that system 1000 (and/or its components) are suitable for travel to and/or setup at another site. Thus, system 1200 could end or be repeated at another site as indicated by reference 1228.

FIG. 13 illustrates a contact tank of an oxidation subsystem. The contact tank 1300 can correspond to contact tank 1036 of embodiments. As FIG. 13C illustrates, the contact tank 1300 includes a set of baffles 1302, 1304, and 1306 along with an adjustable weir plate 1308 which form passageway 1310 from an oxidation chamber 1334 to a dearation chamber 1038. Moreover, the contact tank includes two panels 1312 and 1314 sloped at respectively angles α and β of 70 and 105 degrees from the horizontal. Moreover, the contact tank defines and/or comprises an inlet port, an outlet port 1332, two sparger inlet ports 1342, level sensor ports 1348A and B, and a foam level sensor port 1333. Appropriate sensors can be connected to the level sensor ports 1348 and the foam level sensor port 1333. Source pumps such as source pump 1030 can be connected to the inlet port 1330 and feed pumps such as feed pump 1032 can be connected to the outlet port 1332.

In operation, water to be treated by contact tank 1300 flows through the inlet port 1330 and then into the oxidation chamber 1334. Meanwhile, mixtures of water, dissolved air, ozone, and or micro bubbles of air and/or ozone (or some other oxidizer/coagulant flow into the sparger inlet ports 1342. Moreover, piping connected thereto can convey the mixture into the interior of the oxidation chamber 1034. Such piping can convey the mixtures to near the bottom of the oxidation chamber 1034 and direct the resulting jets in a downwardly direction as illustrated by FIG. 13. Agitation caused by the resulting jets of the mixture will likely cause foaming in the water resident in the oxidation chamber 1334. The foam (or rather its liquor) floating on top of the water can be drawn off by an appropriately positioned drain.

In the meantime, water spraying from the spray bars 1362 can contact the foam floating above the water resident in the oxidation chamber 1034. Note that the foam, in some scenarios can fill enough of the space in the oxidation chamber 1034 that some of the foam extends over (and in contact with) the panel 1312. Hence, panel 1312 increases the surface area of the foam available for contact with the spray. The spray can collapse some of the foam bubbles thereby causing foam liquor to drain down through the remaining foam and, in areas over the panel 1312, to the panel 1312. The foam then drains down to the top of the resident water where it can be drawn off.

In the meantime, some water will find its way to the bottom of the oxidation chamber 1034 and more specifically, to volumes below the sparger inlets 1342. This, water (which will be largely foam free) can flow into the passageway 1310 between baffles 1302 and 1304. From there it flows to a weir partially defined by the weir plate 1308. That water will therefore flow into the dearation chamber 1038 and settle or become still for some residence time therein. Ozone, air, and/or other gases will therefore come out of solution with the water in the dearation chamber and flow out of the contact tank 1300 through a vent provided therefor. Meanwhile, the water will flow out of the outlet port 1332.

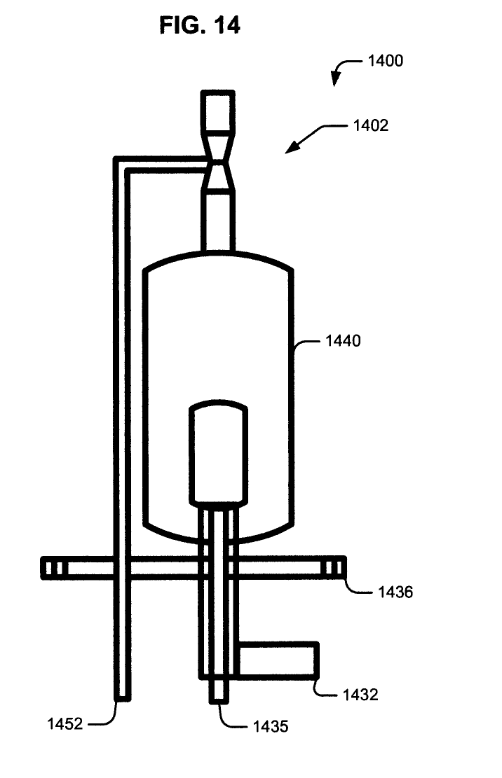

FIG. 14 illustrates a cross-sectional view of a coagulant/oxidizer/dissolved air sparger of an oxidizer subsystem. The sparger 1400 can be used to dissolve air and/or an oxidizer coagulant into water and, further, can be used in conjunction with tanks such as contact tank 1036 (see FIG. 10). As illustrated by FIG. 14, the sparger 1400 comprises an eductor 1442, a turbulence chamber 1440, a water port 1432, an air port 1454, a water port 1432, and an oxidizer port 1452. The sparger 1400 further comprises an adaptor 1436 which can be a flange or other fluid connector for mounting the sparger 1400 on a pressure vessel and/or sealing it thereto. The water port 1452 can be connected to a source of pressurized water such as feed pump 1032 while the air port 1454 and oxidizer port 1452 can be connected, respectively to a source of compressed air and a source of oxidizer. Moreover, in operation, the water enters the sparger 1400 at the water port 1452 while the air enters it at the air port 1454. Both of these fluids flow into the turbulence chamber and, due to the pressure with which they are driven, mix completely therein. That pressure drives the mixture of water and dissolved air and micro bubbles of air out of the turbulence chamber and to the eductor 1440.

As the water/air mixture flows through the eductor 1442, it develops a region of low pressure at and/or near the throat of the venturi shaped eductor 1442. The low throat pressure draws the oxidizer, for instance ozone, into the eductor 1442. The oxidizer therefore mixes with the rapidly flowing water/air mixture and dissolves into the water and/or forms micro bubbles therein. The water/air/oxidizer mixture then jets from the eductor 1440 whereby it can mix with fluids present at and/or near the eductor 1442 discharge.

Note also that the angles α and β and other dimensions of the contact tank 1400 can be chosen to provide head room for the foam while also allowing other components of the system 1000 (or other systems) to fit in the envelope of a standard sized shipping container and/or trailer. Thus, the shape of the contact tank 1400 can contribute to the relatively small physical size of the system 1000.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. A system for treating water, the system comprising:
a first oxidation subsystem;
a particulate filtration subsystem downstream from the first oxidation subsystem;
a low pressure membrane filtration subsystem downstream from the particulate filtration subsystem;
a high pressure membrane subsystem downstream from the low pressure membrane filtration system;
a high pressure membrane bypass path;
the subsystems in fluid communication with each other in that order;
a bypass path for at least the particulate filtration subsystem;
recirculation paths for each of the first oxidation, particulate filtration, and high pressure membrane subsystems;
sensors for sensing water conditions in the system; and
a controller in communication with the sensors and being configured to, responsive to the sensed conditions, determine in the order
whether to recirculate water through the first oxidation subsystem,
whether to bypass water through the particulate filtration bypass path or whether to recirculate water through the particulate filtration subsystem,
whether to recirculate water through the low pressure membrane subsystem, and
whether to bypass water through the high pressure membrane bypass path or whether to recirculate water through the high pressure membrane subsystem whereby a flow path is configured, the controller being further configured to output a control signal in accordance therewith.

2. A system for treating water, the system comprising:
a first oxidation subsystem;
a particulate filtration subsystem;
a membrane filtration subsystem;
the subsystems in fluid communication with each other in that order, the system further comprising recirculation paths for each of the foregoing subsystems;
sensors for sensing water conditions in the system; and
a controller in communication with the sensors and being configured to, responsive to the sensed conditions, determine whether to recirculate water from one of the subsystems to a previous subsystem in the order whereby a flow path is configured, the controller being further configured to output a control signal in accordance therewith.

3. The method of claim 2 further comprising a second oxidation subsystem wherein the order includes the second oxidation subsystem after the membrane filtration subsystem.

4. The method of claim 2 further comprising an ultraviolet contactor wherein the order includes the ultraviolet contactor after the membrane filtration subsystem.

5. The method of claim 2 further comprising a high pressure membrane subsystem wherein the order includes the high pressure membrane subsystem after the membrane filtration subsystem.

6. The method of claim 5 further comprising a source pump before the high pressure membrane subsystem in the order, a booster pump of the high pressure membrane subsystem, and a damping tank configured to maintain a damping pressure in the buffer tank within a selected range.

7. The method of claim 6 wherein the high pressure membrane subsystem further comprises nanofiltration membranes, reverse osmosis membranes, or a combination thereof.

8. The method of claim 2 further comprising an ion exchange subsystem wherein the order includes the ion exchange subsystem after the membrane filtration subsystem.

9. The method of claim 2 further comprising an activated carbon subsystem wherein the order includes the activated carbon subsystem after the membrane filtration subsystem.

10. The method of claim 2 further comprising a bypass path for the particulate filtration subsystem, the controller being further configured to determine, responsive to the sensed conditions, whether to bypass the particulate filtration subsystem.

11. The method of claim 2 wherein the first oxidation subsystem further comprises a contact tank generally bifurcated between an oxidation chamber and a dearation chamber, the contact tank further comprising a baffle between the oxidation chamber and the dearation chamber and defining a sloped portion whereby the sloped portion extends the oxidation chamber into the bifurcation of the contact tank for the dearation chamber.

12. The method of claim 2 wherein the first oxidation subsystem further comprises a coagulant/oxidizer sparger, the oxidizer sparger further comprising a coagulant port, an oxidizer port, and a water port, the water port in fluid communication with an outlet of the first oxidation subsystem, the coagulant/oxidizer sparger defining a turbulence chamber and a venturi and a throat of the venturi, the venturi being downstream of the turbulence chamber, the water port and the oxidizer port in fluid communication with the turbulence chamber, the coagulant port being in fluid communication with the throat of the venturi.

13. A method comprising:
sensing water conditions with sensors in a system for treating water, the system further comprising
a first oxidation subsystem,
a particulate filtration subsystem,
a membrane filtration subsystem,
the subsystems in fluid communication with each other in that order, the system further comprising recirculation paths for each of the foregoing subsystems;
responsive to the sensed conditions and using a processor in communication with the sensors determine whether to recirculate water from one of the subsystems to a previous subsystem in the order whereby a flow path is configured; and
outputting a control signal using the processor and in accordance with the determining.

14. The method of claim 13 wherein the system further comprises a second oxidation subsystem and wherein the order includes the second oxidation subsystem after the membrane filtration subsystem.

15. The method of claim 13 wherein the system further comprises an ultraviolet contactor and wherein the order includes the ultraviolet contactor after the membrane filtration subsystem.

16. The method of claim 13 wherein the system further comprises a high pressure membrane subsystem and wherein the order includes the high pressure membrane subsystem after the membrane filtration subsystem.

17. The method of claim 16 wherein the system further comprises a source pump before the high pressure membrane subsystem in the order, a booster pump of the high pressure membrane subsystem, a damping tank, and a pressure sensor, and a pressurization valve in fluid communication with the damping tank, the method further comprising maintaining a pressure in the damping tank within a selected range using the pressure sensor, the pressurization valve, and the processor.

18. The method of claim 13 wherein the system further comprises an ion exchange subsystem and wherein the order includes the ion exchange subsystem after the membrane filtration subsystem.

19. The method of claim 13 wherein the system further comprises an activated carbon subsystem and wherein the order includes the activated carbon subsystem after the membrane filtration subsystem.

20. The method of claim 13 wherein the system further comprises a bypass path for the particulate filtration subsystem, the method further comprising determining, responsive to the sensed conditions, whether to bypass the particulate filtration subsystem.
